(19) United States
(12) Patent Application Publication
(10) Pub. No.: US 2017/0036709 A1
(43) Pub. Date: Feb. 9, 2017

(54) VEHICLE AERODYNAMICS CONTROL SYSTEM AND METHODS OF USE AND MANUFACTURE THEREOF

(71) Applicant: Honda Motor Co., Ltd., Tokyo (JP)

(72) Inventors: Matthew L. METKA, Worthington, OH (US); James MCKILLEN, Raymond, OH (US); James W. GREGORY, Columbus, OH (US)

(21) Appl. No.: 15/186,371

(22) Filed: Jun. 17, 2016

Related U.S. Application Data
(60) Provisional application No. 62/202,374, filed on Aug. 7, 2015.

(51) Int. Cl. B62D 35/00; B62D 35/02

(52) U.S. Cl. CPC B62D 35/001; B62D 35/008; B62D 35/02; B62D 35/007; B62D 35/005

(57) ABSTRACT

Some embodiments are directed to a vehicle aerodynamics control system for use with a vehicle. The vehicle can have a top side, a bottom side, a right side, and a left side. The control system can include at least one flow control actuator along at least one of the top side, the bottom side, the right side and the left side of the vehicle. The control system can also include a tuned surface configured to modify airflow in conjunction with the at least one flow control actuator. The tuned surface can be disposed along at least one of the top side, the bottom side, the right side, and the left side.

### CROSS REFERENCE TO RELATED APPLICATIONS

This application is non-provisional of U.S. Provisional Patent Application No. 62/202,374, filed on Aug. 7, 2015, the content of which are hereby incorporated by reference in its entirety.

### BACKGROUND

The disclosed subject matter is directed to methods and apparatus for enhancing active vehicle aerodynamics abilities.

Aerodynamic drag is an increasingly important factor in ground vehicle (automotive) design due to its large impact on overall fuel economy. Reducing automotive fuel consumption (or increasing fuel economy) yields significant benefits, such as reducing global fossil fuel consumption. The average vehicle drag coefficient has improved significantly since the advent of the automobile; however only marginal gains are possible with traditional shape optimization within the constraints of the automotive industry regarding styling and function/usability. Active flow control (AFC) can be used to improve vehicle drag coefficient large scale changes in the flowfield by utilizing energy perturbations at strategic locations on the vehicle surface.

### SUMMARY

Some embodiments are directed to a vehicle aerodynamics control system for use with a vehicle. The vehicle can have a rear portion defining a top side, a bottom side, a right side, and a left side. The control system can include at least one flow control actuator disposed at the rear portion of the vehicle. The at least one flow control actuator can be configured along at least one of the top side, the bottom side, the right side and the left side of the vehicle. The control system can also include a tuned surface configured to modify airflow in conjunction with the at least one flow control actuator. The tuned surface may be disposed along any surface proximate the flow control actuator that provides a beneficial interaction and desired aerodynamic modification change of the flowfield, and may include at least one of the top side, the bottom side, the right side, and the left side. The tuned surface may be shaped, modified, and adapted to modify airflow in conjuction with at least one proximate flow control actuators. The tuned surface shape and modifications may also be influenced by including shape of a vehicle, i.e. styling, and the location of the actuator or actuators.

Other embodiments are directed to a different vehicle aerodynamics control system. The vehicle can include wheels, and can define an underbody and an upper body. The control system can be configured to modify aerodynamic performance of the vehicle by manipulating underbody airflow and interaction of the airflow with the upper body.

Yet other embodiments can be directed to a method for forming a vehicle aerodynamics control system. The vehicle can have a top side, a bottom side, a driver side, and a passenger side. The method can include: providing at least one flow control actuator disposed along at least one of the top side, the bottom side, the driver side and the passenger side.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a schematic representation depicting control volume for wake integral.

FIG. 2 is a graph depicting an exemplary vehicle slant angle versus drag coefficient.

FIG. 3 is a perspective view of an exemplary vehicle having a rear portion with a slant.

FIG. 4 is a schematic representation of an exemplary fluidic oscillator.

FIG. 5A is a perspective view of an exemplary square-back vehicle including flaps.

FIG. 5B is a perspective view of exemplary fluidic oscillators on the square-back vehicle of FIG. 5A.

FIG. 5C is a side view of exemplary fluidic oscillators on the square-back vehicle of FIG. 5A.

FIG. 6A is vector representation of an exemplary tangential oscillator jet on an exemplary vehicle.

FIG. 6B is a vector representation of an exemplary pitched oscillator jet on an exemplary vehicle.

FIG. 7A is a perspective view of an exemplary square-back vehicle including tangential fluidic oscillator jets.

FIG. 7B is a perspective view of oscillator jet outlets of FIG. 7A.

FIG. 8A is a perspective view of an exemplary square-back vehicle including pitched fluidic oscillator jets.

FIG. 8B is a perspective view of oscillator jet outlets of FIG. 8A.

FIG. 9A is a perspective view of an exemplary square-back vehicle including pitched fluidic oscillator jets.

FIG. 9B is a perspective view of oscillator jet outlets of FIG. 9A.

FIG. 10A is a side view of an exemplary square-back vehicle.

FIG. 10B is a bottom view of the square-back vehicle of FIG. 10A.

FIG. 11 is a schematic representation of exemplary fluidic oscillators.

FIG. 12 is a schematic representation of exemplary oscillator array layouts.

FIG. 13 is a schematic representation of an exemplary wind tunnel.

FIG. 14A is a perspective view of an exemplary square-back vehicle including flap pressure taps.

FIG. 14B is a top view of the flap pressure tap of FIG. 14A.

FIG. 15 is a perspective representation of particle image velocimetry (PIV) near an upper flap of an exemplary vehicle.

FIG. 16 is a graphical representation of particle image velocimetry (PIV) of FIG. 15.

FIG. 17 is a vector representation of a flow profile over an exemplary flap surface without and with fluidic oscillator flow control based on an injected jet momentum.

FIG. 18 is a representation of streamwise vorticity mapped at a flap end of an exemplary vehicle.

FIG. 19A is a graphical representation of an instantaneous velocity magnitude at a roof-slant interface of an exemplary vehicle without fluidic oscillator separation control.

FIG. 19B is a graphical representation of an instantaneous swirling strength at a roof-slant interface of an exemplary vehicle without fluidic oscillator separation control.

FIG. 19C is a graphical representation of an instantaneous velocity magnitude at a roof-slant interface of an exemplary vehicle with fluidic oscillator separation control.

FIG. 19D is a graphical representation of an instantaneous swirling strength at a roof-slant interface of an exemplary vehicle with fluidic oscillator separation control.

FIG. 20A is a graphical representation of unactuated wake flow of an exemplary vehicle with flaps and pitched jets.

FIG. 20B is a graphical representation of actuated wake flow of an exemplary vehicle with flaps and pitched jets.

FIG. 20C is a graphical representation of a difference in wake flow of actuated and unactuated vehicles with flaps and pitched jets.

FIG. 21A is a side view of airflow behind an exemplary vehicle without active control.

FIG. 21B is a side view of airflow behind the vehicle of FIG. 21A with active control.

FIG. 22 is a graphical representation of drag reduction for varied flap angles.

FIG. 23A is a graphical representation of pressure tap data indicating degree of attachment to an exemplary upper flap.

FIG. 23B is a graphical representation of pressure tap data indicating degree of attachment to an exemplary side flap.

FIG. 23C is a graphical representation of pressure tap data indicating degree of attachment to an exemplary lower flap.

FIG. 24 is a vector representation of an exemplary oscillator jet location.

FIG. 25 is a perspective view of oscillator jet locations on an exemplary vehicle.

FIG. 26A is a graphical representation of drag coefficient for varied placement and angle of exemplary oscillator jets.

FIG. 26B is a graphical representation of drag coefficient for varied placement and angle of exemplary oscillator jets.

FIG. 26C is a graphical representation of drag coefficient for varied placement and angle of exemplary oscillator jets.

FIG. 27A is a graphical representation of flap surface static pressure of exemplary flaps for varied jet locations.

FIG. 27B is a graphical representation of flap surface static pressure of exemplary flaps for varied jet locations.

FIG. 27C is a graphical representation of flap surface static pressure of exemplary flaps for varied jet locations.

FIG. 28A is a graphical representation of flap surface static pressure of exemplary flaps for varied jet locations.

FIG. 28B is a graphical representation of flap surface static pressure of exemplary flaps for varied jet locations.

FIG. 28C is a graphical representation of flap surface static pressure of exemplary flaps for varied jet locations.

FIG. 29A is a graphical representation of flap surface static pressure of exemplary flaps for varied jet locations.

FIG. 29B is a graphical representation of flap surface static pressure of exemplary flaps for varied jet locations.

FIG. 29C is a graphical representation of flap surface static pressure of exemplary flaps for varied jet locations.

FIG. 30A is a graphical representation of base pressure at varied jet locations along exemplary vehicle flaps.

FIG. 30B is a graphical representation of base pressure at varied jet locations along exemplary vehicle flaps.

FIG. 30C is a graphical representation of base pressure at varied jet locations along exemplary vehicle flaps.

FIG. 31 is a graphical representation of change in drag coefficient for underbody actuation for exemplary flaps with tangential jets.

FIG. 32A is a graphical representation of upper and side jet wakes of an exemplary vehicle.

FIG. 32B is a graphical representation of upper, side and lower jet wakes of an exemplary vehicle.

FIG. 32C is a graphical representation of airflow difference between wakes of varied jet configurations of an exemplary vehicle.

FIG. 33 is a graphical representation of systematically deactivated actuator rows.

FIG. 34 is a side view of a wake plane of an exemplary vehicle.

FIG. 35A is an underbody view of airflow wake of the vehicle of FIG. 34 without active flow control.

FIG. 35B is an underbody view of airflow wake of the vehicle of FIG. 34 with active flow control.

FIG. 36 is a graphical representation of underbody centerline flow velocity of an exemplary vehicle.

FIG. 37 is a schematic view of underbody roughness element placement of an exemplary vehicle having pitched jets.

FIG. 38 is a graphical representation of underbody disturbance drag.

FIG. 39 is a graphical representation of lower flap static tap pressure from underbody disturbance.

FIG. 40A is a graphical representation of drag with varied flap angles and tangential jets of an exemplary vehicle along varied surface of travel.

FIG. 40B is a graphical representation of drag with varied flap angles and tangential jets of an exemplary vehicle along varied surface of travel.

FIG. 40C is a graphical representation of drag with varied flap angles and tangential jets of an exemplary vehicle along varied surface of travel.

FIG. 41A is a graphical representation of drag coefficient of an exemplary vehicle having varied ride height using tangential jets.

FIG. 41B is a graphical representation of drag coefficient of an exemplary vehicle having varied ride height using tangential jets.

FIG. 41C is a graphical representation of drag coefficient of an exemplary vehicle having varied ride height using tangential jets.

FIG. 42A is a graphical representation of geometric scaling for an exemplary vehicle having tangential jets.

FIG. 42B is a graphical representation of geometric scaling for an exemplary vehicle having tangential jets.

FIG. 43A is a vector representation of jet exit step height for an exemplary vehicle.

FIG. 43B is a vector representation of jet exit step height for an exemplary vehicle.

FIG. 44 is a schematic representation of exemplary oscillator jet arrays.

FIG. 45 is a graphical representation of actuator scaling for an exemplary vehicle having tangential jets.

FIG. 46 is a graphical representation of particle image velocimetry (PIV) wake behind an exemplary vehicle.

FIG. 47A is a graphical representation of normalized side force for an exemplary vehicle.

FIG. 47B is a graphical representation of normalized side force for an exemplary vehicle having flaps with actuation.

FIG. 48 is a vector representation of microphone locations in an exemplary anechoic chamber.

FIG. 49 is a graphical representation of far-field acoustics for exemplary fluidic oscillators at varied jet velocities.

FIG. 50 is an exemplary oscillator.

FIG. 51 is a graphical representation of acoustic spectra at varied microphone locations.

FIG. 52 is a graphical representation of directivity of oscillation and second harmonic far field noise.

FIG. 53 is a schematic representation of oscillation induced acoustic waves.

FIG. 54 is a schematic representation of oscillator feedback length scaling.

FIG. 55 is a graphical representation of feedback scaling frequency.

FIG. 56 is a graphical representation of oscillation frequency and feedback length scale at varied jet velocities.

FIG. 57 is a schematic representation of an exemplary system for evaluating oscillator pressure drop and energy requirements.

FIG. 58 is a graphical representation of total pressure and oscillator outlet jet velocity at varied locations in an exemplary representative distribution system.

FIG. 59 is a graphical representation of total to total efficiency between varied locations in an exemplary representative distribution system.

FIG. 60 is a graphical representation of system flow power requirements for an exemplary oscillator.

FIG. 61 is a schematic representation of streamwise vorticity measurements behind an exemplary pitched fluidic oscillator.

FIG. 62 is a graphical representation of streamwise vorticity of an exemplary single pitched fluidic oscillator.

FIG. 63A is a graphical representation of isolines at varied different jet velocities.

FIG. 63B is a graphical representation of isolines at varied different jet velocities.

FIG. 63C is a graphical representation of isolines at varied different jet velocities.

FIG. 64A is a graphical representation of pressure variation of jet centered taps and downstream taps.

FIG. 64B is a graphical representation of pressure variation of jet centered taps and downstream taps.

FIG. 64C is a graphical representation of pressure variation of jet centered taps and downstream taps.

FIG. 65A is a graphical representation of drag coefficient for exemplary vehicles on varied travel surfaces.

FIG. 65B is a graphical representation of drag coefficient for exemplary vehicles on varied travel surfaces.

FIG. 65C is a graphical representation of drag coefficient for exemplary vehicles on varied travel surfaces.

FIG. 66A is a graphical representation of wake behind an exemplary vehicle having pitched jets with a sealed cavity.

FIG. 66B is a graphical representation of wake behind an exemplary vehicle having pitched jets with an open cavity.

FIG. 67A is a perspective view of an exemplary oscillator mounting in an echoic chamber.

FIG. 67B is a perspective view of an exemplary oscillator mounting in an echoic chamber.

FIG. 68A is perspective view of a benchtop microphone layout.

FIG. 68B is a schematic representation of an exemplary oscillator.

FIG. 69 is a perspective view of an exemplary vehicle having oscillators arranged along bases of a flap assembly.

FIG. 70A is a perspective view of an exemplary vehicle having oscillators arranged along bases of a flap assembly.

FIG. 70B is a perspective view of an exemplary vehicle having oscillators arranged along bases of a flap assembly.

FIG. 70C is a perspective view of an exemplary vehicle having oscillators arranged along bases of a flap assembly.

FIG. 71 is a perspective view of an exemplary vehicle having an oscillator array.

FIG. 72 is a perspective view of an exemplary vehicle having an oscillator array.

FIG. 73 is a perspective view of an exemplary vehicle having an oscillator array.

FIG. 74 is a perspective view of an exemplary vehicle having an oscillator array.

FIG. 75 is a schematic representation of an exemplary vehicle having a flow control system.

FIG. 76A is a schematic representation of an exemplary vehicle having an unactuated flow control system.

FIG. 76B is a schematic representation of an exemplary vehicle having an actuated flow control system.

FIG. 77 is a schematic representation of an exemplary fluidic oscillator.

FIG. 78 is a schematic representation of an exemplary oscillator array.

FIG. 79 is a schematic representation of exemplary oscillators.

FIG. 80 is a graphical representation of oscillator frequency spectrum manipulation of the oscillators of FIG. 80.

FIG. 81 is a perspective view of diffuser actuators of an exemplary vehicle.

FIG. 82 is a flow chart of exemplary actuation system power.

FIG. 83 is a schematic representation of rear of an exemplary vehicle having notional flow control system.

FIG. 84 is a perspective view of a tire assembly of an exemplary vehicle.

FIG. 85 is a perspective view of a rear portion of an exemplary vehicle.

FIG. 86A is a representation of airflow behind the vehicle of FIG. 86 without a flow control system.

FIG. 86B is a representation of airflow behind the vehicle of FIG. 86 implementing an exemplary flow control system.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

The disclosed subject matter specifically relates to general application of active flow control devices to vehicles. The active flow control systems described herein may be implemented to manipulate ground vehicle aerodynamic performance. Exemplary embodiments are directed to fluidic oscillators, for example, applied to ground vehicles to reduce drag. Additionally, exemplary flow control systems may be used for lift reduction, such as on high performance vehicles.

Active flow devices such as fluidic oscillator jets can be included along surfaces of vehicle panels and components. The flow devices can thereby control separation and manipulate airflow forming a vehicle wake. Exemplary embodiments can include fluidic oscillators for bluff body drag reduction tailored to specific portions of the vehicle, such as various rear portion sides, such as a lower side.

The disclosed subject matter also relates to flow control systems that specifically target control of vehicle underbody flow to reduce drag.

Flow control actuators can be applied to the underside of the vehicle to thereby manipulate wake symmetry to reduce drag. Systems including flow actuators can include a lower bumper diffuser with active separation control as well as a tuned upper body surface of the vehicle. The tuned upper body surface of the vehicle may passively direct airflow past the vehicle, while the underbody airflow is specifically targeted by active flow control. Exemplary embodiments can include fluidic oscillators as flow control actuators, however various other types of jets may achieve separation control and wake manipulation as disclosed.

Additionally, disclosed subject matter includes airflow jets disposed along diffusers (i.e., actively blown diffusers) for on-demand rear lift alteration. Unlike passive diffusers, airflow past the vehicle can be altered by active flow jets along the diffuser depending on user input or automatically, thereby adapting drag and lift characteristics to suit various performance needs of the vehicle.

High performance vehicles, such as sports cars or race cars that engage in aggressive cornering require certain downforce to maintain traction and stability. However, such downforce that enhances potential corning abilities of a high performance vehicle may also be associated with a drag penalty. Therefore, an active and adaptable downforce enhancing system may be controllable such that the system may be activated during high speed corning to increase cornering grip and deactivated during straightaway acceleration to lessen drag and enable greater top speeds.

Active rear diffusers applied to the rear portion of a vehicle can enable momentary rear downforce changes on demand via user input or automatically. Particularly, such active diffusers may be installed in sports/high performance cars for abilities to increase rear downforce during cornering while maintaining low drag for straightaway driving. An emergency braking safety device may also implement the active diffusers to increase potential braking effectiveness via increased downforce during braking. Exemplary embodiments can feature systems including tuned upper and lower flap surfaces, with active flow control targeted to underbody flow. The control systems can be specifically targeted towards enhanced track performance. The notional control system may receive input parameters such as vehicle speed, acceleration, steering wheel angle, GPS mapping of vehicle position (i.e., on a race course), and may further include a driver-controllable override, as well as other inputs.

Embodiments of the above described systems may be implemented on any vehicle in which rear down force may be supplemented for enhanced corning abilities. The activation logic of the system is dependent upon specifications of the vehicle and driving environments and conditions the vehicle is expected to encounter.

### I. Introduction

Some embodiments are directed to separation control with fluidic oscillators on a modified square-back Ahmed vehicle model to advance the possibility of AFC application to production vehicles. A fluidic oscillator is a simple pneumatic device that converts a steady flow input into a spatially oscillating jet. This AFC actuator can be selected based on proven separation control efficiency and robustness. Some embodiments relate to studies applying fluidic oscillator separation control to simplified vehicle models.

Some embodiments are based on performance of models in a scale wind tunnel facility at a Reynolds number based on model length of 1.4×10⁶ or higher. A modified aft section containing boat-tail flaps and fluidic oscillators can be added to the square-back Ahmed model and various parameter sensitivity trends can be examined. Parameters of interest can include flap angle, oscillator jet location, jet velocity, jet spacing, jet size, moving ground plane simulation, ride height, speeds changes, underbody turbulence, actuation symmetry, and model geometric scaling. Fluidic oscillator acoustics, separation control mechanism, and energy consumption can also be analyzed to build practical implementation knowledge. Some embodiments implement techniques that can include the use of force transducers, particle image velocity, surface static pressure taps, wake total pressure surveys, and microphone acoustical measurements.

This analysis shows that drag reduction can be sensitive to many of the parameters discussed above. The character of the underbody flow and the use of symmetric actuation can be of critical importance for enhanced or optimal drag reduction, however exploitation of underbody flow modification may facilitate an efficient use of actuator energy. Parameters, such as speed changes, ride height, and simulated ground plane may weakly affect the drag coefficient changes experienced with actuation. A model scaling embodiment may indicate that the actuator momentum requirements for a given drag reduction decrease as the model size is increased, because the number of oscillators requires scales with perimeter. A notional energy analysis may suggest that the actuator energy consumption relative to drag reduction estimate on a full scale vehicle are within reason.

A. Rationale

Close to 60% of the total power consumed by a vehicle at highway speeds can be attributed to aerodynamic drag, and highway vehicles alone accounted for 23% of United States energy consumption in 2012. Reduction of drag is desired to reduce or minimize transportation fuel use and its associated economic and environmental impacts. The dissipative drag force is due to viscous and pressure interactions between air and the vehicle surfaces. Ground vehicles, such as cars and trucks, can be referred to as bluff bodies, and the majority of their total drag is due to the net pressure difference between the front and rear facing vehicle surfaces. The vehicle design and development process involves focusing on vehicle shape to reduce or minimize the drag coefficient within the constraints imposed by function and aesthetics; however the pace of improvement is marginalized because many of the straightforward shape modifications have already been implemented. Active flow control (AFC) can be used to modify the flow-field around the vehicle while adhering to design constraints so as to further enhance the drag coefficient.

Active flow control is a local introduction of energy into the flow through a control actuator, such as a fluidic oscillator air jet, that can result in large scale changes to the overall flow-field. These resulting flow-field changes may have a beneficial impact on pressure distribution and change drag, lift, and crosswind stability of the vehicle. A large portion of the drag on a vehicle manifests in the low pressure unsteady wake.

Some embodiments are directed to active flow control aimed at influencing the unsteady wake of a modified square-back Ahmed vehicle model through separation control on the aft facing surfaces with fluidic oscillator. A fluidic oscillator is a device that emits a spatially oscillating jet of air, which is increasingly recognized as an effective way of controlling flow separation. The devices are particularly advantageous for ground vehicle use due to the relatively low speed flow fields encountered and rapid vehicle development process.

B. Aerodynamic Drag on Ground Vehicles

The interaction between a vehicle's surfaces and air results in a net rearward force that must be overcome with additional driving energy. The driving energy expended to overcome drag is eventually dissipated as heat and radiated noise to the surroundings. The transfer of energy from the vehicle to the surrounding air molecules is clear when viewed from the perspective of the stationary ground frame of reference. As the vehicle passes, air molecules are seen to be accelerated from rest, resulting in a turbulent movement of flow that follows the vehicle. Aerodynamics are evaluated from the point of view of the moving vehicle, which can be simulated in a wind tunnel as air moves past the stationary vehicle. The flow physics are the same regardless of the frame of reference used. The vehicle drag coefficient can be estimated from the wake losses with the following equation,

$${C}_{D} = \frac{1}{{A}_{∞}} \int \int \frac{{p}_{{o}_{∞}} - {p}_{o}}{{q}_{∞}} - {( 1 - \frac{{V}_{x}}{{V}_{∞}} )}^{2} + {( \frac{{V}_{y}}{{V}_{∞}} )}^{2} + {( \frac{{V}_{z}}{{V}_{∞}} )}^{2} d y d z$$

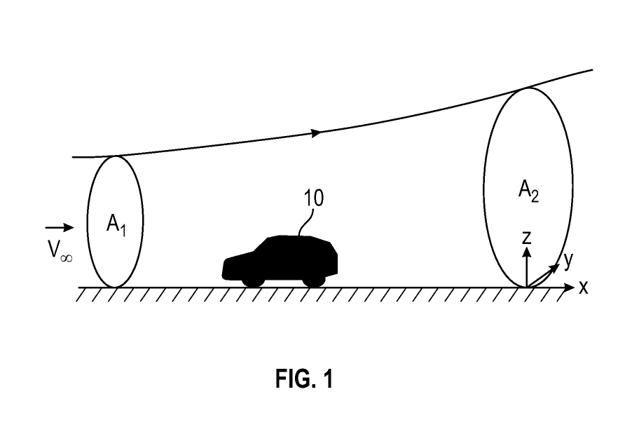

which takes into account the momentum losses imparted to the freestream flow. The area integral of the control volume shown in FIG. 1 is calculated sufficiently downstream of the vehicle such that the bounds of the integral A₂ are at freestream velocity and pressure. The first term involves the spatial integration of the local pₒ, and accounts for the total pressure losses that occur due to various dissipative interactions around the vehicle due to boundary layer growth, separation on body panels, wheel wake, cooling flow through the engine compartment, and mirrors, among others. The second term is from the change in streamwise flow velocity, and the last two terms represent the kinetic energy of streamwise vorticity. The relative contribution of the terms depends on the body shape, however total pressure losses generally dominate.

FIG. 1 is a schematic representation depicting control volume for wake integral of an exemplary vehicle 10.

Drag is traditionally reduced by careful optimization of vehicle shape, however the freedom permitted to the aerodynamicist is often limited due to styling and other considerations. During the initial vehicle development phase, the rough outline of the vehicle shell is selected to accommodate passengers, cargo, and safety requirements, while meeting overall aesthetic targets. Once the initial shape is selected, aerodynamic development engineers address the various details that have an impact on drag, lift, crosswind stability, aeroacoustics, and other considerations such as soiling by rainwater. Details of interest may include the windshield angle, front bumper radius, rear window angle, cooling flow inlet size, among others. This process involves an iterative approach to modification involving iterative and computational methods to understand and measure the impact of parameter changes. The details of the interaction between the vehicle and air can be complex, even for relatively simple vehicle shapes. The use of a simplified vehicle model can be advantageous such that the essential flow phenomena may be understood and controlled.

C. Drag on the Ahmed Vehicle Model

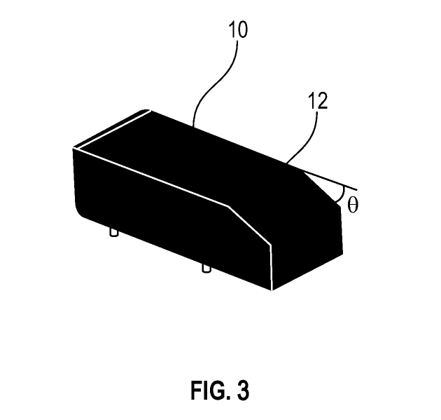

A simplified vehicle shape (Ahmed model) can be used for fundamental ground vehicle aerodynamic evaluations. The Ahmed vehicle model is a traditional test bed for fundamental ground vehicle research that allows a variety of representative flow configurations to be achieved by changing the aft geometry. One benefit of using this model is the ability to reference and compare results to numerous other models. The relatively simple geometry of the Ahmed model depicted in FIG. 3 can generate several generic wake topologies based on the angle of the rear slant surface, θ.

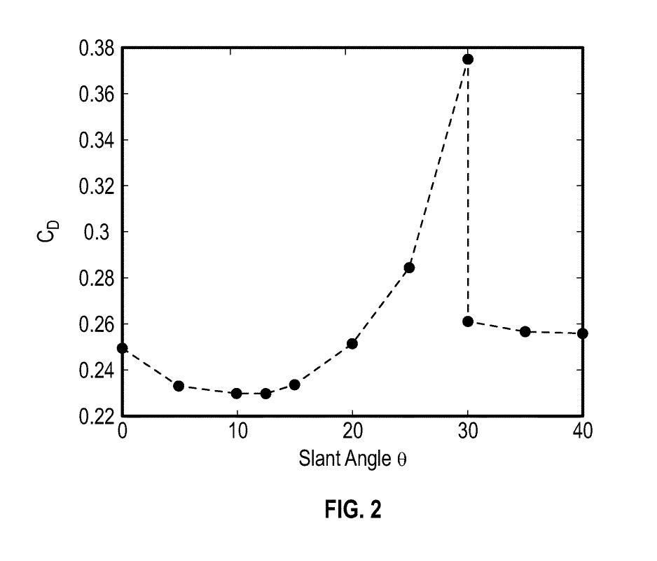

FIG. 2 is a graph depicting slant angle versus drag coefficient of the exemplary vehicle shown in FIG. 3. The vehicle 10 in FIG. 3 may be configured with a slant 12 having a slant angle as described below. For θ=0° (square-back), the flow fully separates from the sides of the blunt aft end of the model, which results in large scale interactions of flow structures that shed from the four sides of the model. The wake from the square back Ahmed model contains some key flow features seen in the wake of a tractor trailer or bluff car shape, such as an SUV. A slant-back configuration can be achieved by tapering the top portion of the Ahmed model. A pair of streamwise vortices and closed separation bubble develop with increasing strength as θ is increased from 0° up to θ=30° which is similar to flow seen on a sedan or hatchback type vehicle. Flow fully separates from the model beyond θ=30° resulting in lower drag as the energetic streamwise vortex structures are not present. An unstable configuration occurs if the slant angle is set to θ=30° as the flow randomly oscillates between the high drag partially attached state and the low drag detached state. The square-back model (θ=0°) can be used to represent the wake behind common vehicles, such as a tractor trailer, SUV, or minivan.

Flow on the front of the model initially detaches at the front nose radius, with transition-hastened reattachment occurring shortly downstream. The blunt rear shape then results in a massively separated wake formed of shed vertical structures from the four sides of the model. The wake dynamics can be relatively complex. The wake of the square-back Ahmed model oscillates between two span-wise symmetry breaking states.

D. Flow Control for Ground Vehicles

The sources of drag on vehicles are often complex and there is a limit to drag reduction from shape optimization within imposed design constraints. Some embodiments are therefore directed to other ways of modifying aerodynamic performance, such as by using: passive flow control, semi-active flow control, and active flow control.

1. Passive Flow Control

Passive flow control is the addition of a fixed shape modification to alter aerodynamic behavior that goes beyond the traditionally accepted methods of optimizing vehicle shape during development. Several types of passive flow control modifications include the addition of, but are not limited to, boat-tail flaps, vortex generators, or spoilers. The passive boat-tail flap is a method of base drag reduction on tractor trailers, and can provide C_{D} reductions greater than 50 counts. The flaps provide a taper to the bluff square trailer shape that was not present in the original design for reduction of wake size. Passenger vehicles inherently contain features of boat-tailing within the tapers at the rear of the car.

Another passive modification is the addition of vortex generators (VG), e.g., airfoil or vane shaped protrusions normal to the wall, to control separation via increased wall normal mixing. The tip vortices generated by the inclined airfoils have a strength which depends on the pitch, height, shape, and spacing of the VGs, as well as the incoming boundary layer and imposed pressure gradient. These devices can be used in aircraft applications due to their simplicity (no moving parts) and cost effectiveness. The height of the vortex generators for aircraft application is typically of order boundary layer thickness or less, however certain automotive applications may require VGs of greater height. Passive vortex generators have several disadvantages, the primary being the drag penalty associated with the additional projected area, and of relevance to the automotive industry is the impact on aesthetics and robustness of the exterior surfaces. There are possibilities to implement passive vortex generators into vehicle design while reducing or minimizing these penalties.

Spoilers can also be used in vehicle design to mitigate lift and drag, for example when applied to force separation at the roof end of a hatchback vehicle.

2. Semi-Active Flow Control

Semi-active flow control is a method of actively changing the vehicle shape or state of a passive device to suit driving conditions. An example of a semi-active device is a front air dam (used to reduce underbody flow volume and its associated losses) that extends during highway cruise but retracts for low speed driving to prevent impact with obstacles such as curbs. Another example is a retractable rear spoiler that extends at highway speeds to reduce lift, but retracts at low speeds to maintain a certain aesthetic appeal or durability. A third example of a semi-active device is a variable radiator grill shutters that control the amount of cooling flow through the engine bay based on the driving condition.

At low speeds the required grill opening is larger than at highway speeds, and the ability to modulate the airflow through the radiator can reduce total pressure losses and the associated drag penalty. There are many other possibilities for semi-active flow control devices within the definition that an active shape change occurs based on operating conditions.

3. Active Flow Control

Active flow control (AFC) is a method that introduces an additional energy perturbation through some type of device (flow control actuator) to alter the flow-field. There are several broad classes of active flow control that involve either the addition of momentum into the flow, a periodic or systematic perturbation to target or enhance natural instabilities, or a combination of both. There are many types of control actuators used to initiate the flowfield changes including plasma based devices, pneumatic jets, acoustic sources, synthetic jets, suction slots, and possibly other strategies that are unforeseen.

Vortex generating jets (VGJs) can actively produce the beneficial effects of streamwise vorticity with an operating envelope not possible with passive VGs. A VGJ can include a pitched and/or skewed jet that exhausts flush from the vehicle surface into the boundary layer. The jet outlets are usually spaced periodically across the span of interest with a relevant parameter being the spacing between jets.

One benefit of an active VGJ is that the state of the device can be varied based on operating conditions, which may be useful for active cross-wind stability control or other transient aerodynamic enhancements. The VGJ also introduces momentum into the flowfield from the issuing jet, which can also be used to delay separation. A further benefit of the flush mounted VGJ is the reduced or minimal aesthetic impact and reduced drag from the lack of projected area. One drawback of VGJs is the power consumed to generate the compressed air, which can overburden any drag improvements if used inefficiently.

There are many types of pneumatic actuators which likely result in some form of streamwise vorticity generation and act in part as a VGJ. Several examples include synthetic jets, steady microjets, suction and blowing jets (SAOB), and fluidic oscillators. Please note, the present disclosure contemplates actuators configured as any type of jet or other device that provides a pressurized jet or suction into a flow field, while keeping within the scope and spirit of the present disclosure. Fluidic oscillators are efficient active separation control devices, with a portion of the effectiveness thought to be the result of streamwise vorticity generation. The fluidic oscillator actuator is simple, effective, and efficient.

E. Fluidic Oscillator

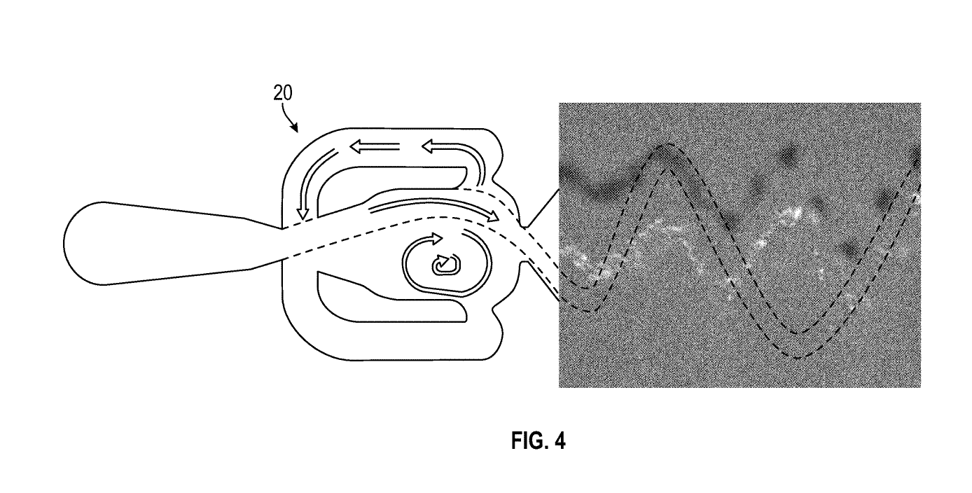

A fluidic oscillator, otherwise known as sweeping jet actuator, converts a steady flow input into a sweeping jet that may be used to manipulate a flowfield by increasing momentum and wall normal mixing within the boundary layer. An advantage of an oscillating jet over a steady jet is that momentum is injected over a broader region of the flowfield due to the sweeping motion. Several mechanisms can be used to generate an oscillating jet from a steady flow input. The feedback channel type oscillator shown in FIG. 4 can be used due to its simplicity and the wealth of data related to the internal and external flow fields.

FIG. 4 is a schematic representation of an exemplary fluidic oscillator 20. The purely fluidic conversion of a steady jet to sweeping jet occurs through a relatively simple mechanism. Flow initially enters the oscillator cavity and attaches to one of its walls, where a portion of the flow is diverted into the corresponding feedback channel. Flow in the feedback channel leads to a hydrodynamic pressure that initiates the switching of the incoming jet. The amount of fluid entering the feedback channel is amplified during the switching process until the jet rests on the opposite wall. This process then repeats at rates from several Hz to more than 20 kHz and scales approximately linearly with flowrate. There are other variations of the device that can decouple the flowrate from oscillation frequency, however the oscillation frequency, can be nearly on order of magnitude greater than the natural flow instabilities, which leads to frequency independent separation control for synthetic jet type actuators. The fluidic oscillator arrays used exhibit similar frequency independence (in terms of coherent structure modifications), so jet frequency is not of primary concern.

There are two mechanisms behind the oscillating jet's ability to control separation. First, the momentum introduced into the boundary layer by the sweeping jet can directly enhance separation resistance due to entrainment and acceleration of the low speed near wall flow. The most beneficial use of the raw jet momentum may involve a tangential configuration (where the jet aligns parallel with the surface), however in many cases this is not possible, which leads to the use of pitched jet orientations (where the jet direction does not align with the local surface tangent). The second mechanism behind oscillator effectiveness is thought to be the generation of streamwise vorticity in a manner similar to traditional pitched and skewed vortex generator jets. The vorticity increases mixing between the outer flow and boundary layer to maintain near wall forward flow. Generation of streamwise vorticity by fluidic oscillators is confirmed with oil flow patterns near the jet exit.

A single fluidic oscillator has limited influence on the global flow-field around the Ahmed model (or almost any practical application), therefore many oscillators are used to control separation over a region of interest. The most effective way to arrange oscillators is thought to be in a row aligned perpendicular to the flow direction. There may be special circumstances where interference between oscillators in the streamwise direction is desired or beneficial (possibly when conditioning a relatively thick boundary layer). Significant parameters to be considered when placing the oscillators in array are the width of jet exit (d) and the spacing between jets exits (λ). There is a limitation to the minimum λ that can be achieved due to the large width of the oscillator cavity geometry relative to the jet exit width (d) (see FIG. 4). λ up to 38 mm is more efficient (in terms of C_{μ} requirements) than more closely spaced oscillators at λ=19 mm. Variable spacing may also be desired based on the local need for separation control

Fluidic oscillator separation control on the vertical tail section of a Boeing 757 is effective at increasing rudder control authority by up to 20%. The devices can be used to control separation ahead of boat-tail flaps on the G.E.T.S. model, which is of similar geometry to the Ahmed model. Pitched fluidic oscillators can be used on the 25° Ahmed model at the roof-slant interface to control separation over the rear slant surface, resulting in a drag reduction near 7%. The oscillators reduce the spanwise coherence of the vertical structures shed from the roof and eliminate the separation bubble. Oscillators can be applied to the DriveAer vehicle model, similar to a mid-size sedan, for separation control over the rear window.

F. Fluidic Oscillator Flow Control on the Ahmed Model

Some embodiments are directed to vehicle flow control application through fluidic oscillator separation control variations on the square-back Ahmed model. C_{μ} (momentum coefficient) is not the governing parameter for the oscillators' effect on drag reduction. The jet velocity ratio (VR=Vⱼ/V_{∞}) is a more important predictor than C_{μ}, with an optimal VR close to 5. Therefore a reduction in C_{μ} can be achieved by increasing jet spacing while maintaining the optimal velocity ratio. The maximum jet spacing used can be close to 38 mm to determine whether the maximum oscillator spacing can be further increased while maintaining control authority. Several combinations of oscillator size and spacing (42 mm and 88 mm) can be examined using a tangential jet configuration on the 166% scale Ahmed model.

A maximum thrust corrected drag reduction close to 60 counts can be achieved with 20° flaps at C_{μ}=3%.

It may also be beneficial to determine whether the 20° flap optimum holds for the slightly different Ahmed model geometry. The primary geometric difference between the Ahmed model and G.E.T.S. model is the rear aspect ratio (W/H), which is 1.33 and 0.75 respectively. The forebody features are similar between the two models; however the sideways shedding modes may be more dominant on the G.E.T.S. model due to the smaller W/H ratio. Ground effect can also be examined. The step height between the top of the model and flap surface can also be varied. A small step is required in order to accommodate the tangential oscillator jet outlet (nominally 6 mm), which results in a forced separation at the roof end. Ideally the flow would immediately reattach to the flap after this interface, such that the flaps would act as an optimal baseline configuration, however the flow has a finite attachment length and therefore the passive flaps may not approach optimal performance until the flap length is sufficiently greater than the natural reattachment length.

The present disclosure focuses on tangential jets with a 50% shorter 3 mm step height, which leads to a greater flow attachment response. A pitched jet configuration with smooth shoulder curvature can also be used to eliminate the step interface between the jet exit and flap surface. A 30° oscillator pitch angle and a 39 mm jet spacing can be used.

Fluidic oscillator separation control is highly sensitive to jet location in airfoil evaluations. Generally the boundary layer is most receptive to control at or slightly ahead of the separation location. The other trends, such as ride height, speed changes, and moving ground plane can be examined to understand the relevance of the test conditions.

### II. Setup and Equipment

A. Square-back Ahmed Models

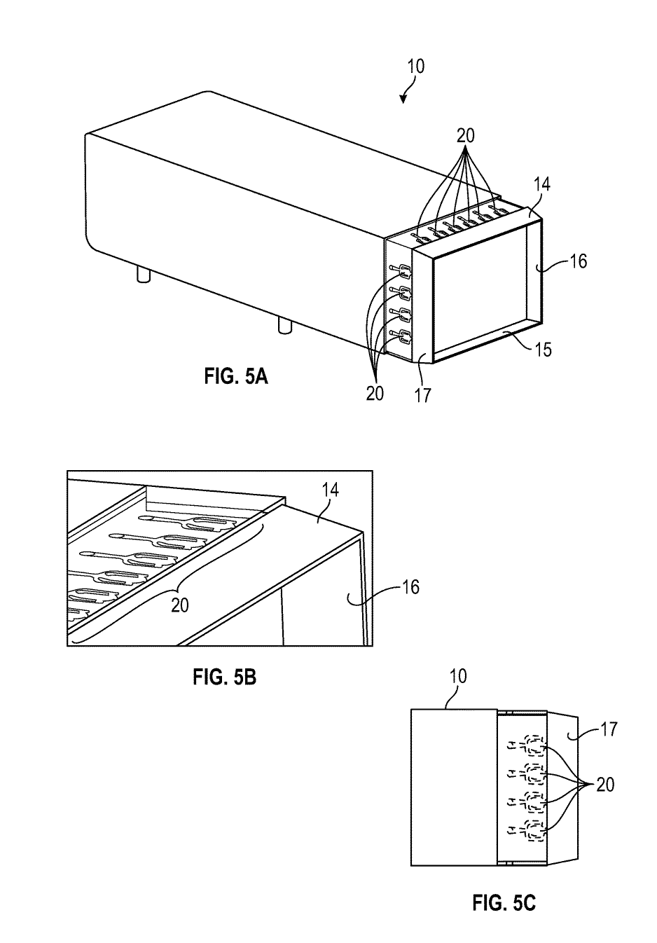

Several modified versions of the square-back Ahmed model geometry can be used. A significant modification to Ahmed's original design is the addition of an assembly containing boat-tail flaps with fluidic oscillators upstream of the flaps for separation control, as shown in FIG. 5A-C.

FIG. 5A is a perspective view of an exemplary square-back vehicle 10 including flaps. FIGS. 5B-C are perspective views of exemplary fluidic oscillators 20 on the square-back vehicle 10 of FIG. 5A. The vehicle 10 may be configured to include a flap assembly 13 including a top flap 14, a bottom flap 15, a side flap 16, and a side flap 17.

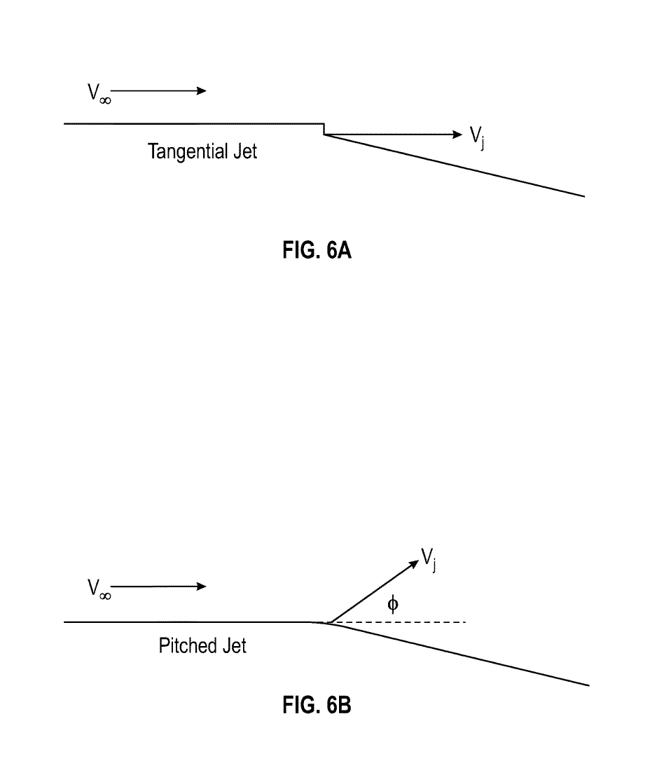

FIGS. 6A-B are vector representations of an exemplary tangential oscillator jet 20 on an exemplary vehicle 10. FIG. 6A depicts a tangential jet, while FIG. 6B depicts a pitched jet.

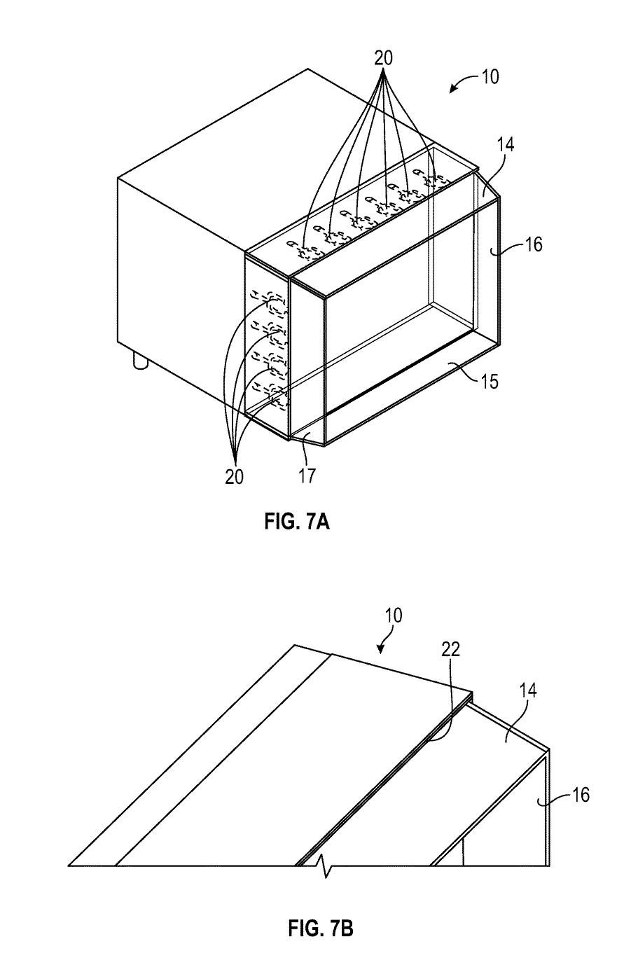

FIG. 7A is a perspective view of an exemplary square-back vehicle 10, and specifically a modified square-back Ahmed model, including tangential fluidic oscillator jets 20. FIG. 7B is a perspective view of the oscillator jet outlets 22 of FIG. 7A. The tangential jet assembly can be applied to the 83% and 166% scale Ahmed models, while the pitched jet assemblies can be used on the 166% Ahmed model.

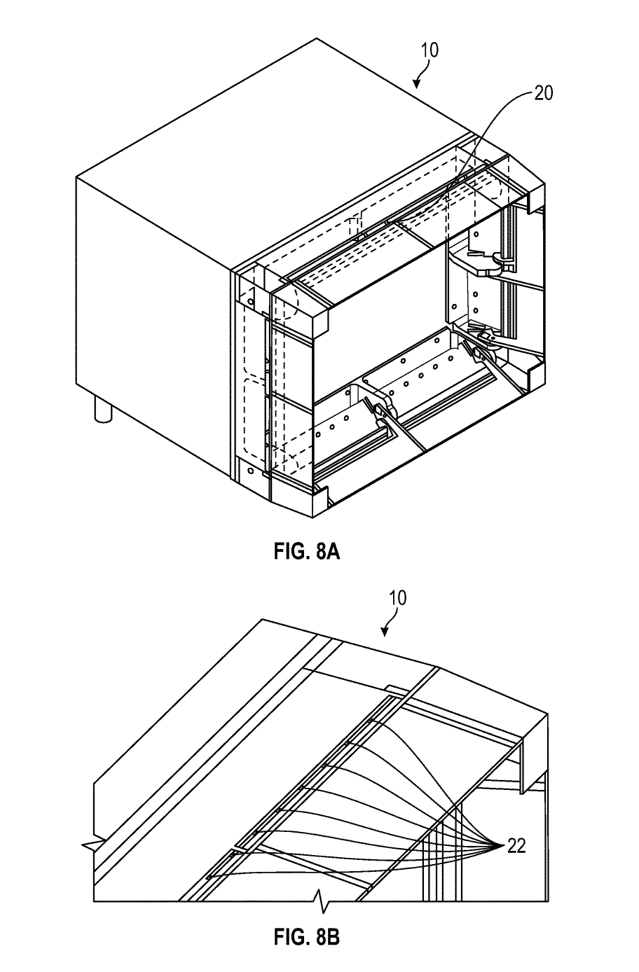

FIG. 8A is a perspective view of an exemplary square-back vehicle 10 including pitched fluidic oscillator jets 20. FIG. 8B is a perspective view of oscillator jet outlets 22 of FIG. 8A.

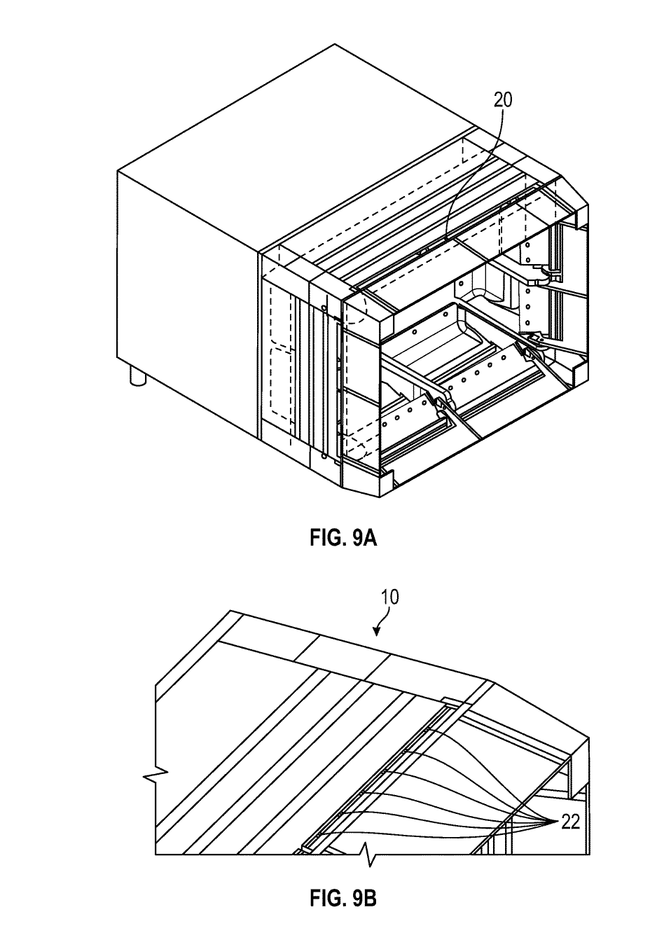

FIG. 9A is a perspective view of an exemplary square-back vehicle 10 including pitched fluidic oscillator jets 20. FIG. 9B is a perspective view of oscillator jet outlets 22 of FIG. 9A.

The testing of three different aft assemblies on the 166% Ahmed model, one with tangential jets and two with pitched jets, are depicted in FIGS. 6A-9B. The tangential jet includes acrylic oscillators arrays (described in section 2.2) and flaps constructed from 3 mm thick acrylic laser cut for the appropriate corner miters. Discrete detachable boat-tail flap assemblies can be made for each angle setting. The uncertainty in the flap angle across the span is close to 1.5°. The gap between the flap surface and lower exit of the jet can be reduced to less than 1 mm.

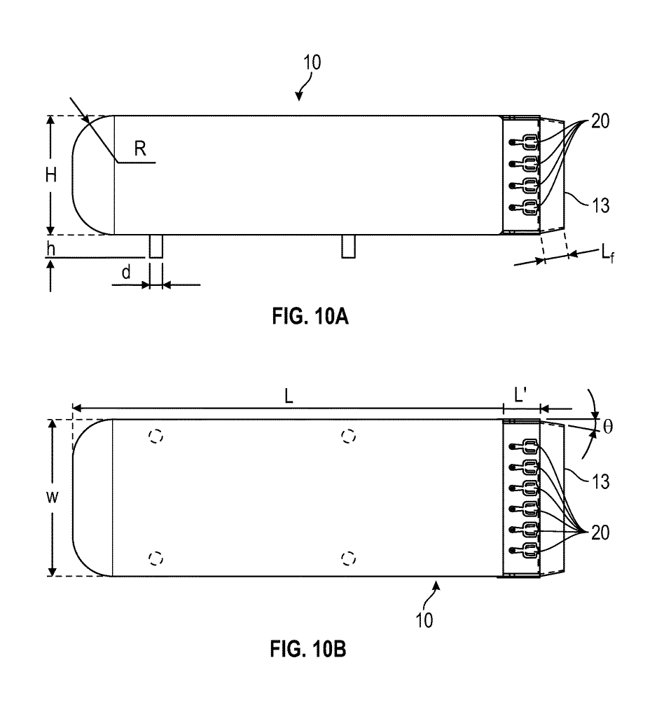

The pitched jet A and B assemblies can be used for the flap angle and jet location models, respectively. The main assembly, flaps, jet mounts, and other surfaces can be 3-D printed using selective laser sintering (SLS). The SLS printed base structure can be designed to accept various oscillator array assemblies. Flap angle can be continuously variable on all sides and locked into place with set screws. A digital angle gauge can be used to set the flap angles to within 0.5° across a given flap span, and the interfaces between the flap and shoulder curvature can then be sealed with foil tape to prevent unwanted interaction with the flap flow and base cavity. The interface between the roof end and flap leading edge includes a 43 mm circular radius. The Ahmed model design and dimensions can be found in FIGS. 10A-B and Table 1.

### Table 1

FIG. 10A is a side view of an exemplary square-back vehicle 10. FIG. 10B is a bottom view of the square-back vehicle 10 of FIG. 10A. The vehicle 10 may be configured to include oscillators 20 and a flap assembly 13.

TABLE 1
Ahmed model dimensions.

| | | 83% Model | | 166% Model | | 166% Model | | 166% Model | |
|---|---|---|---|---|---|---|---|---|---|
| Symbol | Description | Tangential Jets | | Tangential Jets | | Pitched Jet A | | Pitched Jet B | |
| L | Base Length | 869 | mm | 1738 | mm | 1738 | mm | 1738 | mm |
| L′ | Actuator | 75 | mm | 75 or 150 m [symbol] | | 75 or 150 mm | | 232 | mm |
| | Length | | | | | | | | |
| W | Width | 318 | mm | 636 | mm | 636 | mm | 636 | mm |
| H | Height | 239 | mm | 478 | mm | 478 | mm | 478 | mm |
| h | Ride Height | 30, 55, 80 m [symbol] | | 94 | mm | 100 | mm | 100 | mm |
| R | Front Radius | 83 | mm | 166 | mm | 166 | mm | 166 | mm |
| D | Support | 25 | mm | 25 | mm | 25 | mm | 25 | mm |
| | Diameter | | | | | | | | |
| L_{f} | Flap Length | 48 | mm | 96 | mm | 100 | mm | 100 | mm |

| | | | | | |
|---|---|---|---|---|---|
| θ | Flap Angle | 10°, 15°, 20° | 10°, 15°, 20° | 0° ≦ θ ≦ 30° | 0° ≦ θ ≦ 30° |

[symbol]

indicates data missing or illegible when filed

B. Fluidic Oscillator Arrays

Several modified fluidic oscillators used in some embodiments are based on the wall attachment geometry similar to that shown in FIG. 4. The relevant oscillator array parameters for some of the embodiments are the spacing between jets (λ), exit nozzle width (d), and jet pitch angle relative to the freestream direction (φ). Two primary variations of oscillators used in the presented embodiments are 30° pitched and tangential.

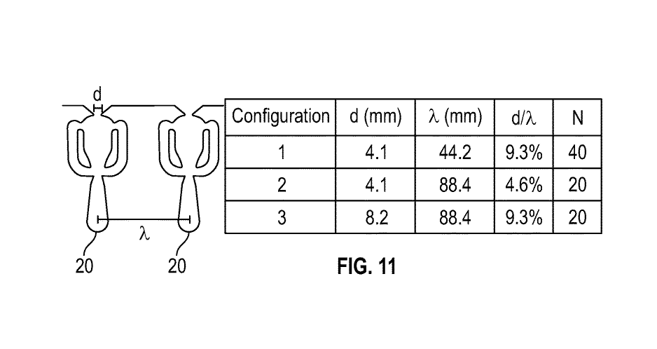

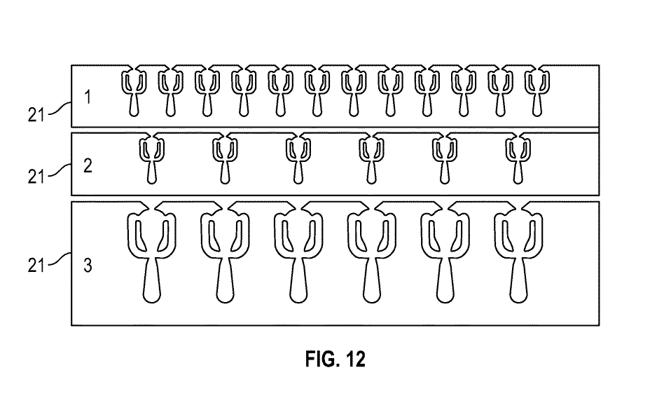

The 83% Ahmed model can be equipped exclusively with tangential jets spaced at 44 mm with a jet width d=4.1 mm. Three tangential actuator configurations, depicted in FIGS. 11 and 12, can be tested on the 166% scale Ahmed model to determine the effects of actuator size and spacing. Configuration 1 contains the original actuator size and spacing used for the embodiment on the 83% Ahmed model, with twice the number of actuators. Configuration 2 has the same number and size of oscillators used on 83% model with a proportionally larger spacing, such that the jets were at the same scaled locations. Configuration 3 contains double scaled oscillators at the same location as configuration 2. The pitched jets A and B configurations used removable actuators spaced at A=39 mm with jet diameters of d=4.1 mm.

FIG. 11 is a schematic representation of exemplary fluidic oscillators 20. FIG. 12 is a schematic representation of exemplary oscillator array 21 layouts. The oscillator array 21 layouts in FIGS. 11-12 are used for actuator scaling embodiments based on the 166% model.

All actuator arrays can be constructed via lamination of laser cut acrylic pieces, including a 1.5 mm cover plate, 1.5 mm oscillator cavity, and 5 mm bottom plate with tapped holes for inlet air fittings. The pitched jets require an additional milling operation to achieve the desired pitch angle.

Oscillator blowing rate is generally expressed herein in terms of C_{μ} or less frequently in terms of velocity ratio (VR=Vⱼ/V_{∞}). The dimensionless momentum coefficient,

$${C}_{μ} = \frac{N {ρ}_{j} {A}_{j} {V}_{j}^{2}}{\frac{1}{2} {ρ}_{∞} {AV}_{∞}^{2}}$$

has a fundamental meaning as the ratio of jet momentum relative to half of the freestream momentum displaced by the projected area of the model. The numerator represents the actuator momentum flux, which is approximately the maximum thrust that the jet can produce. The subscript j indicates quantities related to the actuator jet.

The area term in the denominator is selected as the model frontal area. The momentum coefficient is preferably calculated from a directly measured jet velocity. Thus, a more conservative mass balance approach can be used, where the exit velocity is estimated from the mass flux at the exit throat. The flow at the nozzle is assumed to be uniform with an air density equal to ambient conditions. The momentum coefficient may then be written as,

$${C}_{μ} = \frac{2 {\dot{m}}^{2}}{{ρ}^{2} {AA}_{j} {NV}_{∞}^{2}}$$

where \dot{m} is the mass flowrate to the array, Aⱼ is the throat area of a single jet in the array, N is the number of actuators in the array, A is the model frontal area, and ρ is the density of the air and jet (which were assumed equal).

C. Wind Tunnel Facilities

Data presented in this disclosure can be collected at two wind tunnel facilities, a first subsonic wind tunnel facility (1WT) or in a scale wind tunnel (2WT). Particle image velocimetry data can be collected at 1WT, while other datasets can be taken at 2WT.

1. First Wind Tunnel (1WT)

The OSU Battelle wind tunnel facility is open loop with a closed test section capable of speeds in excess of 40 m/s. The test section dimensions are 1.0 m tall, 1.4 m wide, and 2.4 m in the streamwise direction. The turbulence intensity is less than 0.5%. Tunnel speed can be measured with total and static pressure rings ahead of the test section, which can be read with an electronic pressure transducer connected to a computer with LABVIEW data acquisition software. The front of the Ahmed model can be positioned 0.82 m (3.4/4) from the start of the test section, and placed midway between the sidewalls with an uncertainty of ±2 mm. Pitch and yaw angles can be set as close to zero as possible, with an uncertainty of ±0.5°. This tunnel can be used to collect particle image velocimetry data (PIV) on the 83% scale Ahmed model.

2. Second Wind Tunnel (2WT)

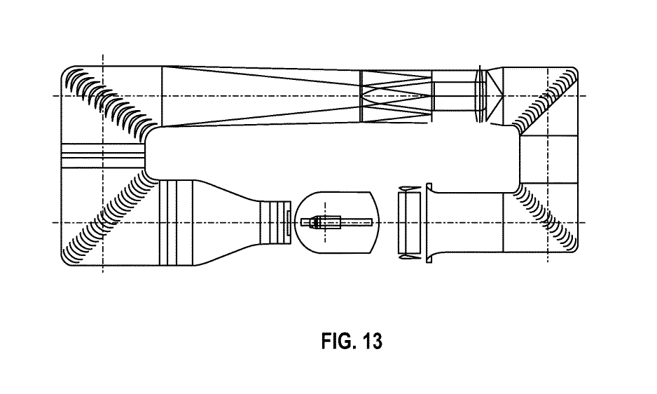

FIG. 13 is a schematic representation of an exemplary wind tunnel. 2WT with a closed loop design and open test section capable of 70 m/s, as shown in FIG. 13. The test section is 6.7 m long with a nozzle area of 4.15 m². The 2WT 6-axis load cell has 2σ uncertainty of ±0.07 N, which in practice allows a 2σ uncertainty within C_{D}±0.0007. The load cell measurement system connects to the model via the four support posts outlined in the original Ahmed geometry. In some embodiments, drag can be averaged over three 60-second periods. The thrust generated by the oscillators can be removed from the measured C_{D} by conducting the force tare with the actuators ON and tunnel OFF. Removing the beneficial thrust component from the drag measurements more accurately represents the flowfield changes that occur with actuation. An alternative thrust correction may be provided by adding the C_{μ} to the drag value, however the tare method may be desirable for also subtracting possible unwanted forces from flex of the air tubing that enter the model as the lines are pressurized.

D. Pressure Measurements

Pressure measurement equipment can be used for flowfield diagnostics at 2WT. Wake total pressure surveys can be taken with a 785 mm wide 40 probe rake attached to an automated traverse. The wake total pressure surveys presented herein have a vertical resolution of 20 mm and horizontal resolution better than 25 mm. Pressure can be sampled at a rate of 10 Hz for 60 seconds per vertical traverse location. Wake pressure measurements can be presented in terms of Cₚ, which is defined as

$${C}_{p} = \frac{{p}_{o} - {p}_{∞}}{\frac{1}{2} {ρ}_{∞} {V}_{∞}^{2}}$$

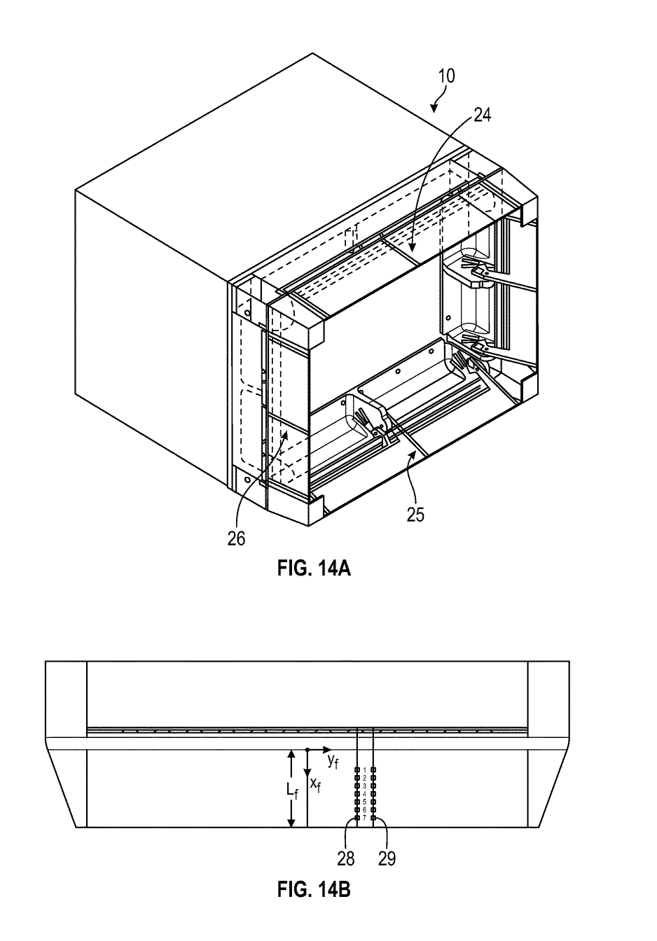

Total pressure can be measured with a 64 channel transducer (ESP-64HD-DTC-2500 Pa-Gen2) rated to within ±4 Pa. This transducer can also be used for the static tap pressure measurements at 2WT. Static pressure taps can be added to the upper, side, and lower flap surfaces to measure the pressure gradient and infer the attachment response. Two rows of taps can be added on each flap surface, one downstream of an oscillator jet, and another row between oscillator jets, as shown in FIGS. 14A-B.

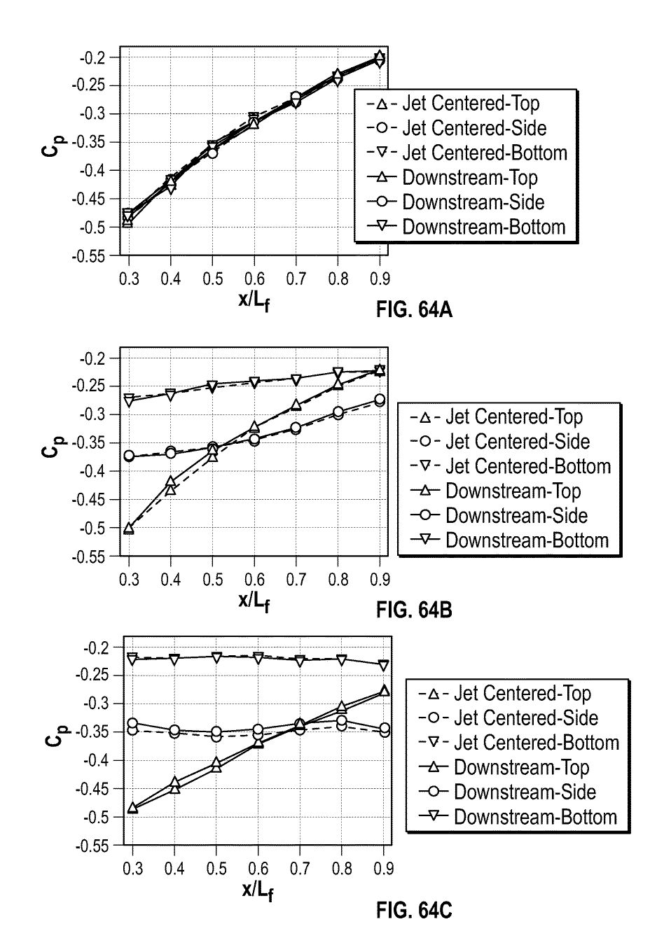

FIG. 14A is a perspective view of an exemplary square-back vehicle 10 including flap pressure taps 24, 25, 26. FIG. 14B is a top view of the upper flap pressure tap 24v of FIG. 14A. Specifically, location of the flap pressure taps on the rear of the modified Ahmed model 10 is shown, including downstream taps 28 and centered taps 29. The purpose of the two offset rows of taps is to determine the degree of spanwise variation in the attachment response (see FIGS. 64A-C).

Table 2 indicates the static tap locations relative to the coordinate system given in FIGS. 14A-B. The inner tap diameter is nominally 0.7 mm and the tubing length is relatively long (greater than 5 m) due to the distance from the model to the pressure scanners located on the traverse. The pressure results can be time averaged, so the hampered dynamic response from the long pressure tubing is not a concern.

TABLE 2
Flap static pressure tap locations relative
to spanwise center at the flap start.

| Flap | y_{f} (mm) | Tap 1 x_{f} (mm) | Δ x_{f} (mm) |
|---|---|---|---|
| Upper (downstream) | 59 | 30 | 10 |
| Upper (centered) | 78 | 30 | 10 |
| Side (downstream) | 59 | 30 | 10 |
| Side (centered) | 78 | 30 | 10 |
| Lower (downstream) | 59 | 30 | 10 |
| Lower (centered) | 78 | 30 | 10 |

All static pressure measurements herein are presented in terms of the following Cₚ definition.

$${C}_{p} = \frac{{p}_{o} - {p}_{∞}}{\frac{1}{2} {ρ}_{∞} {V}_{∞}^{2}} .$$

E. Particle Image Velocimetry

Particle image velocimetry (PIV) data can be acquired in the 1WT wind tunnel using DaVis PIV software and a double exposure camera (PCO.1600). A double pulse ND:YAG 532 nm laser (Quantel Evergreen 200 mJ/pulse) and 19 mm focal length cylindrical lens can be used to illuminate the seed particles. Tunnel seeding with atomized olive oil can be achieved with two Laskin nozzle type seeders injected into the tunnel flow through a grid assembly located ahead of the flow conditioning screens in the tunnel inlet. Double-pass cross correlation with a 16×16 pixel interrogation window and 50% overlap can be used to calculate the vector fields. A calibration grid can be used to allow DaVis to correct for camera skew and determine the image plane size.

PIV can also be acquired at the 2WT facility with a Dantec Dynamics based system that includes an ND:YAG 532 nm laser (Nano L200-15 PIV), double exposure camera (Flow Sense EO 11M), and Dynamic Studio v3.41 software. The tunnel can be seeded with atomized olive oil injected into the tunnel beyond the fan. Double-pass cross correlation can be used on a 32×32 interrogation window with 50% overlap. The ensemble averages presented herein contain 100 vector fields taken at a rate of 2.5 Hz. This system can be used for the PIV data that illustrates the presence of wake bi-stability=.

F. Mass Flow Controller

The mass flow-rate to the fluidic oscillator arrays can be controlled with digital flowmeters. A single flow meter is capable of powering the oscillators on the 83% scale Ahmed model at the 1WT wind tunnel. Tests on the 166% scale Ahmed model, and the high Re embodiments based on the 83% Ahmed model at 2WT require two mass flow controllers in parallel to deliver the required flow rate. The meters can be supplied with 900 kPa (130 psi) shop air, and exhausted into a distribution manifold that feed each oscillator in the array. The pressure drop across an individual oscillator is much lower than the supply pressure to the flowmeter (˜10 kPa). Equal length tubing (6.4 mm ID) and consistent fitting arrangements can be used for each channel in the manifold to promote similar flow rates to each oscillator. The 9 SLPM accuracy of the digital flowmeters allow for good repeatability of mass flow, which is typically greater than 200 SLPM per meter.

### III. Results

A. Local Effects of Fluidic Oscillator Separation Control

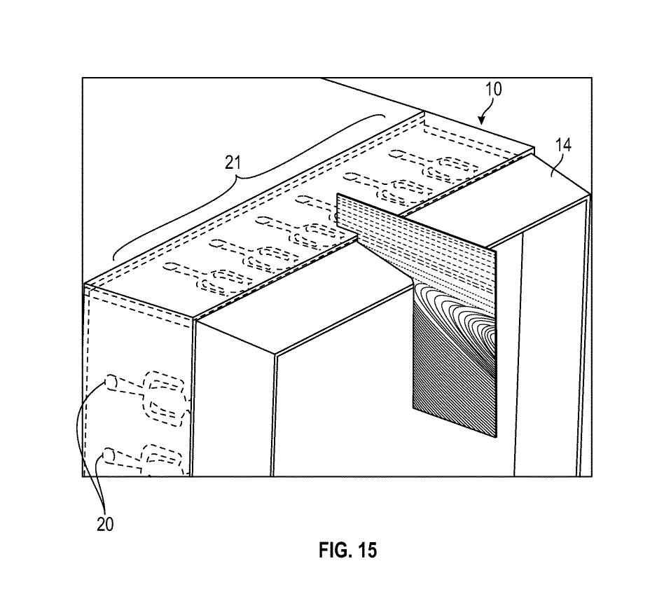

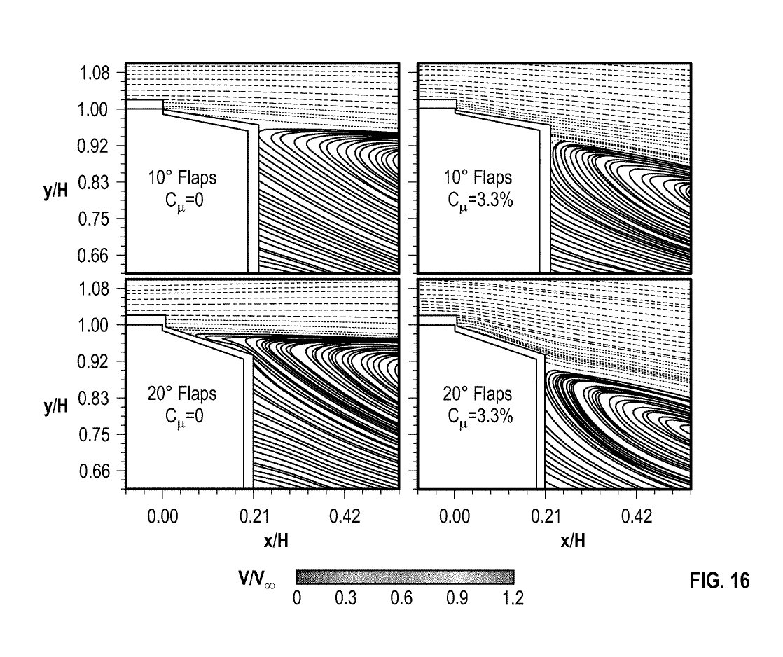

In this disclosure, fluidic oscillators are used to locally control separation on the boat-tail flap surfaces added to the aft portion of the square-back model. The local effect of control is exemplified by the particle image velocimetry data in FIGS. 15 and 16, which is taken for two different flap angles on the 83% Ahmed model with tangential jets at the 1WT wind tunnel facility (Re=1.4×10⁶). The location of the image plane is as shown in FIGS. 15 and 16 at the model centerline (between the two center jets) over the upper flap surface. Data in the white masked regions is not available due to laser reflections, while black mask regions indicate the body geometry. The location (x,H=0, y/H=1) corresponds with the jet outlet location. The step near the jet outlet was due to the geometric condition required for a tangential jet.

FIG. 15 is a perspective representation of particle image velocimetry (PIV) near the upper flap 14 of an exemplary vehicle 10. Specifically, FIG. 15 shows data near the upper flap on the 83% model equipped with 10° or 20° flaps and tangential jets. FIG. 16 is a graphical representation of particle image velocimetry (PIV) of FIG. 15.

The baseline flow on the 10° flap shown in FIGS. 15 and 16 is partially attached. The flow is attached with actuation (C_{μ}=3.3%), which leads to a decrease in wake size. The baseline flow on the 20° flap is initially fully detached, and becomes partially attached with control, which also leads to a smaller wake.

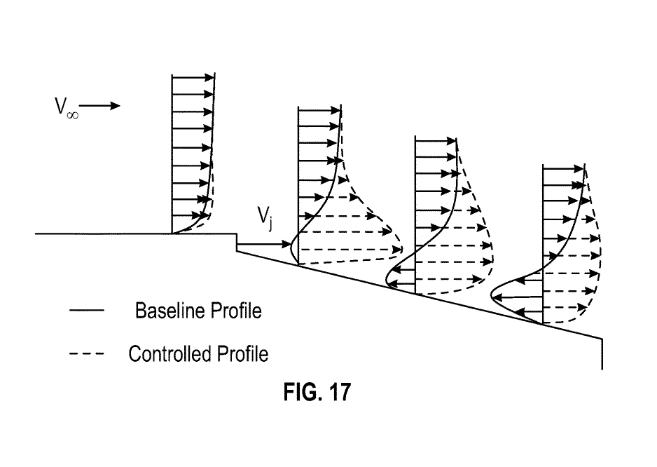

There are two primary mechanisms behind the fluidic oscillators' ability to attach flow. One is that the high speed jet has a momentum component tangential to the wall, which entrains and accelerates the boundary layer fluid thereby delaying the onset of reverse flow. A notional depiction of the interaction between the high speed jet and local flow is shown in FIG. 17.

FIG. 17 is a vector representation of a flow profile over an exemplary flap surface without and with fluidic oscillator flow control based on an injected jet momentum. The boundary layer profile is enhanced as the jet momentum diffuses toward the wall due to viscous and turbulent shear stresses. The momentum from the oscillator diffuses more effectively into the boundary layer due to the additional mixing provided by spanwise oscillation of the jet. Fluid just ahead of the jet is also accelerated due to continuity requirements.

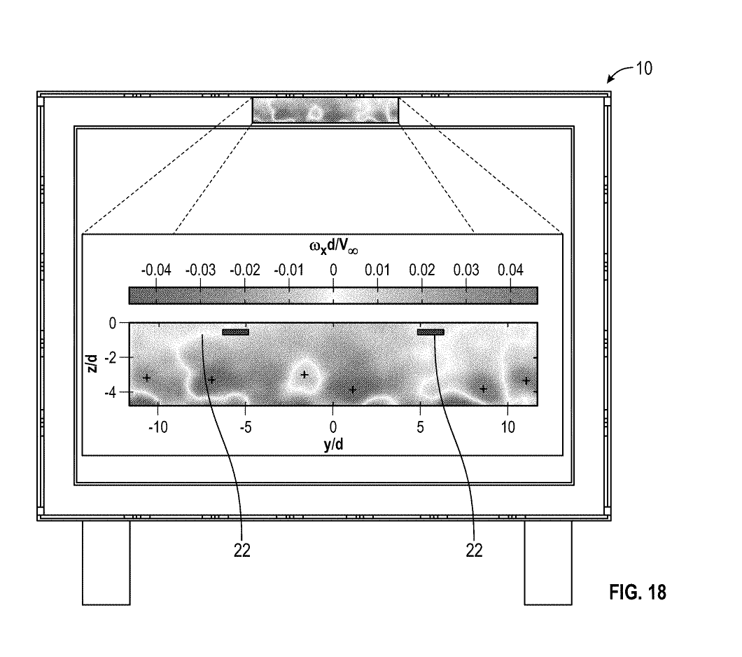

FIG. 18 is a representation of streamwise vorticity mapped at a flap end of an exemplary vehicle. Specifically, streamwise vorticity mapped at the flap end of the 83% Ahmed model equipped with 20° flaps at a jet velocity ratio of three. The two black rectangles near y/d=±6 indicate the jet exit locations, or oscillator outlets 22.

Generation of streamwise vorticity is another contributor to oscillator effectiveness. FIG. 18 shows streamwise vorticity behind the 83% model at the flap end (45 mm downstream of the jet exit) with the 20° boa t-tail at Re≈1.2×10⁶ (20 m/s). The streamwise vorticity magnitude is normalized by the jet diameter and freestream velocity, and the ensemble average of 750 instantaneous snapshots is filtered with a 4×4 data point averaging window. The vertical extent of the inset image includes the projected height between the roof and end of the 20° flap, while the width encompasses two jets (located at y/d=±5.4, z/d=−0.34).

A counter-rotating vortex pair is suggested about each oscillator exit with a sense of rotation that generates a jet centered upwash. In addition to the primary vortices centered about z/d=−3, secondary near wall vorticities of opposite sense are formed. The vortices remain attached to the flap surface until the flap end, as suggested by the vertical offset between the upstream jet exit and mean height of the generated vortices. The vorticity generation is also validated at another 1WT facility using a single pitched fluidic oscillator (select results are presented in Appendix A) in a zero pressure gradient environment. This setup generates a greater vorticity magnitude, because streamwise vorticity is more efficiently generated with the pitched fluidic oscillator. The vorticity results allow for a useful interpretation of the separation control mechanism.

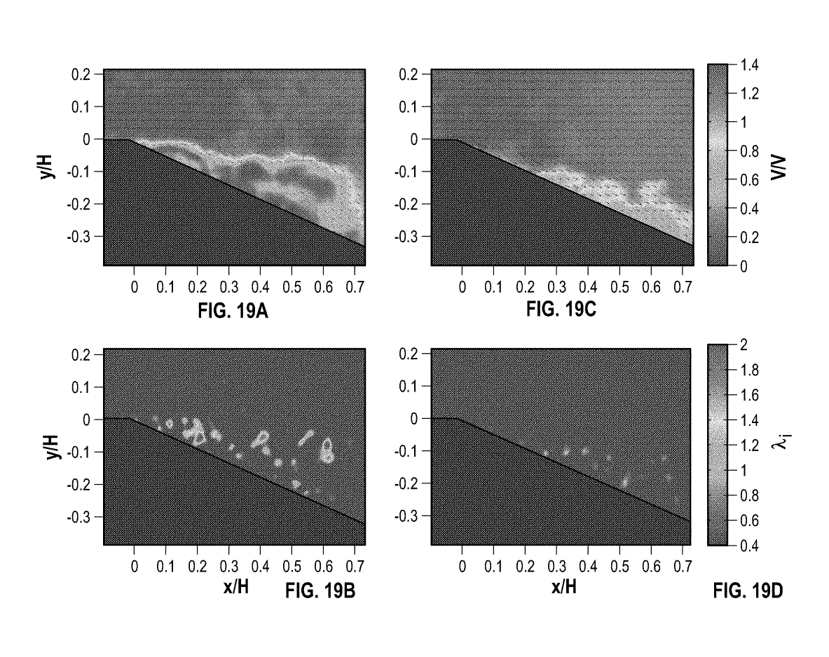

The large degree of spanwise variation seen in FIG. 18 may also have an effect on large scale wake structures. In the instantaneous sense, the separated shear layer is formed of shed vortex structures with coherence along the flap span. These structures may be approximated to contain a tangential velocity about the vortex center and a convective velocity. Separated flow may be present in regions where the vortex reverse tangential velocity exceeds the streamwise convective velocity. Discrete forcing across a span attenuates the vortex coherence and strength, which contributes to the time averaged attachment, as shown by the instantaneous flowfield images over the rear slant of a 25° Ahmed model in FIGS. 19A-D.

FIG. 19A is a graphical representation of an instantaneous velocity magnitude at a roof-slant interface of an exemplary vehicle without fluidic oscillator separation control. FIG. 19B is a graphical representation of an instantaneous swirling strength at a roof-slant interface of an exemplary vehicle without fluidic oscillator separation control. FIG. 19C is a graphical representation of an instantaneous velocity magnitude at a roof-slant interface of an exemplary vehicle with fluidic oscillator separation control. FIG. 19D is a graphical representation of an instantaneous swirling strength at a roof-slant interface of an exemplary vehicle with fluidic oscillator separation control. Specifically, instantaneous flowfield is shown at the roof-slant interface of a 25° Ahmed model without and with fluidic oscillator separation control. Flow is from left to right.

FIGS. 19A-B show instantaneous velocity magnitude, while FIGS. 19C-D show the swirling strength of the respective snapshots. The flowfield shown in FIG. 19A leads to separated flow in the time average while FIG. 19C is attached. A similar phenomena occurs with active control over the flap surfaces on the rear of the modified square-back Ahmed model. Although the local changes in the flow field are subtle, the global effect on the wake and pressure fields can significantly alter the drag force on the model.

B. Global Effects of Separation Control on the Wake

Local separation control on the flaps can lead to substantial changes in the wake and drag coefficient. The primary way to reduce drag on the Ahmed model (or almost any bluff body) is to increase the average pressure on the rearward facing (base) surfaces. This generally involves decreasing the wake size by vectoring the wake inwards, in this case with flaps and active control. Vectoring the flow from the streamwise direction imparts a lower pressure on the flap surface, which contributes locally to drag. This low pressure is further accentuated with active control from the jet turning action on the flap shoulder due to the Coanda effect. Pressure then begins to rise beyond the suction peak of the flap shoulder and steadily increases as the effective wake area enclosed by the outer potential flow decreases.

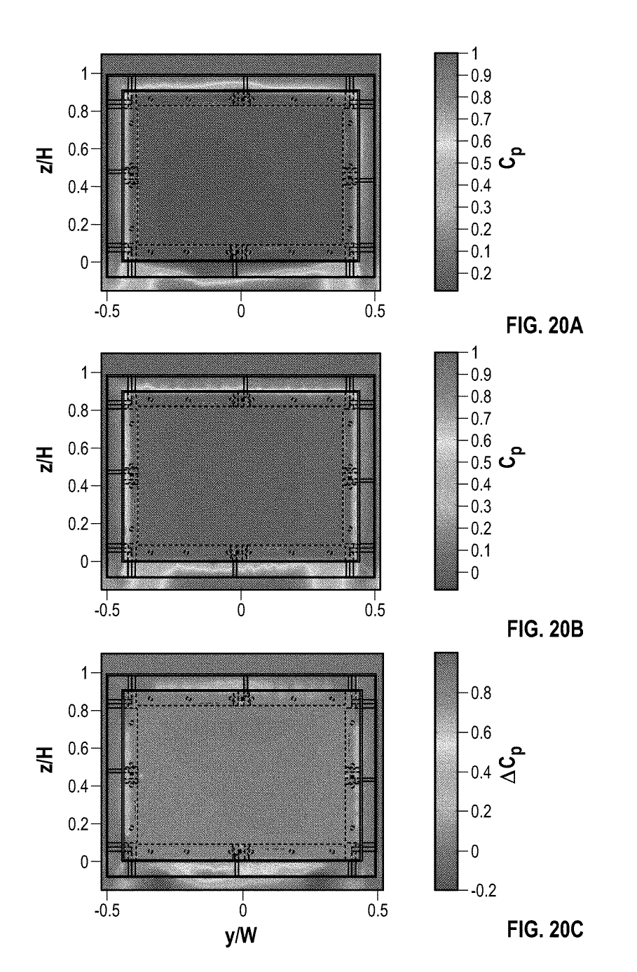

The main beneficial interaction occurs in the base region, where the shear layers from the four sides of the model impinge and vector rearward (in the time averaged sense). The wake survey plots FIGS. 20A-C show the baseline flow behind the pitched jet B model with 20° flaps and 30° jets, without and with actuation. The baseline flow shown in FIG. 20A is weakly attached and contained an asymmetrically large separation on the lower flap. The actively controlled condition shown in FIG. 20B suggests that flow became attached to all flap surfaces, which leads to the ΔCₚ shown in FIG. 20C. The presence of the discrete jets is still sensed at the survey location H/2 behind the model, as indicated by the local ripples in total pressure near the flap surfaces. In this case, the average pressure on the central base surface increased by 41 counts (as measured with static taps) and drag decreased by 26 counts with active control.

FIGS. 20A-C show wake survey data from the square-back model with 20° flaps and 30° pitched jets located at 0d (pitched jets B model). FIG. 20A represents the unactuated flow, FIG. 20B is with actuation at C_{μ}=2.2%, and FIG. 20C is the difference between FIGS. 20A-B.

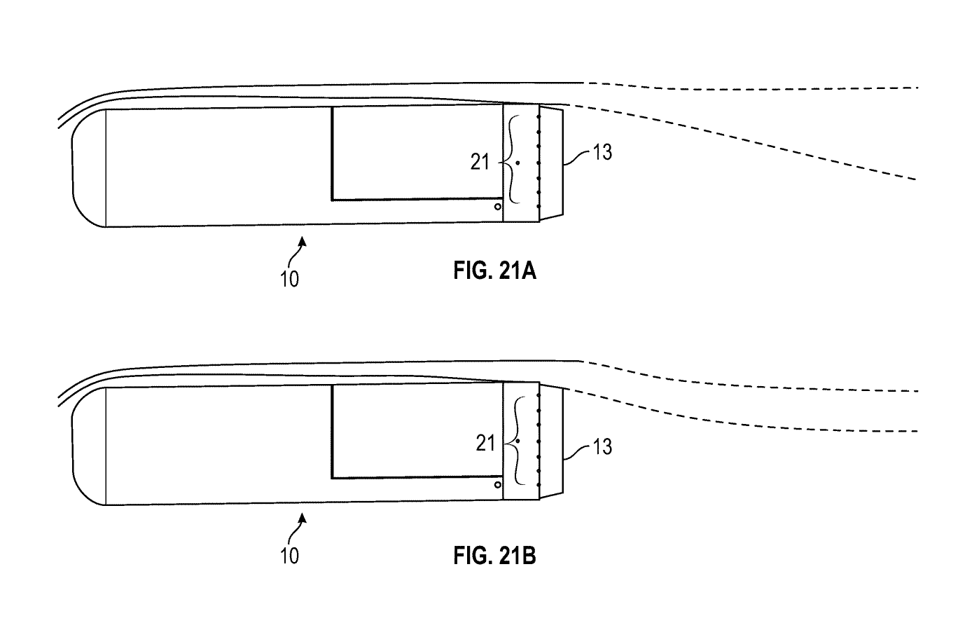

FIGS. 21A-B show smoke visualization of the wake behind the 83% Ahmed model, which suggests a reduction in wake size and unsteadiness when active control is applied over the 10° flaps.

The wake changes resulting from actuation may be qualitatively understood from the smoke visualization on the 83% model with 10° flaps shown in FIGS. 21A-B. The baseline flow is partially attached to the flaps and becomes fully attached with control, as indicated by the PIV of FIGS. 15 and 16. The smoke visualization indicates that actuation leads to a thinner and less turbulent wake. This suggests that the large scale structures shed from the back of the model, which make up the bulk of the turbulent fluctuations, are attenuated. This may be similar to the suppression of vortex shedding that occurred with the addition inset straight flaps on a simplified square-back model. The spectral peaks associated with vortex shedding from the top-bottom and side-side interactions are significantly reduced with the addition of the straight (0°) inset flap surface. The 10° flap surface in the current disclosure coupled with the active control leads to a further reduction in turbulence levels. Spectral measurements of the wake behind this setup have also been considered. The effect of separation control on the wake and base pressure may be summarized as follows: there is a local penalty on the flap surface due to flow turning, however the increased pressure in the central base region leads to overall base pressure increase and drag reduction.

C. Flap Angle

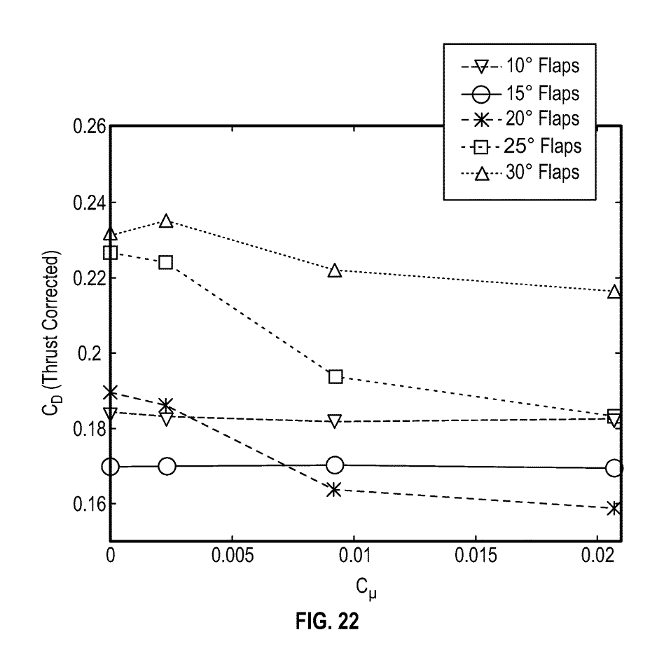

A flap angle embodiment can be based on the 166% scale Ahmed model. The flap angle embodiment with pitched jet configuration A (see section 2.1) is provided in FIG. 22 at Re=2.8×10⁶. The jet pitch angle was 30° and the outlet location are immediately ahead of the initiation of flap curvature. Flap angles ranging from 10° to 30° can be implemented with actuation up to C_{μ}=2.1%.

The jet OFF case (C_{μ}=0) may be considered to be a fair comparison to passive boat-tail flaps due to the smooth interface between the model body and flap surface. A minimum passive drag coefficient of 0.170 is realized with 15° flaps followed by 10° flaps at C_{D}=0.184. The unblown 25° and 30° flaps have similar drag values because the flow is almost fully separated from the flap surfaces. The baseline square-back drag coefficient may have been approximated by a θ=0° flap setting, however results from the pitched jets B model indicate a value close to 0.26. The presented results allow for an evaluation of the active control benefit for a given flap setting.

In one example, drag reduction trends as a function of C_{μ} or several flap angles. The jet angle can be set to 30° (pitched jets A model—see section 2.1).

The drag coefficient value for the marginally attached 20° flap begins to decrease, as actuation is applied, reaching a minimum active drag value of C_{D}=0.159 at C_{μ}=2.1%, which is nearly 10 drag counts lower than the best case passive 15° flap. Drag generally decreases with actuation on the 25° and 30° boat-tails by up to 44 and 15 counts respectively at C_{μ}=2.1%. The reduction is not monotonic with the 30° flaps due to the slight drag increase at the C_{μ}=0.2% data point, where the jet velocity ratio (VR=Vⱼ/V_{∞}) is close to unity and not sufficient to provide a favorable attachment response. The addition of blowing ahead of the 10° and 15° flaps leads to a relatively small change in drag compared to the other flaps, because flow is already nominally attached with actuation OFF.

The uncertainty of the load cell drag measurements is generally less than 1 count, which was well within the size of the data point markers shown in FIG. 22. There is a larger uncertainty in C_{μ}, estimated to be near 10%, due to the assumption of uniform flow at the exit and jet density equal to ambient. Between runs with a given actuator configuration (either pitched or tangential) the C_{μ} repeatability is limited by the mass flow uncertainty (±18 SLPM) and drift in ambient temperature (±2° C.) and ambient pressure (±500 Pa), which indicates a repeatability of C_{μ} within 3% of the indicated value.

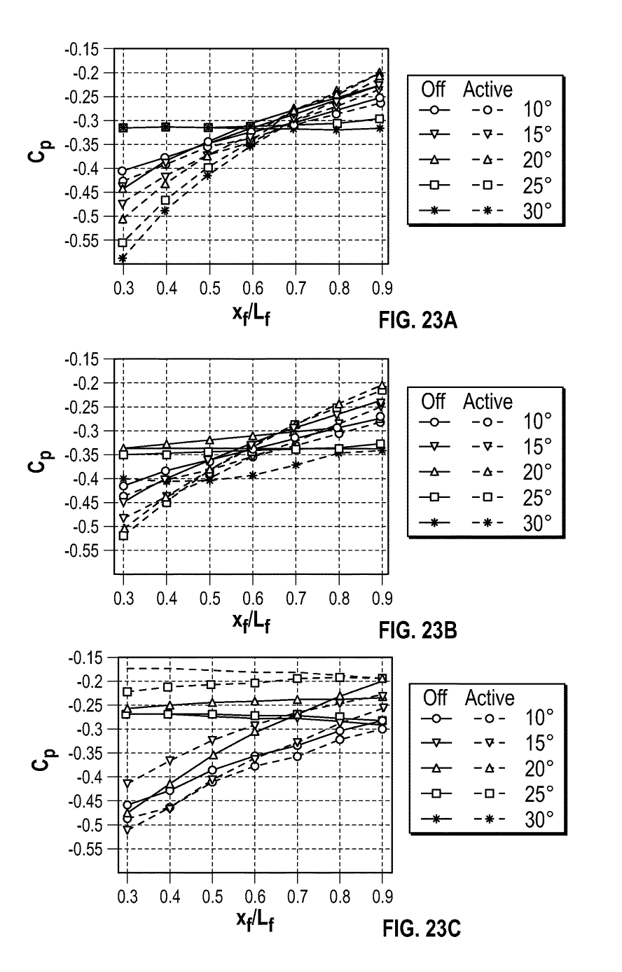

The attachment response on the upper, lower, and side flaps may be interpreted from the pressure tap data shown in FIGS. 23A-C at C_{μ}=0 (jets off) and at C_{μ}=2.1%. Two rows of taps can be used on each flap surface, one row between jets and one row downstream of an oscillator jet, however the data from both rows can be averaged at a given x_{f} due to the relatively small variation in pressure seen between the two rows (see example in Appendix B: FIGS. 64A-C).

The pressure data indicate a notable difference in attachment response between the top, side, and bottom flaps. Flow on the top flap is attached for flap angles up to 20° with no actuation, as shown in FIG. 18A, while flow on the side and lower 20° flaps is weakly attached, as indicated by the weaker pressure trends shown in FIGS. 23A-B. A larger degree of variation in flow attachment between the different sides occurs with active control applied. Controlled flow can be attached up to 30° on the upper flap, 25° on the side, and 20° on the lower f lap. Flow over the 30° side flap may be a separation bubble as indicated by the positive curvature and slope change at inflection at x_{f}/L_{f}=0.5. A negative pressure gradient occurs on the lower 30° flap due to wake entrainment from the jets.

In another example, pressure tap data indicates the degree of attachment to the upper, side and bottom flaps respectively as a function of flap angle. The jet angle is set to 30° and the blowing rate is C_{μ}=0 for the black lines and C_{μ}=1.8% for the red lines.

In yet another example: pressure tap data indicates the degree of attachment to the upper, side and bottom flaps respectively as a function of flap angle. The jet angle is set to 30° and the blowing rate is C_{μ}=0 for the black lines and C_{μ}=1.8% for the red lines.

The varying attachment responses on the four sides of the model indicate that enhanced or optimal performance may be achieved with different actuation rates on each side of the model. For example, the blowing rate on the upper surface may be reduced since the flow was readily attached. This not only lowers jet energy consumption but also decreases the detrimental suction peak from the excessive flow turning of the oscillator jet. The flowrates on the sides and bottom of the model may be increased to enhance or improve attachment on those surfaces. It is also possible that the enhanced or optimal angles for active control increase slightly with this flap specific optimization of blowing rate. The optimization process is further complicated due to feedback between the base pressure and pressure gradient experienced by the boundary layer on the flap surface. As base pressure increases, so must the near wall pressure at the flap end, leading to a greater average unfavorable gradient experienced by the boundary layer between the model roof and flap end. This feedback mechanism increases the difficulty in optimally tuning flap angle and jet actuation rate.

The corrected best case active configuration leads to a drag coefficient that is appreciably lower (10 counts) than the measured best case passive (jets off) C_{D}. The application of tangentially oriented fluidic oscillators on the G.E.T.S model do not lead to thrust corrected drag value below the best case passive 10° flaps. The embodiments with tangential jets may not accurately reflect an optimized passive configuration due to the geometric step at the roof flap interface required to accommodate the jet exit, as indicated by the shallower optimal angles in the embodiments based on the present models (10° passive and 15° active). Thus, for small geometries such as the 83% and 166% Ahmed model, a pitched jet configuration is optimal due to the absence of discontinuity presented by the tangential jet outlet. As the model size increases, the fixed size of the jet exit discontinuity relative to boundary layer thickness and other geometry will become less important. This emphasizes the benefits of scaling on the flow control performance.

D. Jet Location

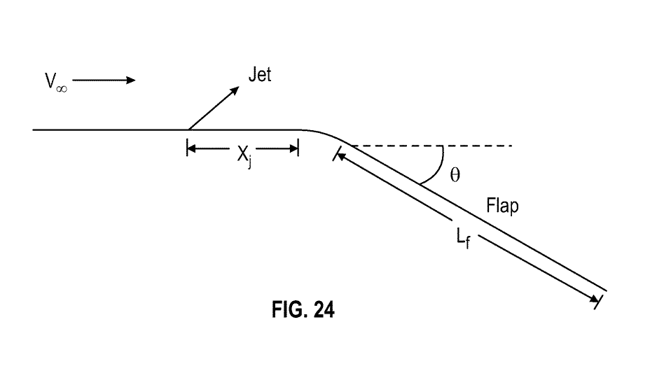

Another parameter that is examined is the distance of the oscillator jet outlet from the flap shoulder (xⱼ), as shown schematically in FIG. 24. The jet location is advanced upstream in increments of 10 jet diameters (10d) from 0d to 30d at Re=2.8×10⁶. Four discrete jet slots are used on the pitched jet B assembly located at different streamwise locations. The present disclosure also contemplates more than four jet slots while keeping within the scope and spirit of the present disclosure. The effect of jet location on C_{D} can be measured at three flap angles and four blowing rates.

FIG. 24 is a vector representation of an exemplary oscillator jet location.

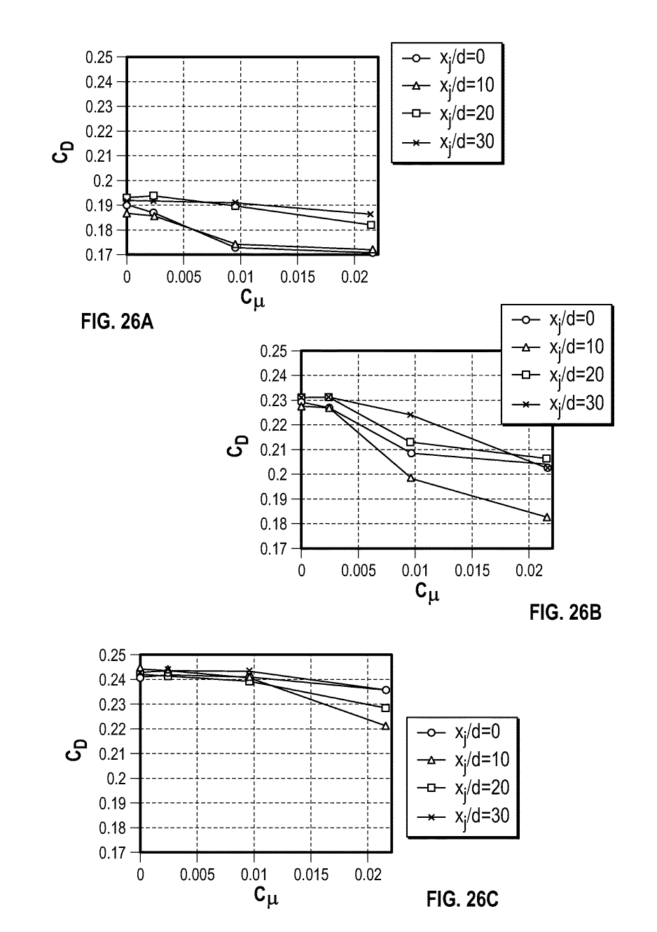

Embodiments based on models with the specific jet location are shown in FIGS. 26A-C for 20°, 25°, and 30° flaps respectively. Scatter exists in the baseline values for a given flap setting, which is due to slight seam taping differences when the setup is resealed after moving the jet location. The sensitivity is higher on the 20° and 25° flaps because those flap angles are closest to attachment. The importance of this effect is reduced once actuation is applied, therefore absolute C_{D} are presented.

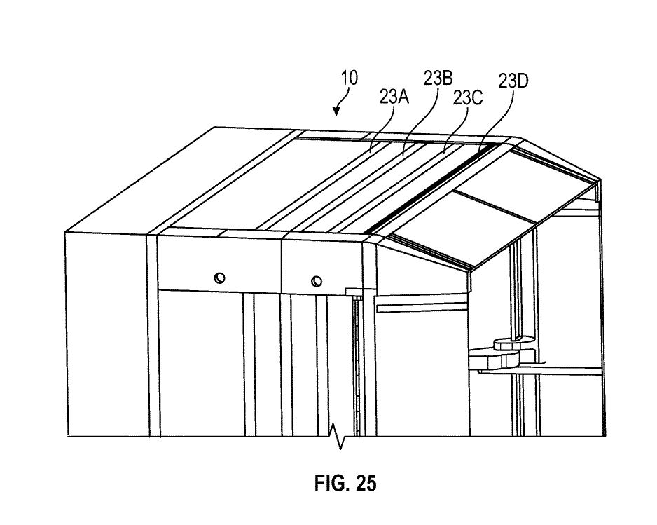

FIG. 25 is a perspective view of oscillator jet locations on an exemplary vehicle. FIGS. 26A-C show Jet location C_{D} trends. The jet angle can be set to φⱼ=30°, while the location of the jet relative to initiation of flap curvature is advanced upstream in 10d increments. The flap angles can be set to 20°, 25°, and 30° in parts a.), b.), and c.) respectively (pitched jets B model).

The effect of jet location on drag changes is relatively strong, and the optimal jet location is not the same for all flap angles. FIG. 26A indicates that actuation close to the flap shoulder at either xⱼ/d=0 or 10 is optimal on the 20° flaps, which lead s to a maximum reduction close to 17 counts relative to the actuation off value. The further upstream jet locations maintained control authority at the highest C_{μ}, however the ΔC_{D} benefit is weaker.

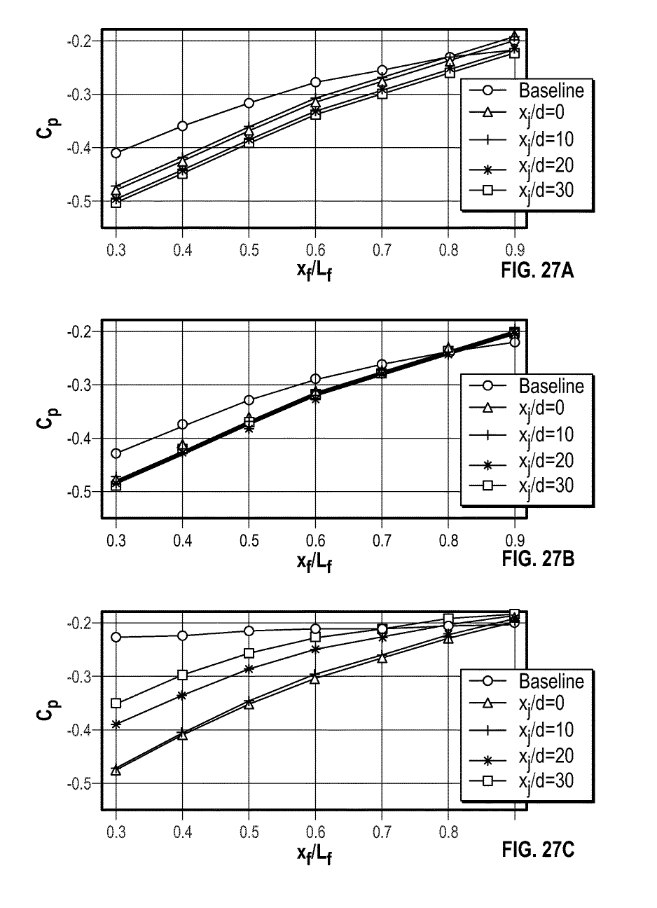

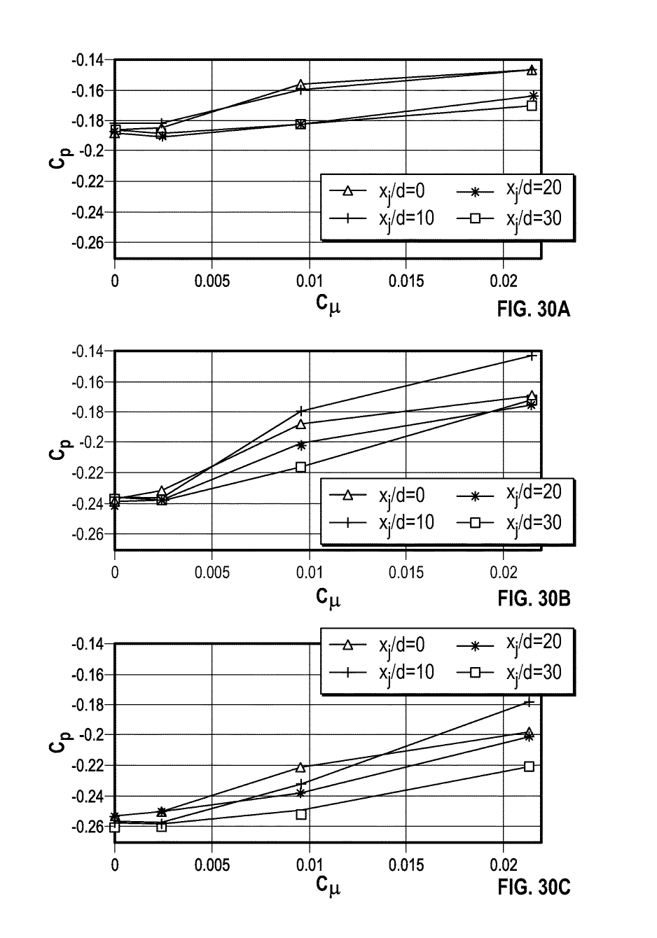

FIGS. 27A-C, 28A-C, and 29A-C provide static pressure along the upper, side, and lower flap surfaces. For the 20° boat-tail shown in FIGS. 26A-C, the pressure gradient and attachment responses on the upper and side flaps are similar and somewhat independent of jet location, however the xⱼ/d=0d, 10d locations provided a clear attachment advantage on the lower 20° flap, which contributed to the highest overall drag reduction. The average base pressure data presented in FIGS. 30A-C indicate that the two downstream jet locations also lead to a higher base pressure than the two upstream locations.

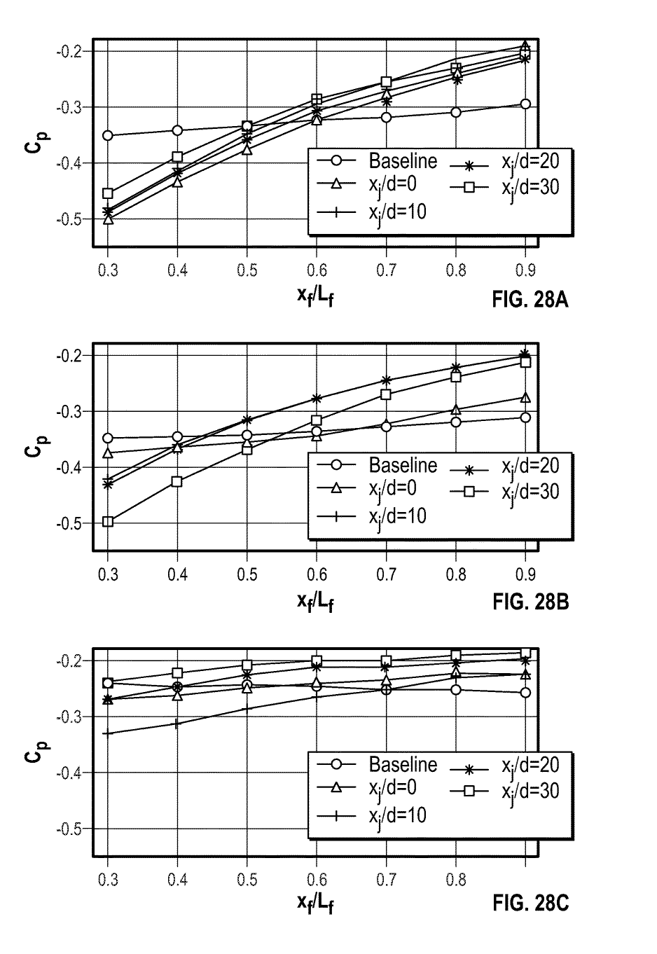

The 25° flaps exhibit a greater sensitivity to jet location than the 20° flaps, indicated by FIG. 26B. The xⱼ/d=10 show a 17 count advantage over the other jet locations at C_{μ}=0.24%, leading to a maximum reduction close to 45 counts from the unblown 25° flap. The base pressure and drag changes are similar for the xⱼ/d=0, 20, and 30 locations. FIGS. 28A-C show that the xⱼ/d=10 blowing location result in a slightly greater response on the lower flap 25°.

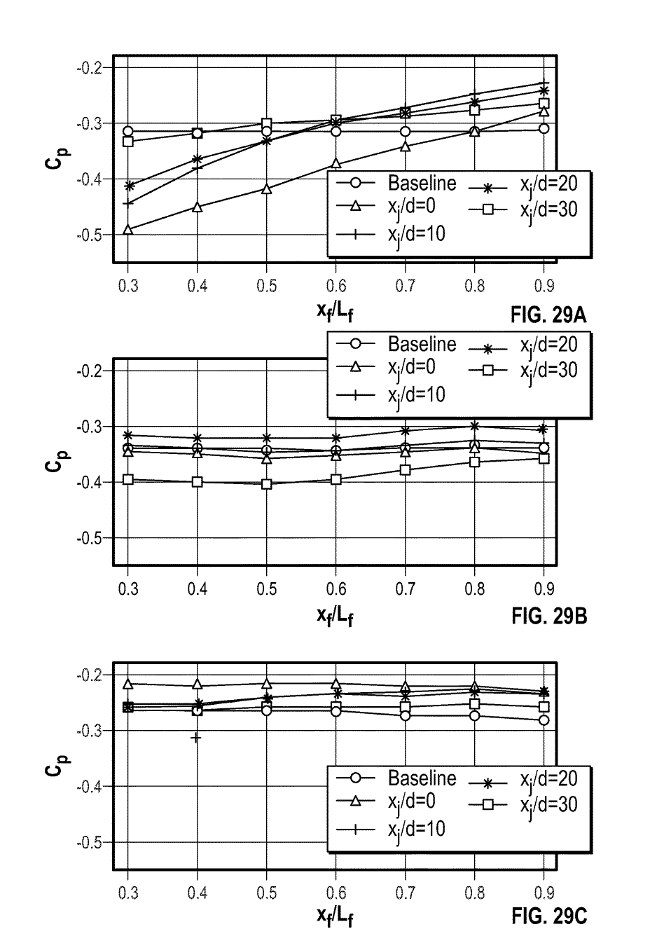

The 30° boat-tail lower and side flaps experience a weak response to actuation, as shown in FIGS. 29A-C, however a 25 count drag benefit is still realized in part due to control on the upper flap. The xⱼ/d=10 location result in the lowest drag and highest base pressure, despite the fact that the xⱼ/d=0 lead to the strongest attachment response on the upper flap. A greater amount of induced drag may be generated by the stronger attachment to the upper flap at xⱼ/d=0, which may lead to the lower C_{D} benefit despite what was perceived from the pressure gradient to be a more complete attachment. The more vectored upper wake pushes the lower shear layer downwards (thus enlarging the lower wake) and accelerates flow along the lower flap as suggested by the slight favorable gradient at the highest C_{μ}.

The xⱼ/d=10 jet location is most favorable in terms of overall C_{D} improvements at boat-tail flap angles with moderately separated flow. This was generally due to greater attachment on the lower flap surface with jets at xⱼ/d=10. All jet locations lead to similar responses on the upper flap, with the exception of the 30° flap which showed an optimum at xⱼ/d=10. A reason for the difference in optimal jet location (either 0d or 10d upstream of the flap shoulder) is due to the variable separation location. Separation occurred earlier at higher flap angles, however jet location is normalized by the distance from the start of the flap shoulder, which is close to the separation location but not precisely where the flow actually separates. This explains why the optimal location is further upstream (xⱼ/d=10) for the hastily separated 25° and 30° flaps than for the likely delayed detachment on the 20° flaps (xⱼ/d=0).

FIGS. 27A-C show flap surface static pressure with the 20° boat-tail flaps for several jet locations. The baseline value is with actuation off, while the others are at C_{μ}=0.215.

FIGS. 28A-C show flap surface static pressure with the 25° boat-tail flaps for several jet locations. The baseline value is with actuation off, while the others are at Cμ=0.215.

FIGS. 29A-C flap surface static pressure with the 30° boat-tail flaps for several jet locations. The baseline value is with actuation off, while the others are at Cμ=0.215.

FIGS. 30A-C show base pressure vs. Cμ at several jet locations. Results are for 20°, 25°, and 30° flaps. The base pressure is the average of four taps placed on the cavity base plate.

One reason for the sensitivity to jet location is related to the development distance of streamwise vorticity generated by the fluidic oscillator—freestream interaction. A maximum vortex size occurs nearly 40d (1.75 flap lengths) downstream of the jet in a zero pressure gradient transitional boundary layer. The development is different in the turbulent non-zero pressure gradient environment present on the Ahmed model, but of the same order of magnitude. The oscillator jet's raw momentum, also an important contributor to the effectiveness, begins diffuse into the boundary layer immediately after the jet exit. The growth and decay of streamwise vorticity, jet momentum diffusion, and pressure gradient result in the trends presented in this section. A jet location slightly upstream of the flap shoulder is suggested based on these results.

E. Actuation Symmetry and Underbody Flow

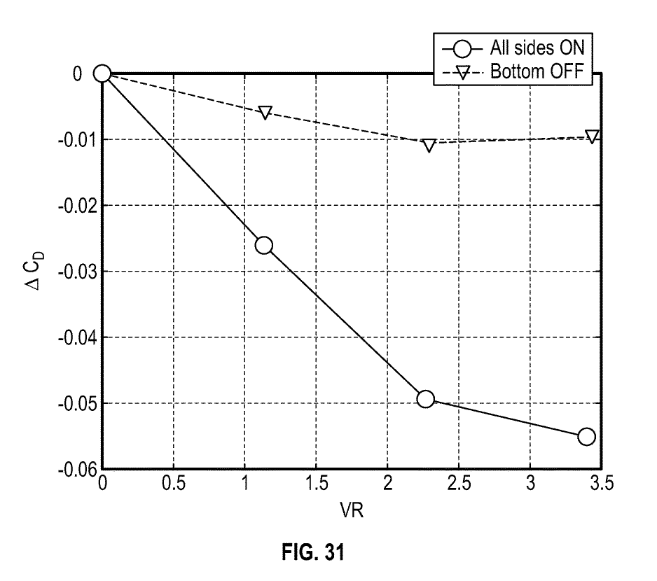

Uniform actuation on all four sides of the model can be used for the majority of embodiments presented in this disclosure. The benefit of controlling from all sides of the boat-tail flaps can be explored by turning off the bottom row of jets, while maintaining the velocity ratio (instead of C_{μ}) to keep the local effect of separation control similar on the other flaps. FIG. 31 shows the drag reduction trends with all jets ON (up to C_{μ}=2.1%) and with the bottom row of jets turned OFF (up to C_{μ}=1.5%). Some embodiments focus on the 166% Ahmed model with tangential jets spaced at 44 mm with a jet diameter d=4.1 mm at Re=2.8×10⁶.

FIG. 31 shows the benefit of underbody actuation for 15° flaps and tangential jets on the 166% Ahmed model. The ΔC_{D} are relative to unblown 15° flaps.

A maximum drag reduction near 55 counts is shown with actuation on all sides at VR=3.4, whereas the benefit plateaued at 11 counts with actuation on the top and sides only at VR=2.3. Removal of the lower jets leads to a reduction in C_{μ} of 68% with a decrease in ΔC_{D} benefit of 80% (at the optimal VR for both configurations). The significantly reduced benefit with the lower actuators removed indicates that some type of wake symmetry is needed for optimal drag reduction.

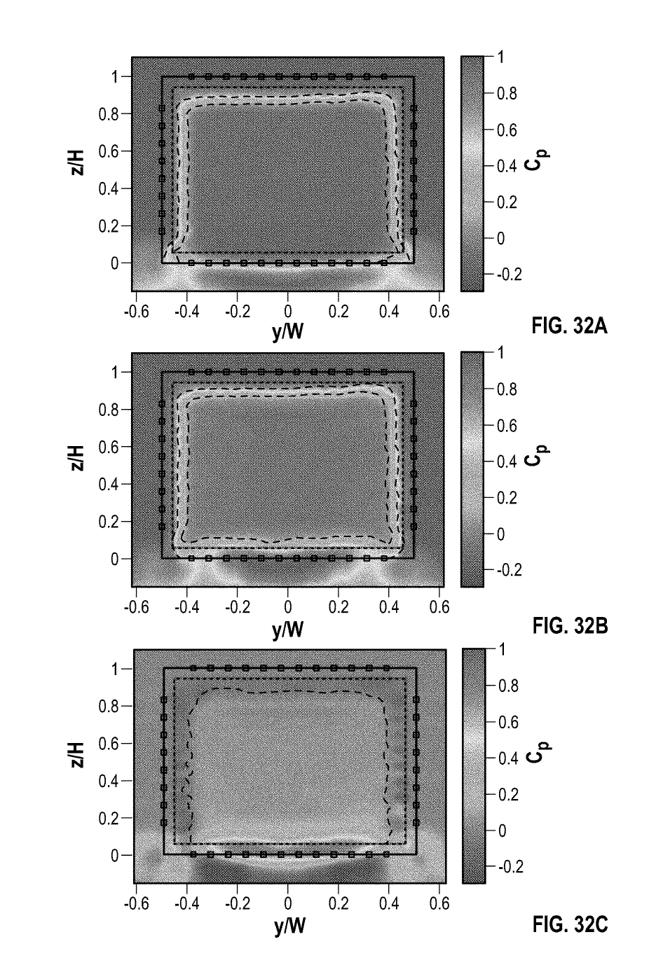

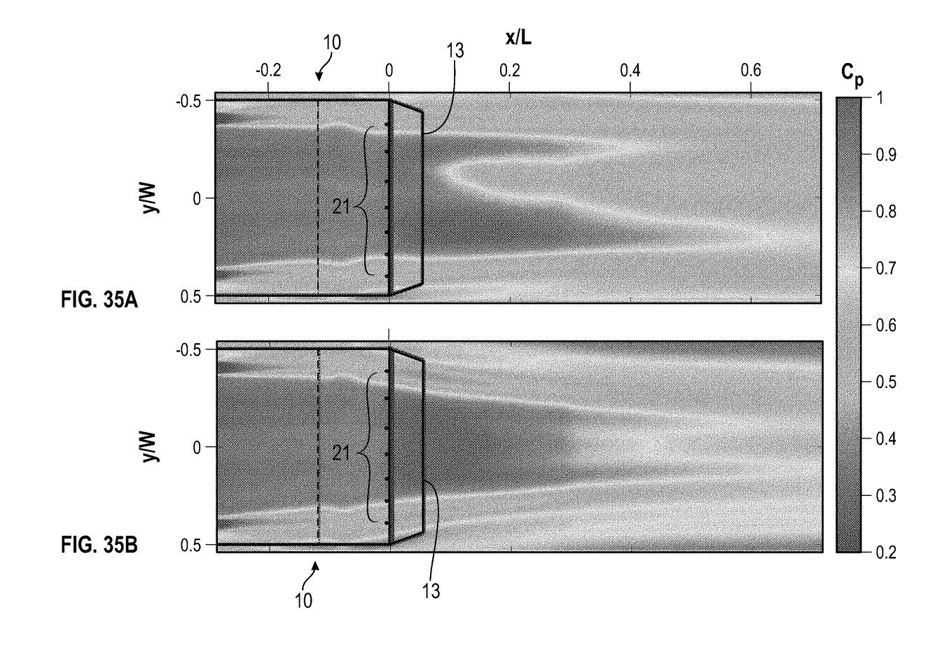

FIGS. 32A-C show wake survey results from the 166% Ahmed model outfit with 15° flap and tangential jets. FIG. 35A shows the upper and side jets only (C_{μ}=1.5%), FIG. 32B is with all 40 jets ON (C_{μ}=2.1%), and FIG. 32C is the difference between FIG. 32A and FIG. 32B. FIGS. 32A-C show wake plots that correspond with the VR=3.4 data points of FIG. 31, taken at a distance of H/2 behind the model end.

FIG. 32A indicates that flow on the lower flap is fully detached with the lower row of jets turned OFF while the wake on the other sides is drawn inward due to actuation. Separation on the lower flap is eliminated as the jets are activated, shown in FIG. 32B, which leads to a strong increase in total pressure downstream of the central base region. The character of the wake from the underside of the model also changes as more of the side flow is entrained into the underbody region, indicated by the inward movement of the support post wake. Movement of the support post wake accounts for the greater total pressure losses on a portion of the underbody seen in the ΔCRₚR plot of FIG. 32C. An attenuation of underbody longitudinal vortex strength is also suggested near (y/W, z/H)=(±0.55, 0) due to acceleration of the underbody flow (and possible decrease in pressure difference between the side and underbody).

These results indicate that the highly three-dimensional wake behind a bluff body experiences optimal recovery when closure is forced from all directions. The relatively weak inward movement of just one shear layer (in this case the lower shear layer) allows for a relief of pressure recovery.

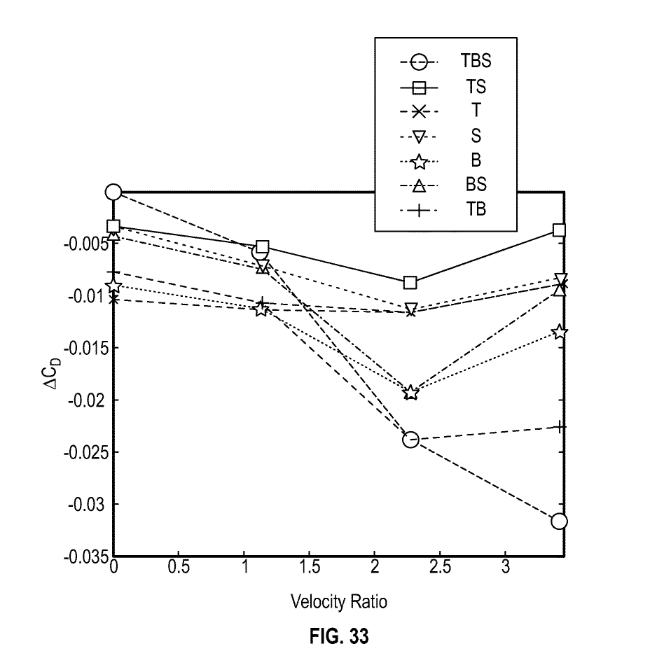

Some embodiments focus on a more detailed actuation symmetry with pitched jets due to the strong sensitivity seen with tangential jets. The 166% model can be outfitted with 30° pitched jets located at 0d and the flap angles can be set to the previously determined optimal active setting of 20°. The ΔC_{D} with different combinations of top (T), bottom (B), and side (S) actuation relative to the untaped configuration can be presented in FIG. 33 as a function of velocity ratio. The jets not in use are taped over, and the flowrate is adjusted accordingly to match VR (to maintain similar local control effects on the actuated surfaces).

FIG. 33 shows symmetry results on the 166% model (pitched jet B configuration). The flap angles are set to 20° and actuator rows are systematically deactivated.

The effect of the tape used to turn off the actuators is not insignificant with this flap configuration, as indicated by the VR=0 data points in FIG. 33. This generally lead to a reduction near 10 counts when the side jets were taped and 5 counts when top and/or bottom were jets taped. The most effective combination in terms of ΔCR_{D} is to actuate from all four sides of the model (TBS), which should agree with the tangential jet results. This can be followed by actuation with a top-bottom (TB) combination at VR=2.3, which has nearly half of the drag benefit seen with TBS actuation at VR=3.4 (15 vs. 32 count reduction). The optimum blowing rate for actuation combinations other than TBS is closer to VR=2.3, which indicates that the required blowing rate to attach flow to the controlled flaps decreases in the absence of actuation on one or more sides. The relative ease in attachment is likely due to a weaker average pressure gradient experienced by the boundary layer due to a lower base pressure. Actuation from only the top surface is ineffective at an angle of 20°, possibly because the flow is predominantly attached to the top flap with no control. Additionally, actuation with side or top-side combinations only did not lead to the reduction possible by only taping the upper jet interface.

Actuation on the bottom flap only lead to the greatest ΔC_{D} (−10 counts) relative to the number of jets (and energy consumed) of any of the individual surface actuation configurations. The underbody flow naturally exhibits the greatest barrier to wake symmetry on the Ahmed model due to losses incurred by the model support posts and other interactions with the ground plane, and introduction of symmetry from actuation on the bottom flap leads to the greater base pressure recovery. Despite the overall importance of wake symmetry as discussed above, differences may result from the disturbed underbody flow on the full scale tractor trailer.

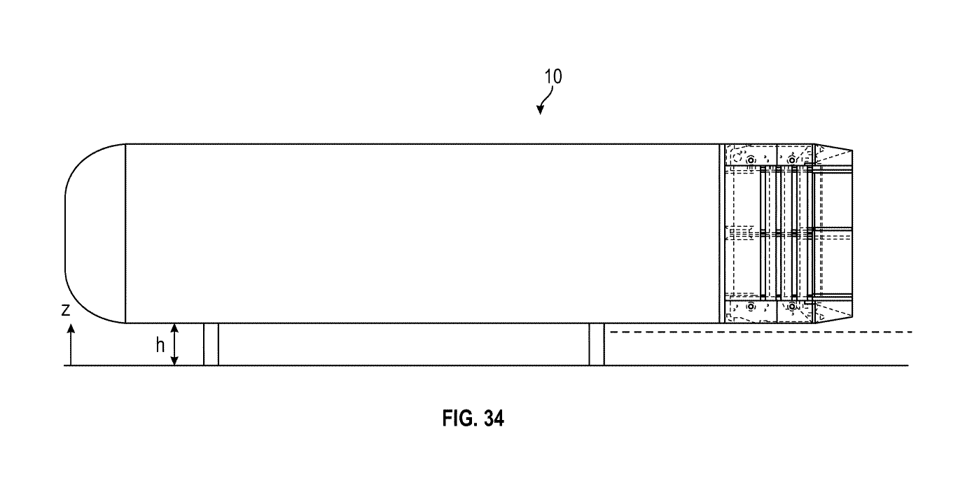

FIGS. 34 and 35A-B show an underbody flow wake survey. The model is outfitted with pitched jet B assembly with 20° flap s and 30° jets. FIG. 35A shows the baseline flow and FIG. 35B shows the actively controlled flow (C_{μ}=2.1%). The survey plane is at z/h=0.75.

An underbody wake survey is taken in the plane indicated in FIG. 34 to understand the changes that occur with actuation (the view looks down onto the model). The baseline underbody is was relatively asymmetric in the spanwise direction, possibly due to a bias in the wake bi-stability due to model imperfections. The wake becomes thinner and more symmetric about the x-z centerline as actuation is applied, which further emphasizes the stabilization effect of active control (or elimination of separated regions) discussed above. The rear model support feet, located near the most upstream portion of FIGS. 35A-B, appear to be the primary total pressure loss sources on the underbody. Additional losses are introduced by the support feet at the front of the model however mixing with the outer flow reduces their wake signature. The flow leading up to the underbody flap contains significant spanwise non-uniformity and lower near wall velocity (and likely a weaker boundary layer profile).

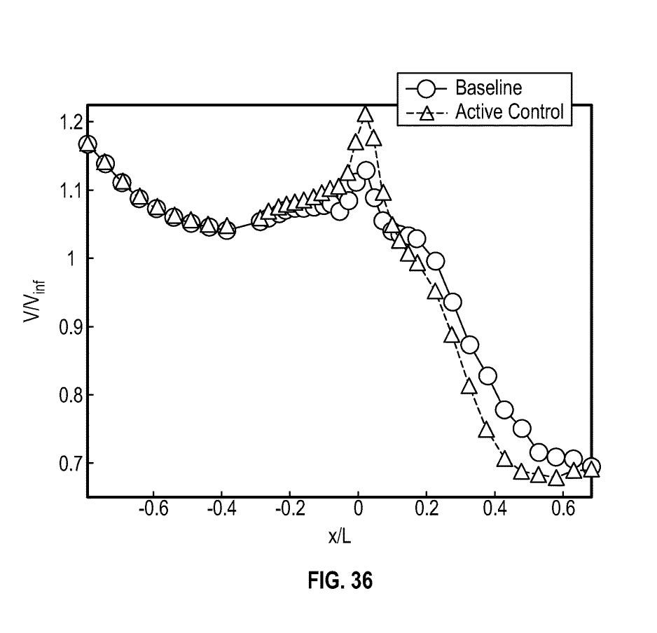

Further insight into the underbody flow may be gained from the pitot-static pressure measurements taken along the model centerline at z/h=0.5 shown in FIG. 36. The survey plane starts at the front support feet (x/L=−0.8), continues to the model flap shoulder at x/L=0, and ends in the wake region x/L=0.7 behind the model. The underbody velocity initially decelerates from the front of model (where the flow was funneled into the underbody gap) up to x/L=−0.4, and then accelerates to the flap end.

FIG. 36 shows underbody centerline flow velocity at z/h=0.5 above the ground in the baseline flow, and with active control (C_{μ}=2.1%).

The initial deceleration is due to flow exiting from the underbody and feeding the side vortices generated at the lower front corners of the model. Boundary layer and wake growth likely prompt the acceleration of the centerline flow beginning at x/L=−0.4 as the effective displacement thickness constrained the area available to the underbody flow. The rate of flow acceleration further increases near the start of the lower flap surface as the model feet wake is drawn inwards, and is accentuated with active control ON due to entrainment from the jets (VR=3.4). The centerline velocity in the base wake region, beginning at the flap end near x/L=0.05, is initially highest for the actively controlled configuration due to entrainment from the high velocity oscillator jets. Beyond x/L=0.1, the velocity in the uncontrolled configuration surpasses the controlled case as the underbody flow vectored upwards, allowing the low velocity support wake to move inwards. These trends are from a limited region of the wake, however they are still useful for understanding the general underbody flow changes that result with active control, which can be summarized as follows. The centerline underbody wake initially decelerates from the maximum value at the nose and then increases towards the wake. Active control draws the wake inwards and leads to a higher flow velocity in the model-ground gap near the back of the model due to entrainment from the jets. This inward movement of the wake contributes to the higher base pressure and lower drag.

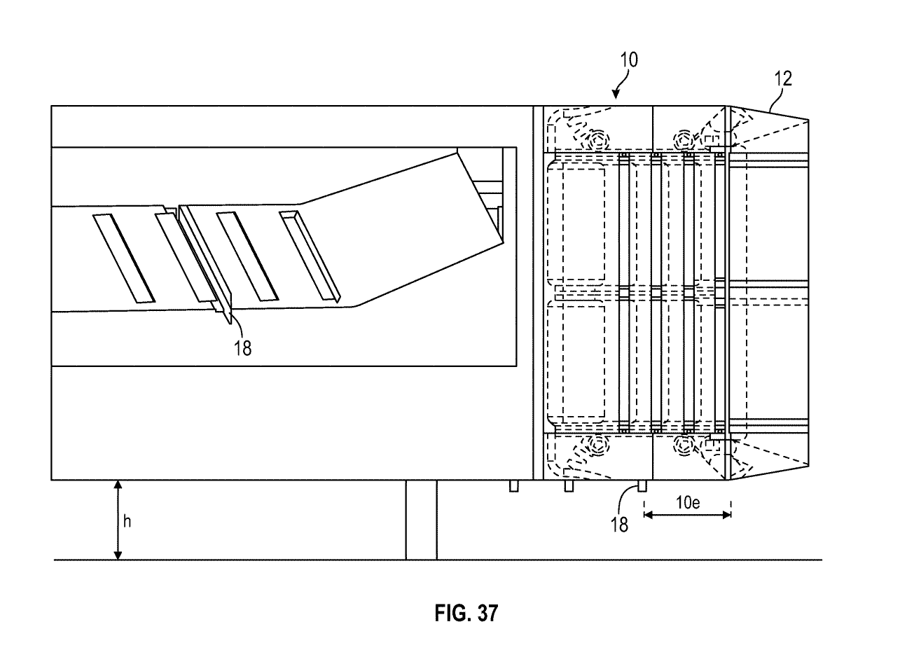

The effect of wake asymmetry is exaggerated with the use of a roughness element on the underside of the model and by increasing the lower flap angle to 22.5° to further increase attachment difficulty. Some embodiments are based on the lower portion of the model, because losses are already present in that region due to the model support feet. Control can be applied to only the lower flap (to vary the degree of wake symmetry), while the other flaps can be set near the limit of natural attachment at 20°. The roughness element takes the form of a step of height e=h/10 placed upstream of the actuation location. The effect of the step on ΔC_{D} trends is tested at three different locations in increments of 10 roughness element heights (10e), up to 30e, indicated in FIG. 37. The thickness of the step in the streamwise direction is 33% of the step height.

FIG. 37 is a schematic of underbody roughness element placement (pitched jets B model).

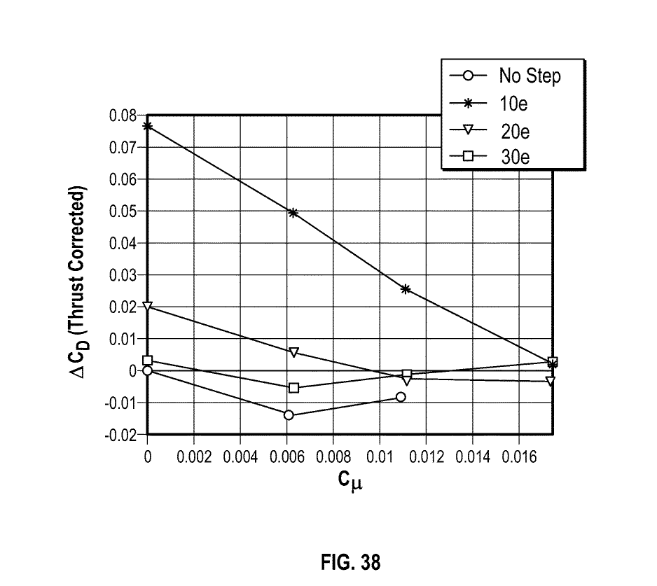

The embodiments based on models of the underbody roughness with 20° top and side flaps and 22.5° bottom flap are presented in FIG. 38, with actuation only applied to the lower flap surface. The ΔC_{D} are presented relative to the actuation OFF condition with no roughness element in place. Up to a 12 count drag benefit of actuation is seen on the baseline setup with no step. With the step placed at the 10e location the actuation OFF drag value increased by 78 counts. The effect of the roughness element decreases when placed further upstream, leading to a penalty of 20 counts at 20e and only 2 counts at 30e. At the most upstream 30e step location, active control at C_{μ}=0.6% reduces drag below the baseline value, but to a lesser degree than without the element. Control reduces the 20e drag values back to baseline, however a higher C_{μ}=1.1% is required. At the most disruptive 10e placement, a C_{μ} of 1.7% brings drag value to within 3 counts of the baseline.

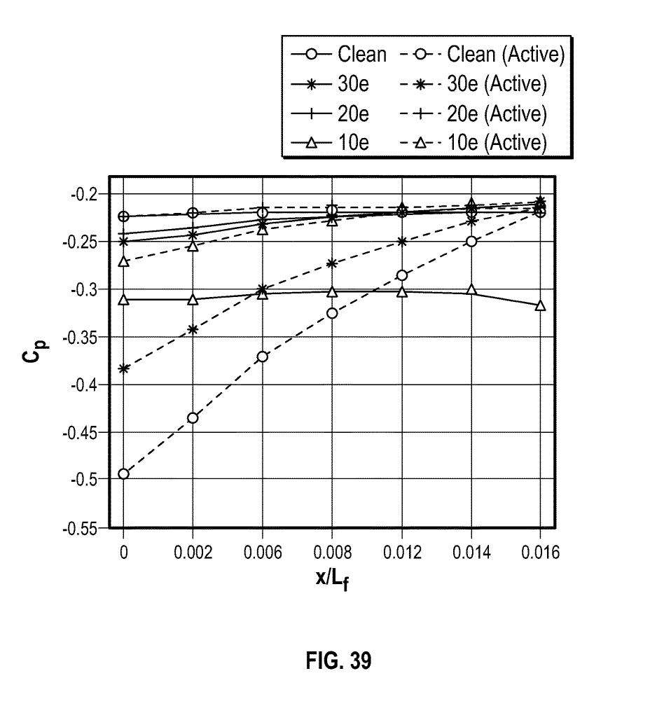

FIG. 38 shows underbody disturbance drag results. FIG. 39 shows lower flap static tap pressure from underbody disturbance. The unactuated configuration is shown in black and the red lines are with actuation ON (bottom jets at C_{μ}=1.1%).

The mechanism for the drag changes may be interpreted from the lower flap pressure data shown in FIG. 39. The unactuated pressure gradients are flat and detached for both the clean and disturbed underbody configurations. Actuation on the clean setup results in the steepest pressure gradient and what is inferred to have been the largest flow attachment response. The degree of response decreases as the step was moved downstream (closer to the jets). The 10e location experiences the largest beneficial change with actuation; however flow does not become attached to the flap surface. This suggests that a significant percentage of the base pressure increase (in the presence of large upstream total pressure losses from the step) is due to the total pressure injected into the wake from the jets, and that the improvements beyond baseline (seen with no step) are due to the improved flap flow exit angle symmetry. Locally correcting the asymmetries present due to wake losses can have a significant impact on the overall base pressure.

F. Rolling Road and Re Sensitivity

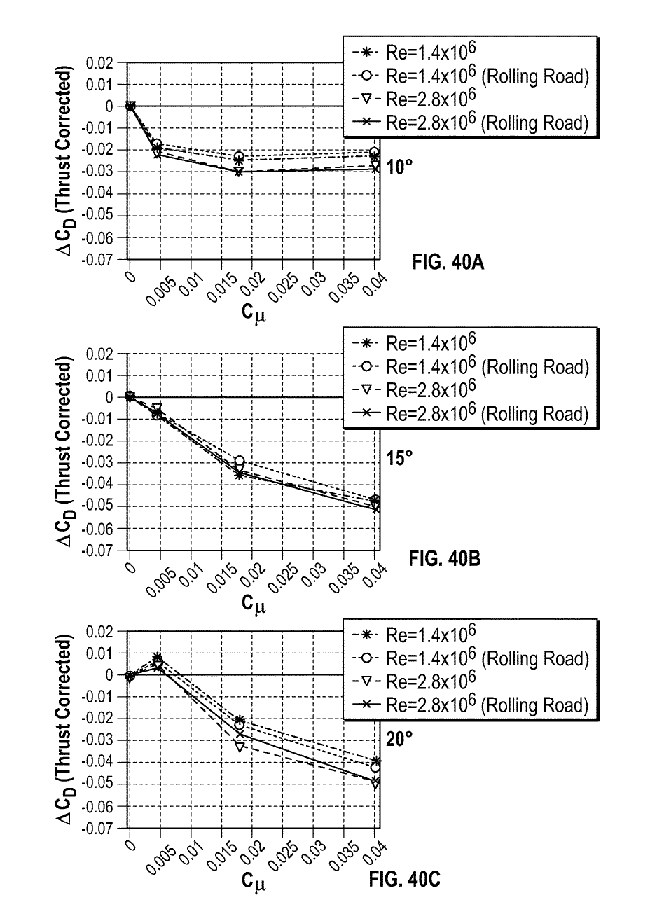

The sensitivity of drag changes to rolling road (simulated ground plane) and Re (by way of ΔV_{∞}) is examined on the 83% model equipped with tangential jets at 2WT. Some embodiments are based on models at two Re (1.4×10⁶ and 2.8×10⁶) and rolling road ON/OFF in order to understand the parameter sensitivities A moving ground plane is simulated with a belt underneath the model is set at the freestream velocity (V_{∞}). The width of the ground belt can be 280 mm, while the width of the 83% Ahmed model feet can be just 250 mm, which requires that the model be set on mounting brackets that extended past the width of the belt to the load cell/mounting posts. The alternate model mounting configuration does not significantly impact the trends in Re/Rolling road sensitivity at the ride height of 55 mm (h/H=0.23). The embodiments described above are presented in FIGS. 40A-C for three different flap angles (10°, 15°, and 20°) in terms of thrust corrected ΔC_{D} relative to the baseline passive (C_{μ}=0) C_{D} at the corresponding Re/Rolling road combination.

FIGS. 40A-C show rolling road and Re embodiment results. Flap angles are set to 10°, 15°, and 20° for Fig. A, Fig. B, and Fig. C respectively. Results are from the tangential jets 83% scale model.

The benefit of active control appears to be weakly sensitive to Re and rolling road. With 10° flaps, the high Re rolling road ON/OFF ΔC_{D} are within several counts at all blowing rates, while the low Re rolling road ON/OFF conditions also appear to be grouped. The benefit of actuation is close to five counts greater at the higher Re, however the drag changes begin to plateau (implying full attachment) near the same C_{μ} at both the low and high Re. Turbulence aided attachment to the flaps may not be responsible for the lower drag at high Re but possibly some other phenomena, such as faster dissipation of the low pressure vortex structures shed from the back of the model. It is possible that greater spanwise mixing was achieved at higher Re, which increases the flow velocity between jet outlets. Another possibility is that the presence of a thinner boundary layer at high Re may increase jet penetration into the outer flow, thus aiding streamwise vorticity generation. Re sensitivity of the cylindrical model support posts may exist, which are also included in the drag value. The changes in the ΔC_{D} trends for the Re/rolling road combinations are minimal when considering the reduction magnitudes near 30 counts that occur with actuation. The trends on the 15° and 20° flaps are also reasonably independent of Re and rolling road.

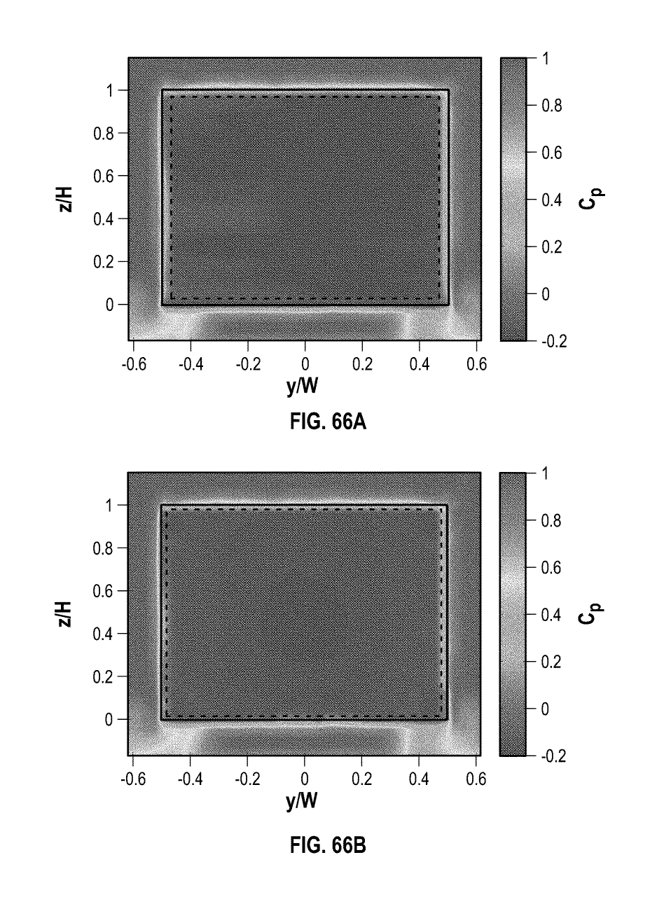

There is a 3 count deviation present in the absolute baseline drag values, which can be seen in FIGS. 66A-C. Of particular interest is a nearly 10 count lower drag for the baseline square high Re/rolling road ON configuration relative to the other test conditions. The lower drag is seen across all flap angles and may have been related to a turbulence aided reattachment of the underbody flow. The other combinations of Re/rolling road are generally within several counts for the baseline and C_{μ}=0.4% datapoints.

The base square-back Ahmed model geometry is weakly sensitive to Re within and above the range tested in the present models on which the embodiments are based, however Re is still nearly and order lower than what would be experienced on a real vehicle. The low sensitivity to Re (speed changes) ishows that the drag reduction trials may be relevant to the Re range seen on a full scale vehicle. Rolling road sensitivity also appear to be low, which is surprising given the importance of flow attachment on the lower flap surface to overall drag reduction. This is due to the well-controlled ground boundary at 2WT (accomplished with a two stage suction and blowing system ahead of the model) which reduces the importance of moving ground simulation for most bluff vehicle applications. The relatively weak dependence on the additional real world effects further supports the relevance of these scale flow control tests.

G. Ride Height Sensitivity

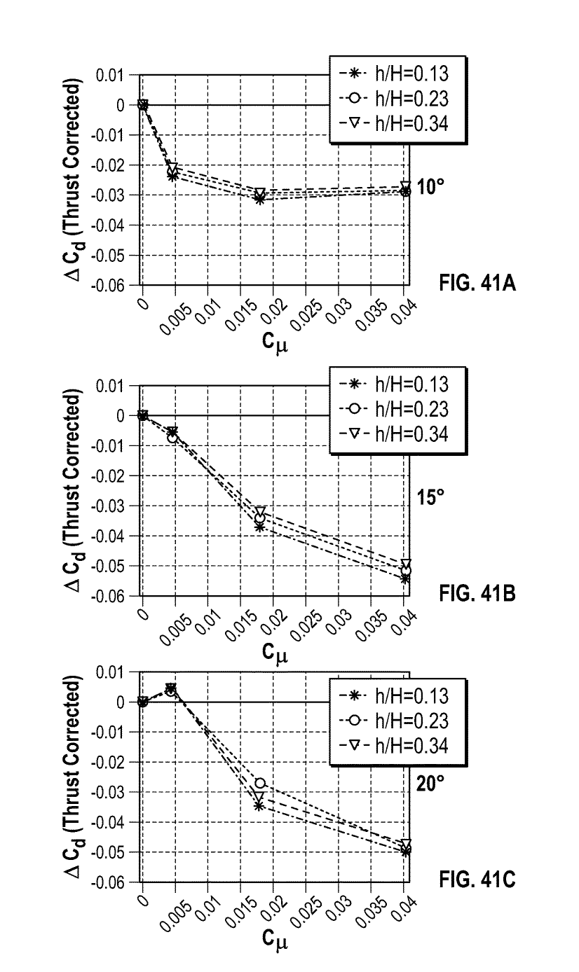

The effect of ride height on drag reduction is examined on the 83% Ahmed model at the NWT facility. The results for active control over 10°, 15°, and 20° flaps are presented in FIGS. 41A-C at three different ride heights (h/H=0.13, 0.23, 0.34) with rolling road ON and test section speed set to 48 m/s (Re=2.8×10⁶). The higher Re results are given due to the weak but still present Re effects. The ΔC_{D} values are thrust corrected and relative to the actuation off drag value for each flap setting.

FIGS. 41A-C show ride height of models on which embodiments are based. Flap angles are set to 10°, 15°, and 20° for part FIG. 41A, FIG. 41B, and FIG. 41C, respectively, using the tangential jets 83% scale model.

The 10° flaps experiences a maximum drag reduction close to 30 counts for all ride heights, as shown in FIG. 41A. The 15° flaps with blowing at C_{μ}=3.4% lead to drag reduction close to 50 counts for all ride heights, shown in FIG. 41B, with a slightly greater benefit at the lowest ride height. The drag reduction trends with the 30° flaps are similar for all ride heights, with a slight deviation for h/H=0.23 at C=1.8%. The ride height trends are also examined with various rolling road and Re configurations (not shown), however Re=2.8×10⁶ with rolling road ON are presented in FIGS. 41A-C due to the greatest relevance to on road conditions.

The overall ΔC_{D} trends indicate a weak dependence on ride height (within the magnitude of the drag reduction that occurred with actuation). This is because of the dominance of the spanwise shedding mode in the Ahmed wake, over the vertical shedding mode (see section 1.3). Additional imaging with PIV near the lower flaps at different ride heights validates this hypothesis. The underbody mounting setup may have prevented attachment to the lower flaps (thus leading to weak underbody sensitivity), however this is unlikely due to the plateau in drag reduction seen with 10° flaps which suggests fully attached flow on all flaps. The well controlled ground boundary layer at the 2WT facility permitted the relative independence of ride height to be uncovered (by removing the additional blockage effects). Although C_{D} increases with ride height (trends not presented) the ability of this actuation scheme to reduce drag does not appreciably change.

H. Model Geometric Scaling

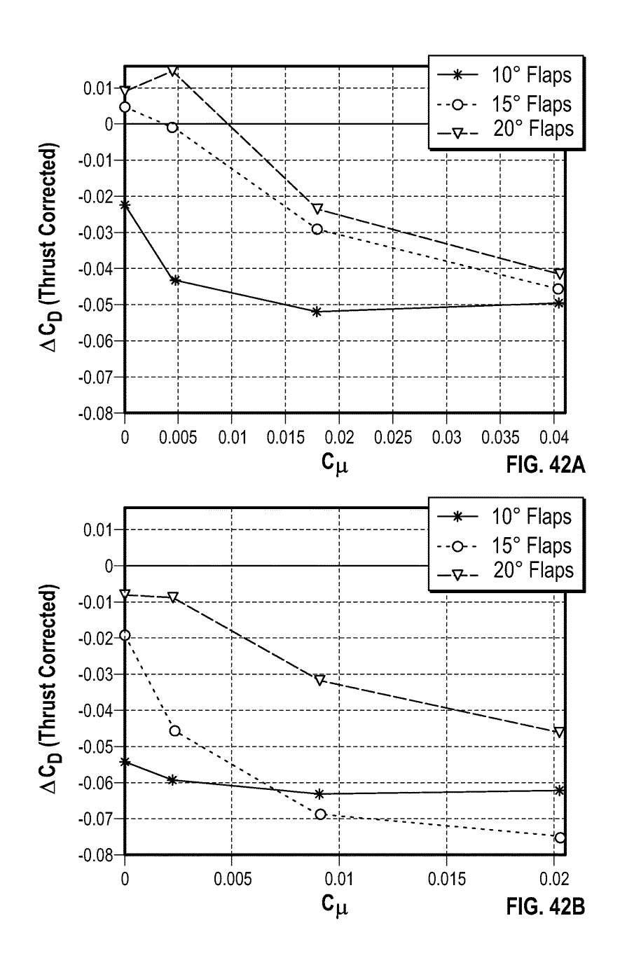

Geometric scaling sensitivity is examined by applying similar fluidic oscillator configurations to 83% (small) and 166% (large) scaled Ahmed models. The tangential jet assemblies are used and the models were tested at the 2WT facility with rolling road OFF at Re=2.8×10, which correspond to V_{∞}=24 m/s and 48 m/s for the large and small models respectively. The ride height for the 83% model is h/H=0.23, and h/H=0.20 for the 166% scale model. Ride height is shown to weakly affect the ΔC_{D} with actuation (section 3.7) which reduced concern from the slight normalized height difference between the two model scales. The oscillator spacing is 44 mm and the outlet diameter was d=4.1 mm for both models, such that the larger model has twice the number of jets as the small model to fill the greater flap spans. The presented configuration on the 166% model is shown to be optimal. The scaling of embodiments with ΔC_{D} are relative to baseline square-back and are presented in FIGS. 42A-B for three flap angles. The jet velocity ratios are approximately matched (VR=0, 1, 2, 3) for the consecutive C_{μ} data points in FIGS. 42A-B.

FIGS. 42A-B show geometric scaling results. The ΔCD results for the small FIG. 42A and large FIG. 42B models are with tangential jets at 10°, 15°, and 20°, relative to baseline square-back CD.

FIGS. 42A-B suggest an optimal passive boat-tail angle of 10° for both models (at C_{μ}=0), although the benefit on the larger model is nearly 32 counts greater. Active control on the 10° flaps leads to a further drag de crease which plateaued near an additional −25 and −9 count on the small and large models respectively. The plateau in drag reduction occurs near the second C_{μ} data points (corresponding with velocity ratio close to two) indicate that the maximum possible attachment with this setup is achieved. The unactuated 15° and 20° flaps lead to a slight d rag increase on the small model, due to the formation of a closed separation bubble on one or more of the flap surfaces, however the same condition leads to drag decreases of 20 and 9 counts respectively on the large model. The 10° flaps are not the optimal active configuration on the large model, instead actively controlled 15° flaps lead to the greatest overall drag reduction of nearly 75 counts at C_{μ}=2.1%.

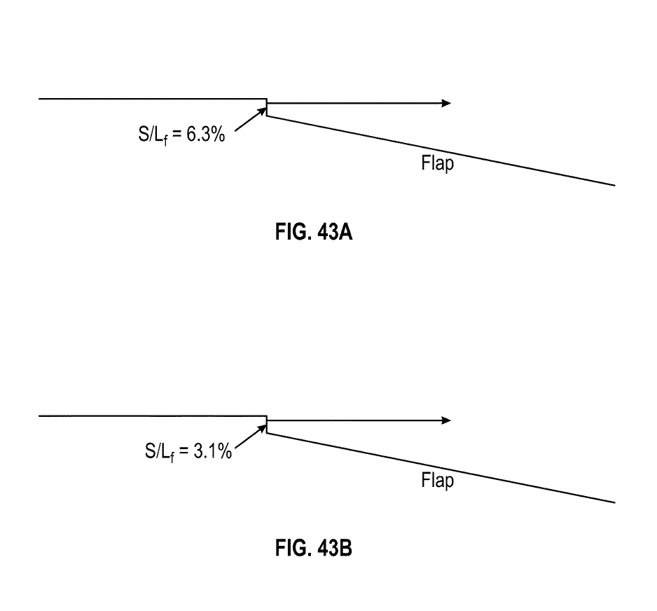

The optimal flap angles with tangential jets on the 166% model contrast with those present in the flap angle embodiments for the pitched jet configuration. The optimal passive and active angles are 10° and 15° respectively with tangential jets and 15° and 20° respectively for pitched jets. The difference in optimal angles (both passive and active) between the jet configurations is due to the presence of the 3 mm inset at the actuator outlet on the tangential configuration, shown in FIGS. 43A-B, which leads to sharp edge separation.

FIGS. 43A-B show comparison of the jet exit step height for both scale models.

The inset is out of geometric necessity to accommodate the tangential jet outlet, with the relevant normalized inset height being s/L_{f}=6.3% for the small model and s/L_{f}=3.1% for large model. The difference in s/L_{f} may also affect the geometric scaling trends because the baseline reattachment length relative to flap length is longer on the small model due to the larger relative step height. Longer normalized flap lengths used for both models reduce the effect of the step height difference. Differences in boundary layer state ahead of the flaps are likely present, however both models are in the range of Re independence.

This results in a reduction in momentum coefficient requirements by a factor of two on the larger model (at a given jet velocity ratio) while maintaining a greater magnitude of the drag reduction than on the small model. The reduction in C_{μ} for the larger model partially results because the number of actuators scaled linearly with the perimeter of the model, while the frontal area (and flow momentum displaced by the model) increases with scale squared. Though C_{μ} is not an appropriate scaling parameter, it still has a fundamental meaning as the AFC momentum input relative to the flowfield momentum displaced by the model. The reduction in relative actuator input with scaling has positive implications for actuator power consumption when transitioning this flow control technique to the dimensions of real vehicle.

I. Actuator Scaling

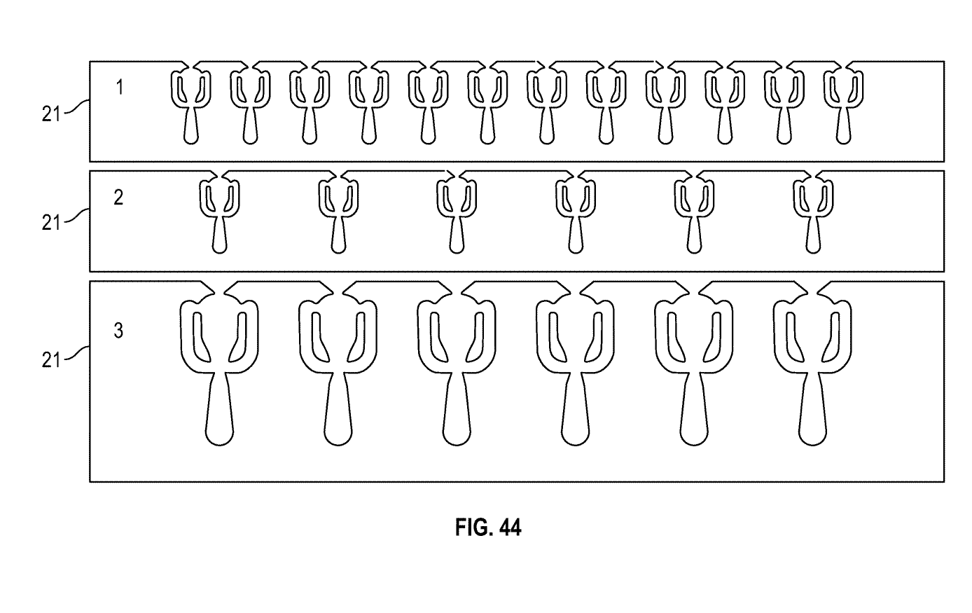

An actuator scaling embodiments is presented as a subset of the model geometric scaling to examine the effect of oscillator spacing and size on separation control performance. This embodiment is based on the 166% Ahmed model equipped with tangentially oriented jets and 15° flaps. Two jet sizes (d=4.1 and 8.2 mm) and two oscillator spacing (λ=44 and 88 mm) were tested which result in total number of either 20 or 40 oscillators applied to the aft portion of the model. The three different scaled actuator configurations are schematically depicted in FIG. 44.

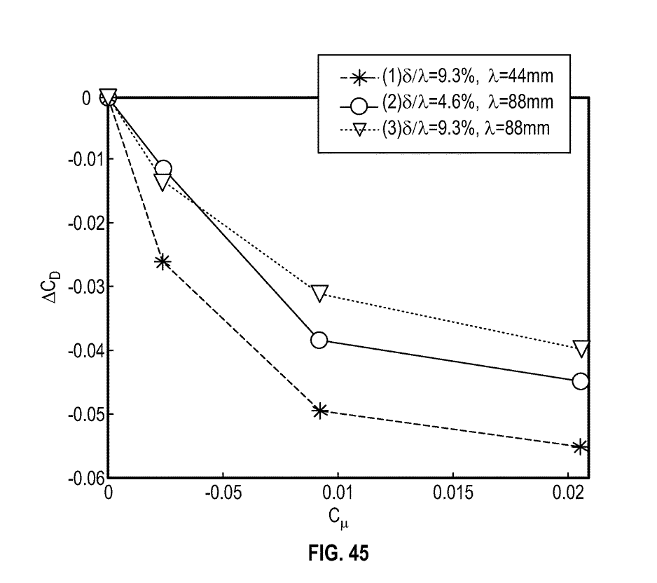

FIG. 44 shows scaled actuator schematic. The labels agree with the legend in FIG. 45.

Drag changes relative to the unactuated 15° flaps are presented in FIG. 45. There is more than a 10 count drag advantage at all C_{μ} for a jet spacing of λ=44 mm. Doubling the spacing to 88 mm while maintaining C_{μ}=2.1% reduces the drag benefit by nearly 16 counts, despite a jet velocity increase by a factor of √2. The velocity ratio (VR) may become less relevant at very large jet spacing. Doubling the jet width at the wide spacing yields a slight improvement of 6 counts, due to a larger percentage of flap area being covered with jets. The velocity of the large oscillators is the same as the closely spaced small oscillators at a given C. Interestingly, the drag reduction plateaus at nearly the same rate for all jet configurations between C_{μ}=0.9% and C_{μ}=2.1%. The local benefit of control may saturate at similar C_{μ} for the different spacings, resulting in boundary layer thickness variation across the flap span, however pressure data on the flap surfaces is not available to gain insight in the attachment response differences.

FIG. 45 shows actuator scaling embodiments based on the 166% Ahmed model with tangential jets.

The actuator scaling results indicated that λ=88 mm may be too large of an oscillator spacing for sufficient separation control authority on the flap surfaces. An increased spacing can be more efficient, however the optimal λ may have been exceeded. The jet velocity ratio (VR) is an important governing parameter for fluidic oscillator flow control, however this may not be valid at large spacing. Differences in oscillator frequency are inherently present in this embodiment when C_{μ} is matched between jet configurations of different scales. The effects of frequency are not directly examined, however the high jet oscillation frequency in these tests (order 100 Hz) relative to natural vortex shedding frequency (order 10 Hz), along with the random phase between oscillators, make flow structure amplification via specific frequencies unlikely. Scaling should be accomplished by maintaining a moderate jet spacing (λ≈40 mm) and a relatively small jet outlet width (d≈4 mm). The number of oscillators should then be appropriately increased to fill the relevant span that separation control is applied. Optimization may be accomplished with a finer resolution of jet spacing and size data points.

J. Wake Bi-Stability Observations

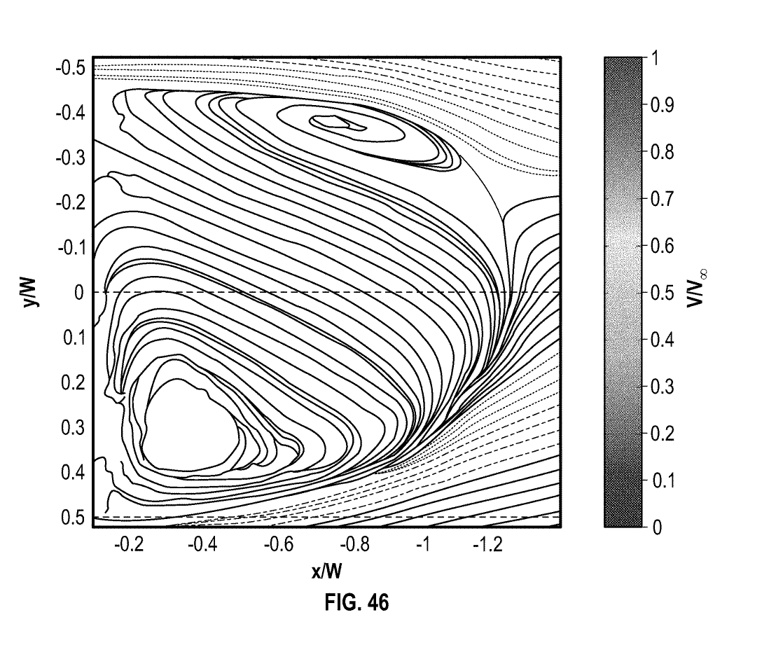

The wake bi-stability is also observed in embodiments based on both the 83% and 166% scale Ahmed models. The PIV image of FIG. 46 shows the wake about the z-plane at z/H=0.73, behind the 83% model. Rolling road was OFF at Re=2.0×10⁶, and ride height was h/H=0.23. The wake on the small model is asymmetric, at zero yaw angle, as indicated by the displaced recirculation centers and vectored wake. The bias in the ensemble average of 100 vector fields suggests that the dwell times in each bi-stable state are not equal within the PIV acquisition period of 41 seconds.

FIG. 46 shows PIV on the x-y plane behind the 83% square-back model at 2WT facility. The view looks down on the model at z/H=0.73 and shows the asymmetric wake due to the bi-stability phenomena.

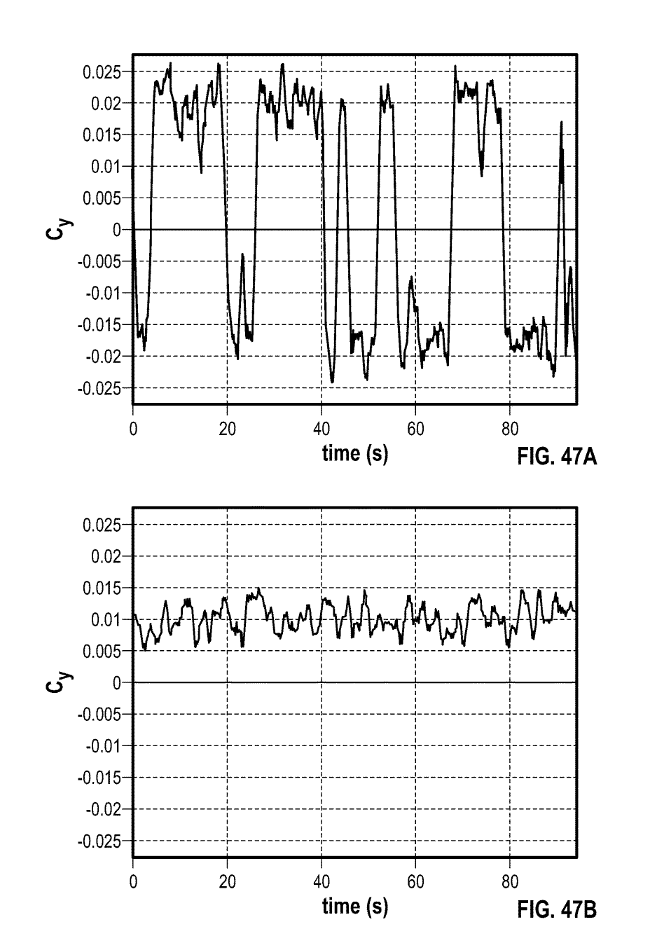

FIG. 47A-B show normalized side force vs. time for the square-back model a.) and model with 15° flaps with actuation at C_{μ}=2.1% b.).

The presence of the wake bi-stability on the larger Ahmed model may be inferred from the side force plot shown in FIG. 47A at Re=2.8×10⁶. The side force coefficient oscillated approximately between ±0.2 with a slightly higher dwell in the +0.2 state within the shown plot range, which leads to an average side force of 0.002. Drag does not change appreciably during the presented data window (σ≈0.004). The dwell time in each state is of order 10 seconds, which is just slightly higher than the 5.3 s mean period. Active control over 15° flaps eliminate the bi-stability, as shown in FIG. 47B, however a slight side force of 0.01 is present, possibly due to flap setting imperfections. Flow visualization suggests that the phenomena may be associated with an unsteady separation near the front of the model, which is quelled with actuation. This is a surprising finding, given the long feedback path between the rear control location and front of the model.

A purpose of this embodiment is not to evaluate the wake bi-stability, however it is thought to be a beneficial contribution given the relativity new insight presented by other researchers into this phenomenon. The effect is verified on two different scale models at the state of the art 2WT facility, which shows that this is an inherent feature of the square-back Ahmed model wake. The natural vectoring of the wake in the baseline square-back flow due to the bi-stability has an induced drag penalty of up to 9% of the total drag. Active control eliminates the bi-stability under certain conditions, which may account for a portion of the drag reduction seen throughout this disclosure.

The above described flow control methods serve to stabilize a vehicle wake. Additionally, the flow control methods may enhance side force stability in crosswinds. Thus, the above described methods are not limited to wake bi-stability, but may encompass multidirectional airflow and resulting wakes.

### IV. Fluidic Oscillator

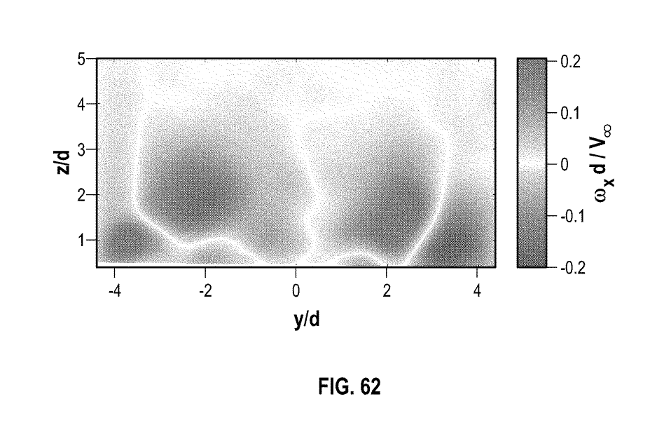

Some embodiments are based on models that evaluate practical considerations, such as oscillator acoustical signature, sweeping frequency modification, pressure drop and energy requirements related to application of fluidic oscillator flow control. An embodiment of a model examining the vorticity generated by the oscillator is shown beginning in FIG. 62.

A. Oscillator Acoustics

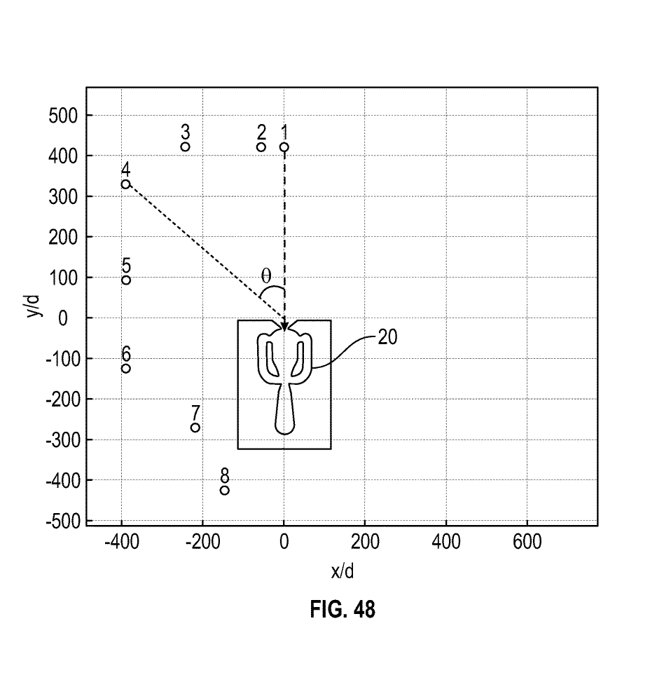

The acoustic signature of the fluidic oscillators is of practical consideration for implementation of the active flow control technique onto a full scale vehicle. The oscillator jets sweep at a specific frequency, which can lead to sharp tones in the noise signature, which along with broad spectrum noise from the jet turbulence may affect passenger comfort. The tone frequencies and sound pressure for a given jet setup depend on jet velocity. Far-field acoustic measurements from a single fluidic oscillator were taken in an anechoic chamber outfitted with microphones surrounding the jet exit, as depicted in FIG. 48, with the oscillator placed at the location of the blue triangle (jet oriented in the positive y direction). Eight microphones are placed around the oscillator to gain an understanding of noise directivity. The microphones are powered with a signal conditioner and calibrated to 94 dB, 1 kHz, which allow the signal measurements to be converted to Pa. Three 8 second trials are done for each test condition at a sampling rate of 200 kHz. The dBA weighting is applied to the amplitude spectrum to account for the greater receptivity of the human ear to mid-range frequencies. Background noise amplitude (measured with the jet OFF) is subtracted from the presented results. The human audible range is approximately 20 to 20,000 Hz (with a minimum detectable amplitude close to 0 dB), however the acoustic chamber is not anechoic below 200 Hz so the data below this frequency is not presented.

FIG. 48 shows microphone locations in anechoic chamber. The dimensions of the chamber are indicated by the bounds of the plot.

The oscillator used in this embodiment can be manufactured using stereo lithography, with similar dimensions to the oscillators used in the drag reduction embodiments. The jet velocity can be varied from 13 m/s to 150 m/s by controlling the mass flowrate through the oscillator. Unless otherwise noted, the intensities measured by the microphones are converted to an equivalent intensity at 1 m, using the following equation,

$${SPL}_{1 m} = {SPL}_{R} + 20 {log}_{10} ( \frac{1}{R} )$$

where R is the distance of the microphone from the source. Results from microphone 4 (see FIG. 48) are presented for much of the analysis because the average sound levels were highest at that location.

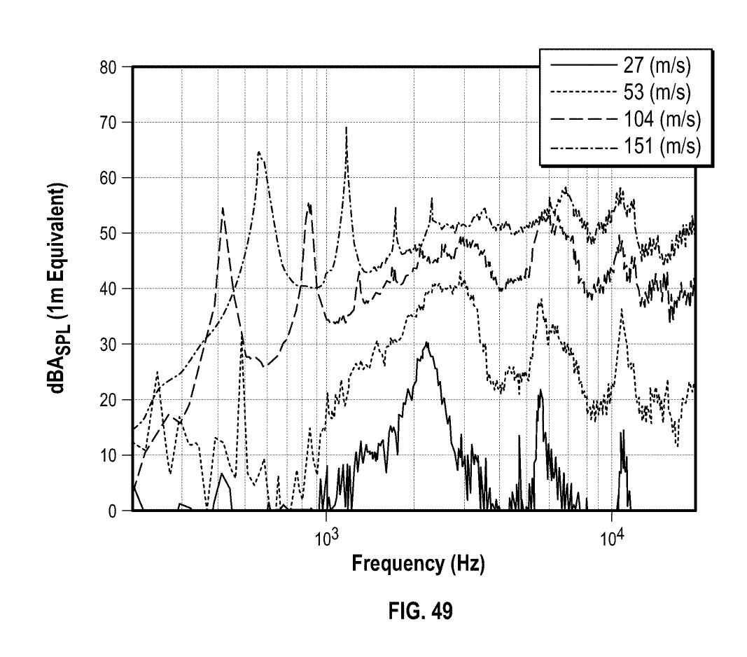

FIG. 49 shows far-field acoustic data for fluidic oscillator at several jet velocities.

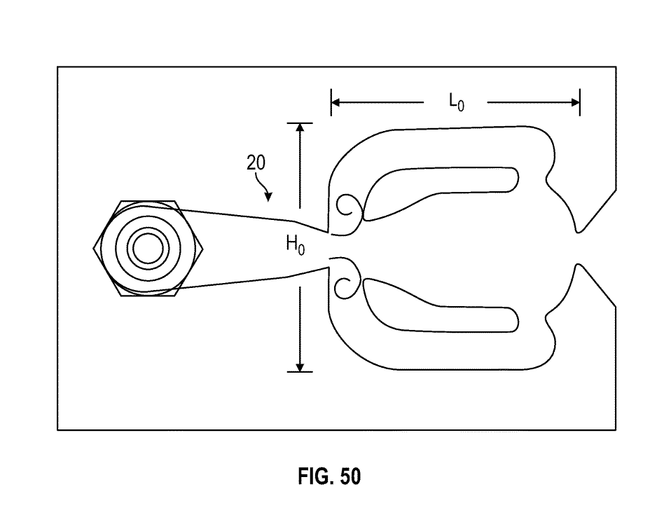

The frequency spectrum of the oscillator is presented in FIG. 49 for several jet velocities. The noise intensities increase with jet velocity (by more than 30 dB when doubled from 53 to 104 m/s). At 104 m/s, the noise signal has a fundamental frequency at 415 Hz with more than six higher harmonics visible up to 3 kHz. This fundamental coincides with the jet sweeping frequency, which increases with jet velocity. The second harmonic at 830 Hz generates similar sound pressure levels as the fundamental. An additional fundamental frequency, generated by another mechanism, was seen near 5,500 Hz along with a strong harmonic at 11,000 Hz for all jet velocities. The amplitude of this tone increases with velocity, however the frequency does not, which suggests that the phenomenon was not related to the oscillation of the jet, but due to a resonance or standing wave within the oscillator cavity. A relevant length scale for this phenomenon may be the distance between outer walls of the feedback channels Hₒ=28 mm, shown in FIG. 50. The standing waves formed by a cross-junction mode may be similarly forced by the shear layers entering the nozzle cavity, as depicted in FIG. 50.

FIG. 50 shows oscillator indicating the relevant cavity noise length scale.

The fundamental frequency for this type of mode is described by,

$$f = \frac{c}{2 {H}_{o}}$$

where c is the sound speed, and Hₒ is the total width of the cavity. This predicts a fundamental cavity frequency close to 5,900 Hz, which was slightly higher than the observed value, possibly due to the semi-open end conditions.

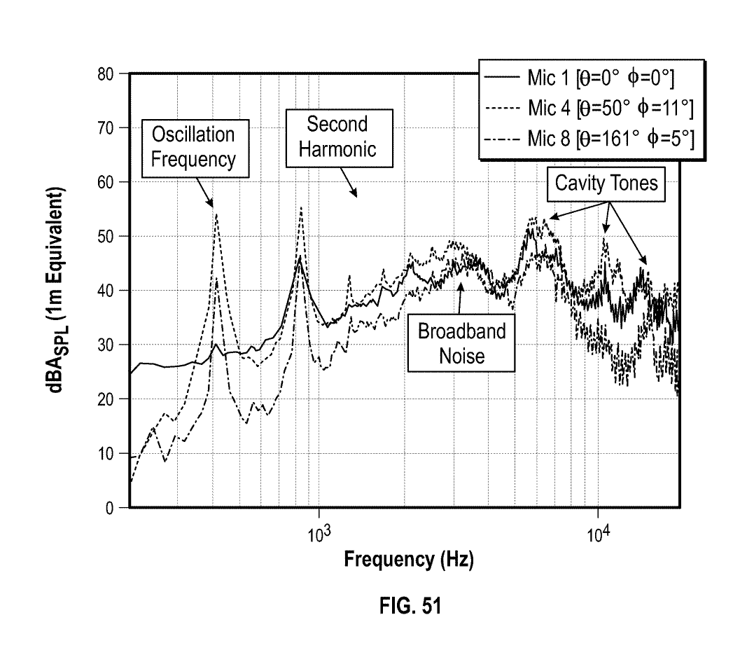

FIG. 51 shows acoustic spectra at several microphone locations.

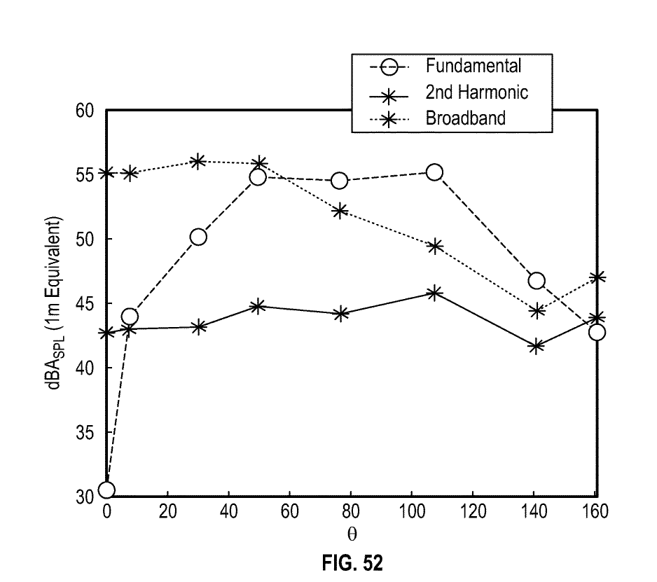

The directionality of the acoustic sources may be assessed from the variation in sound levels measured along the microphone array depicted in FIG. 48. FIG. 51 shows the frequency spectrum measured from several microphone locations at an oscillator jet velocity of 104 m/s. The angle θ is from the microphone to the jet centerline (about the sweeping plane) as shown in FIG. 48. The angle φ is the inclination of the microphone location above the jet sweeping plane. The directivity of the fundamental tone (oscillation frequency) and the second harmonic are shown in FIG. 52 for all microphone locations.

FIG. 52 shows directivity of the oscillation and second harmonic far field noise.

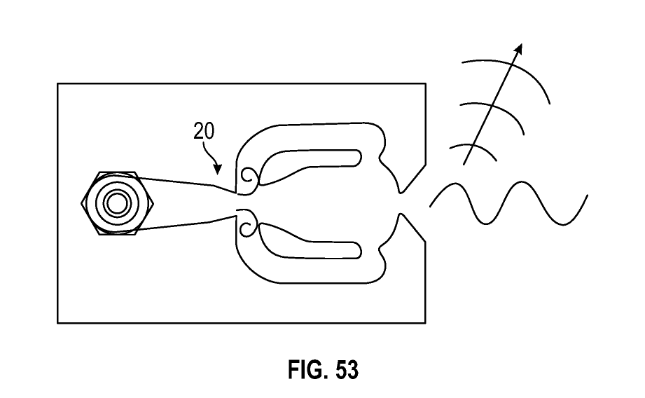

The noise at the oscillation frequency is highly directional and greatest from θ=50° to 107°, while the second harmonic is slightly less directional with a maximum amplitude at θ=30° Directionality of the broadband noise (defined as 2500-4500 Hz) is weak, suggesting that traditional coherent structures within the jet shear layer do not dominate the noise signature. The highly tonal oscillator acoustic behavior differs from a steady round jet, which contains broad spectral peaks associated with turbulent structures of various scales in the jet shear layer. The offset of the oscillation noise from the jet centerline may result because the oscillation associated hydrodynamic disturbances are maximum near the extreme of jet sweep, as depicted in FIG. 53. Characterization of the external flowfield of a similar oscillator geometry shows the jet extreme angles to be ±48°, which agrees with the maximum sound radiation angle from the oscillator noise source seen in the present embodiment.

FIG. 53 is a depiction of oscillation induced acoustic waves.

The acoustic analyses show that there are multiple mechanisms for noise generation. The majority of the tonal noise is due to a mechanism that occurred at the oscillator sweeping frequency along with its higher harmonics (oscillation source). A sizable portion of the noise is also due to a mechanism that was frequency independent of jet velocity (cavity resonance source). Additionally, broad spectrum noise that increases with jet velocity is present in the audible range beyond 1 kHz, due to turbulent fluctuations. The maximum noise amplitude is close to 70 dBA, which indicates that sound dampening considerations may be needed for passenger comfort if implemented on a vehicle.

B. Oscillation Frequency Modification

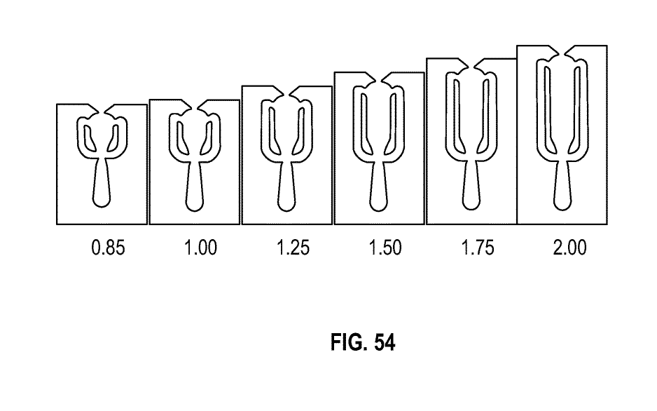

Certain flow control applications may require that the oscillator frequency be tuned independently of jet velocity to maximize streamwise vorticity generation, change the tonal peak for acoustic noise mitigation, or to influence certain periodic flow phenomena. Oscillation frequency is dictated by the feedback channel length and the flowrate through the oscillator (which determines the mean velocity in the cavity). Increasing the feedback channel and cavity length can decrease the frequency, partially due to longer mass transit time through the feedback mechanism. In this embodiment, scaling of the feedback channels is done to examine the trends in frequency shift. The scales examined in this embodiment is presented in FIG. 54, where the 1.00 scale is the d=4.1 mm oscillator used for the majority of the drag models.

FIG. 54 depicts oscillator feedback length scaling.

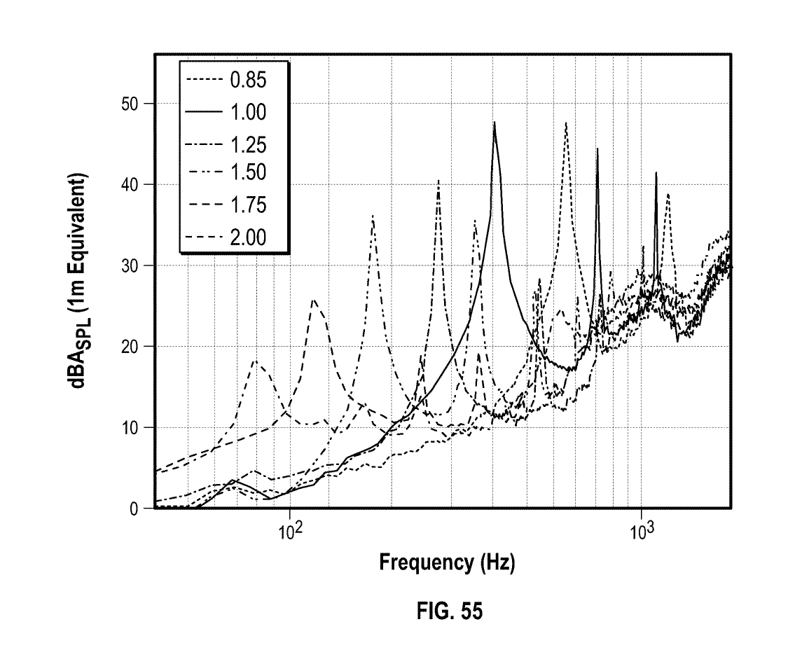

Acrylic oscillators are used for each scale, instead of a SLA fabricated oscillator. This embodiment can be based on a model with a benchtop microphone setup. Measurements from a microphone located on the sweeping plane, 0.25 m from the jet exit at θ=65° are presented herein. The associated microphone conditioning equipment is the same. The frequency scaling results for a constant mass flowrate at a jet exit velocity near 104 m/s are presented in FIG. 55.

FIG. 55 shows feedback scaling frequency results at Vj=104 m/s.

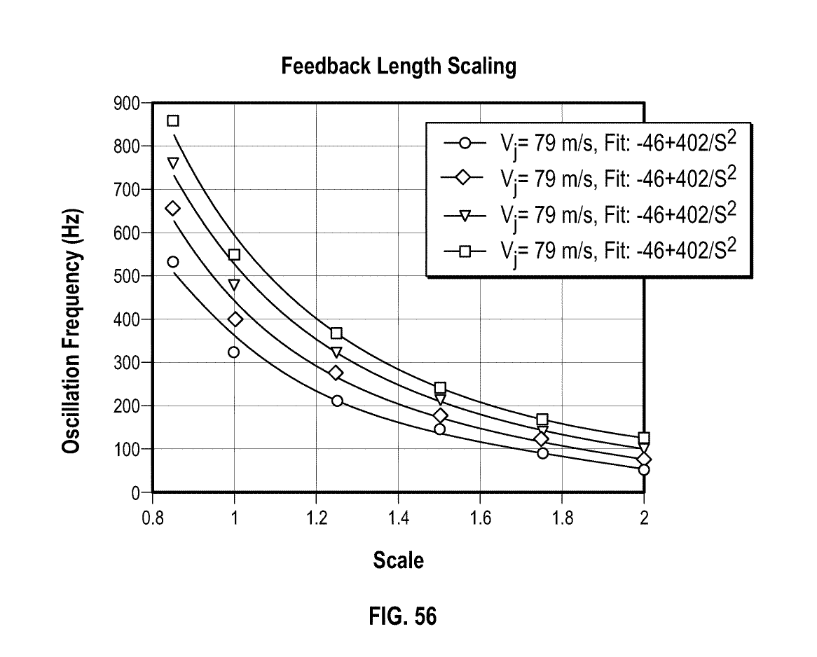

The presence of the oscillation tone and its harmonics, along with higher frequency cavity noise seen in section 4.1, are also suggested in these results. The far-field tonal peaks due to the oscillating jet allowed measurement of the jet sweeping frequency. FIG. 56 indicates that oscillation frequency decreases as 1/Lₒ², suggesting that increased transit time through the feedback channels is not the only phenomena influencing the frequency shift. Another factor is the increased affinity for the jet to attach to the longer cavity walls, which reduced the rate at which the jet detached and switched to the opposite wall. The switching mechanism of this type of oscillator is shown by to be governed by the growth of the main cavity separation bubble, which is fed by the flow from the feedback channels. The critical separation bubble size is likely larger on the stretched oscillator and requires more time to grow. The greater affinity for wall attachment and increased critical separation bubble size are likely coupled phenomena that in conjunction with the longer transit time through the feedback channels contributed to the 1/Lₒ² scaling.

FIG. 56 shows oscillation frequency vs. feedback length scale at several jet velocities.

C. Pressure Drop and Energy Requirements

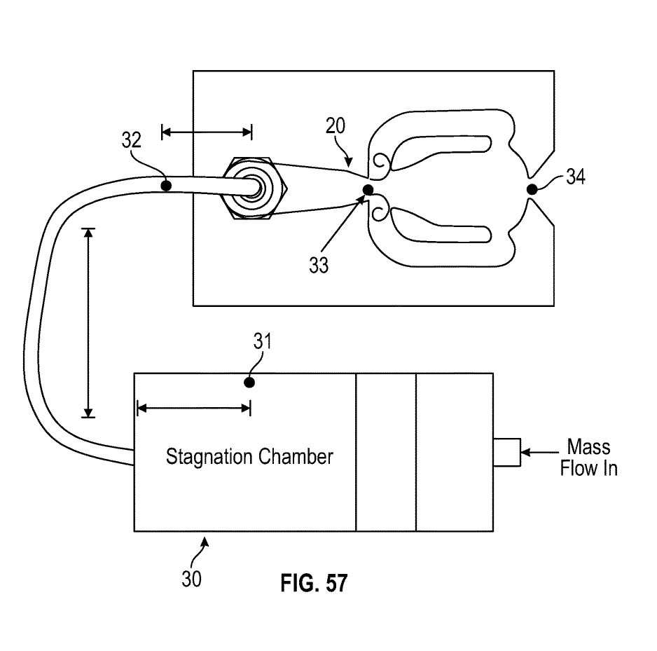

Pressurized air requirements for an oscillator flow control system are estimated by measuring the total pressure at several locations within the representative setup shown in FIG. 57. The mass flow through the system is metered with an electronic mass flow controller. Total pressure is measured directly or determined from static pressure measurements taken at several locations along the system using a 32 channel pressure brick (Chell μDAQ 32-DTC) referenced to ambient. The same SLA oscillator is the subject of this embodiment, which has of similar dimensions to the acrylic oscillators used in the Ahmed model tests (exit nozzle width of d=4.1 mm).

FIG. 57 shows a representative system used to evaluate oscillator pressure drop and energy requirements.

A stagnation chamber (50 mm ID pipe) immediately ahead of the 3 m tubing run allows for direct measurement of the input total pressure to the system (Tap 1). The total pressure is measured ahead of the entrance to the oscillator fitting with static tap on the side of the inlet hose (Tap 2), 150 mm ahead of the oscillator inlet fitting. The dynamic pressure at this location is inferred from the known mass flowrate, cross sectional area of the flow channel, and local static pressure. A similar method was used to determine the total pressure at the inlet to the oscillator chamber (Tap 3) and at the outlet of the oscillator chamber (Tap 4). Jet exit velocity is estimated to be the result of a complete expansion to ambient of the static pressure measured at Tap 4.

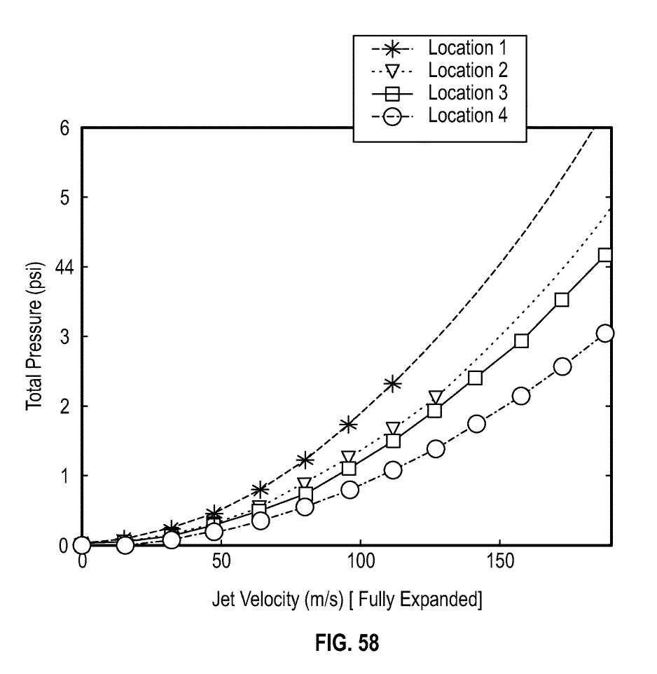

FIG. 58 shows total pressure vs. oscillator outlet jet velocity at several locations in the representative distribution system (data points and 2nd order fit presented). FIG. 58 shows the total pressure as function of jet velocity at various locations in the system. Tap 1 represents the total pressure input to the entire system, and includes losses in the tubing and fittings. A more relevant measure of energy requirements may be found from tap 2, which is just ahead of the fitting on the oscillator. This location neglects the pressure losses in the hose, which may be reduced considerably with an increased hose diameter. Location 3 includes the pressure needed to overcome losses within the oscillator cavity and accelerate the flow to the jet outlet velocity. The total pressure introduced into the flow field is approximately that measured at the jet exit (location 4).

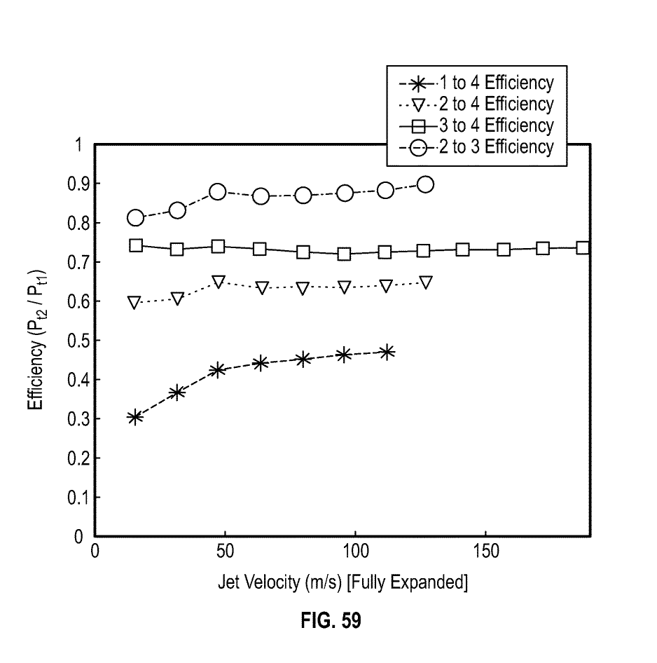

FIG. 59 shows total to total efficiency between several locations in the system.

The metric of efficiency selected for this analysis is the total pressure ratio between two points of interest in the system. FIG. 59 gives the efficiency between several locations as a function of jet exit velocity. The system efficiency from the stagnation chamber to the oscillator exit (Tap 1 to 4) increases slightly with flowrate and approached 48%. The efficiency is closer to 60% if the system starting from the oscillator inlet fitting to jet exit is considered (Tap 2 to 4), which is a more useful metric of the system efficiency because of the arbitrary hose length and stagnation chamber fittings losses. The efficiency across the oscillator mixing chamber (Tap 3 to 4) is independent of velocity and near 73%. This is roughly the maximum efficiency possible (with this oscillator) for the flow conversion from pump total pressure to a sweeping jet entering the flow field without modifying the internal cavity geometry, height, or wall roughness.

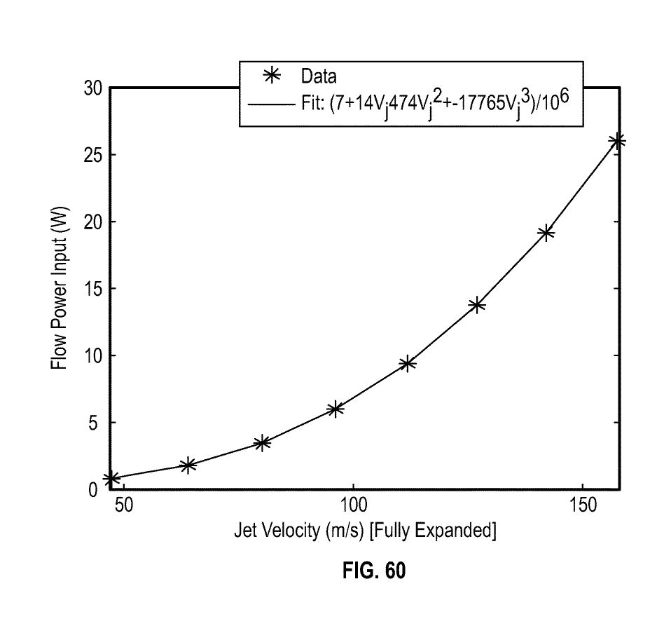

FIG. 60 shows system flow power requirement for a single oscillator vs. jet velocity.

Flow power requirements are the primary concern for sizing the pump system, and can be estimated as the product of the local total pressure (pₜ) and local flowrate (Q),

P_{system}=pₜQ

The tap location 1 was selected to conservatively estimate the power requirements by including all losses in the system. FIG. 60 shows the amount of useful flow power that the pump must output for a single oscillator at the associated tap 1 total pressure. The power requirement is of order 10 watts and scales with Vⱼ³, which has implications for optimization of the flow control method. A relatively small change in jet velocity ratio can lead to a significant change in the energy requirements of the AFC system. The jet velocity ratio is shown to have a strong impact on drag reduction, and will need to be carefully balanced with the actuator energy requirements. Though the results are for a single oscillator, the total flow energy requirement may scale linearly with the number of oscillators present in the array because the pressure requirements per oscillator will not change.

D. Net Energy Benefit

Parameter sensitivities can be examined to provide a notional understanding of where to apply actuation to a vehicle. Of critical concern for implementation is the amount of energy consumed by the fluidic oscillators and associated systems relative to the drag power saved through actuation. The goal of AFC is to provide a net benefit beyond what can be achieved with a passive solution under the constraints imposed on vehicle design.

This analysis is based on assumed values of vehicle size, oscillator placement, and required jet velocity ratio. The embodiments of the symmetry and underbody models suggest that implementation on the aft lower portion of the vehicle may provide the greatest benefit in terms of drag reduction relative to energy input. Losses from the underbody roughness element introduces a significant drag penalty that may be mitigated by the oscillator jets. Similar losses occur due to underbody disturbances on a real vehicle, such that oscillators placed upstream of a flap surface under the rear bumper may show benefit. The wheel wake losses on the sides of the vehicle have a similar effect on drag as the underbody component losses, so control will also be added to the sides and extend above the wheel arch. The actuator scaling models on which the embodiments are based suggests that maintaining a jet spacing close to 40 mm is optimal and the jet velocity ratio is the governing parameter for effectiveness at this spacing.

A typical vehicle shape of 2 m wide and 1.5 m tall with 0.2 m of ground clearance can be selected for this analysis. The wheel diameter is assumed to be 0.7 m, which requires that the jets extend 0.5 m along the side of the car to terminate at the wheel arch. These estimates suggest that nearly 3 m of perimeter must be covered with jets, and based on the previous spacing close to 40 mm, approximately 75 oscillators would be needed. The jet velocity ratio needed to condition the flow in the turbulent underbody region is close to VR=3.5. Based on the highway speeds of a typical vehicle of 30 m/s, the jet velocity at the oscillator exit is near 105 m/s. A pump output flow power close to 8 W is needed to power each individual oscillator, or 600 W for the entire array of 75 jets. Assuming a pump and distribution efficiency of 60%, the load to the engine is close to 1.0 kW.

The total drag power on a vehicle at highway speed may be estimated from the notional frontal area (3 m²) and an assumed drag coefficient of a typical bluff production vehicle of 0.32. The drag power is given by the following equation,

P_{Drag}=½ρ_{∞}V_{∞}³AC_{D}

and the drag power savings may be calculated from the ΔC_{D} as,

ΔP_{Drag}=½ρ_{∞}V_{∞}³AΔC_{D}

Using the previously assumed values at STP, the baseline drag power is close to 16.7 kW at highway speeds. The aerodynamic drag burden to the engine is slightly higher if drivetrain losses are considered. In order for the active flow control method to break even under the prescribed conditions, a drag reduction close to 19 counts would be needed on the full scale vehicle. This reduction or greater is not beyond the realm of possibility considering that the baseline drag coefficient is the result of a highly asymmetric and disturbed underbody flowfield which was able to be controlled on the Ahmed model, leading to reductions close to 80 counts. Further optimization of the actuation setup is also possible to reduce the energy needed to power the jets. The use of actuation is most useful at higher speeds (greater than 45 mph) due to the higher relative contribution of aerodynamic loading to mechanical drag. The actuation energy requirements are within reason relative to possible drag reduction values.

### V. Additional Features

Fluidic oscillator separation control on the square-back Ahmed model geometry can be examined to measure numerous parameter sensitivity trends related to oscillator details and boundary conditions for implementation into a vehicle.

Separation control leads to substantial wake and base pressure changes, and drag reduction of up to 70 counts relative to baseline square-back value. The effect of the oscillator jets on drag changes is large relative to the thrust that would be expected from a simple expansion of the required total pressure (maximum ration of ΔC_{D} to C_{μ} near 45), which indicates an efficient use of actuator energy. An optimal actively controlled boat-tail flap angle is found to be close to 20° with pitched jets while an optimal passive angle was near 15° The pitched jet configuration appears to be more favorable than tangential jets, in terms of benefit beyond best case passive, possibly due to the smooth transition between the jet outlet and flap shoulder which inhibits separation. A jet location slightly upstream of the flap shoulder is generally found to be most effective, possibly due to the evolution of streamwise vorticity from the oscillator outlet. Actuation on all four sides of the boat-tail leads to the greatest drag reduction, however control on only the lower surface has potential for respectable gains. The turbulent character of underbody flow leads to greater difficulty in flow attachment on the lower flap and increased wake asymmetry, that when corrected led to a substantial drag decrease (up to 80 counts). A geometric scaling model on which embodiments are based suggests that actuation energy requirements relative to the drag changes become more favorable as model size increases, and that a way to scale the actuators is to keep the size and spacing moderate while increasing the number of jets to fill a larger span. The effects of rolling road, speed change, and ride height on ΔC_{D} are weak relative to the overall changes.

An examination of the fluidic oscillator acoustical signature indicates that there are several sources of far field noise including the hydrodynamic fluctuations from the oscillating jet and an additional cavity resonance source possibly related to a transverse mode near the inlet of the oscillation chamber. An analysis of the pressure drop across a notional oscillator supply system indicates that power pump power requirements for a single oscillator is of order 10 watts, and that the conversion efficiency across the oscillator itself is relatively high. A theoretical application of the AFC to a vehicle suggests that the actuator energy requirements relative to an estimated drag reduction are within reason.

A. Oscillator Streamwise Vorticity

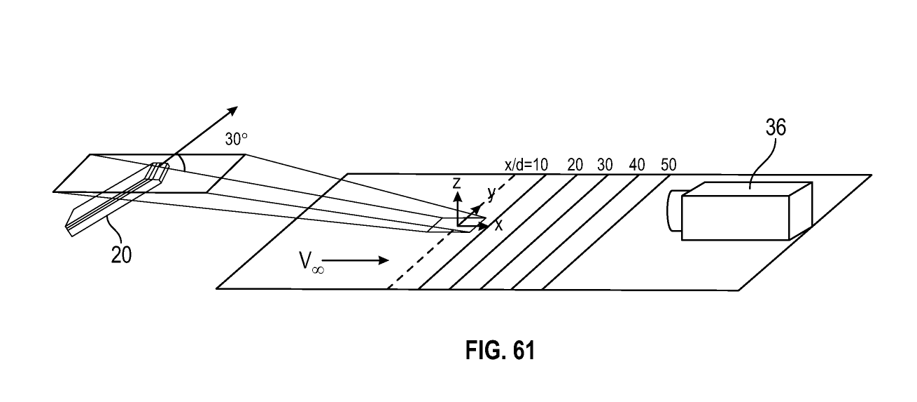

Streamwise vorticity is one of the mechanisms behind the fluidic oscillator's separation control effectiveness. An embodiment based on an initial model can be conducted to map the streamwise vorticity at several locations downstream of a single 30° pitched fluidic oscillator in a zero pressure gradient flat plate test section can be used for determining boundary layers. The test section dimensions are 0.61×1.22 m with a plate length of 6 m in the streamwise direction, and turbulence intensity is rated at 0.05% with 5 Hz cutoff. Removable access panels at various streamwise locations are present, and the oscillator is placed at a location 1.5 m beyond the plate leading edge. The oscillator jet diameter is the same as that used in the majority of the Ahmed model tests (d=4.1 mm). The camera is placed in the tunnel and oriented upstream towards the oscillator, as shown in FIG. 61, at distance of 430 mm from the image plane. FIG. 61 shows a setup for streamwise vorticity measurements behind a 30° pitched fluidic oscillator.

An example image from this embodiment is shown in FIG. 62, which is the ensemble average of 750 instantaneous vorticity snapshots at a freestream speed of 20 m/s. The oscillator center is located at (y,z)=(0,0) and the view is from the perspective of a downstream observer. The image is limited to 2 mm above the flat plate due to laser reflections. A double pulse 532 mm laser is used, and the images are processed with software and a 32×32 interrogation window with 50% overlap.

The results indicate that a single fluidic oscillator generates a pair of counter rotating streamwise vortices along with secondary near wall vortex structures. The height of the vortices is of order jet diameter, and extended several jet diameters above the surface. The boundary layer profile and thickness are not measured for this embodiment, however analytical flat plate estimates suggest a transitional boundary layer (Reₓ≈1.8×10⁶) with δ close to 2d (≈10 mm) at the jet exit.

FIG. 62 shows streamwise vorticity (ωₓ) generated by a single pitched fluidic oscillator. The PIV imaging location is 30d downstream of the jet exit with jet velocity ratio=3.

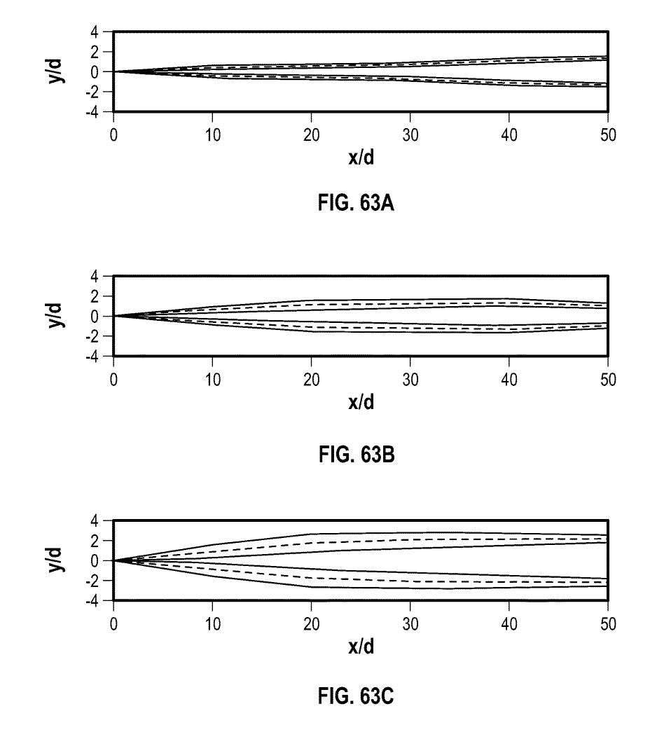

The evolution of vortex shape for three different jet velocity ratios ranging from 1.3 to 4 is shown in FIGS. 63A-C At VR=4.0, the maximum vortex size as arbitrarily defined by ωₓ=500 s⁻¹ occur nearly 20 jet diameters downstream of the jet exit. The vortex strength decreases, however the signature is still present at the further downstream imaging location of x/d=50. The fact that the length scales associated with vortex development are of order 10d has implications for the optimal jet location for separation control. As indicated in the other studies discussed herein, an optimal jet location is close to 10d upstream of the separation location.

FIGS. 63A-C show Isolines of ωₓ=500 s⁻¹ at three different jet velocities. FIG. 63A, FIG. 63B, and FIG. 63C are at jet velocity ratios of 1.3, 2.7, and 4.0 respectively. Distances from the jet exit are normalized by the jet diameter d=4.1 mm.

The results further verify that a useful magnitude of streamwise vorticity is present beyond the oscillator outlet and suggest why jet location relative to separation is an important parameter for full utilization of streamwise vortex strength.

B. Additional Datasets

FIGS. 64A-C show pressure variation between the jet centered taps and taps immediately downstream of an oscillator on. The results are from the pitched jet B configuration with 20° in FIG. 64A, 25° in FIG. 64B, and 30° in FIG. 64C, flaps with 30° jets located at 0d at C_{μ}=0.215.

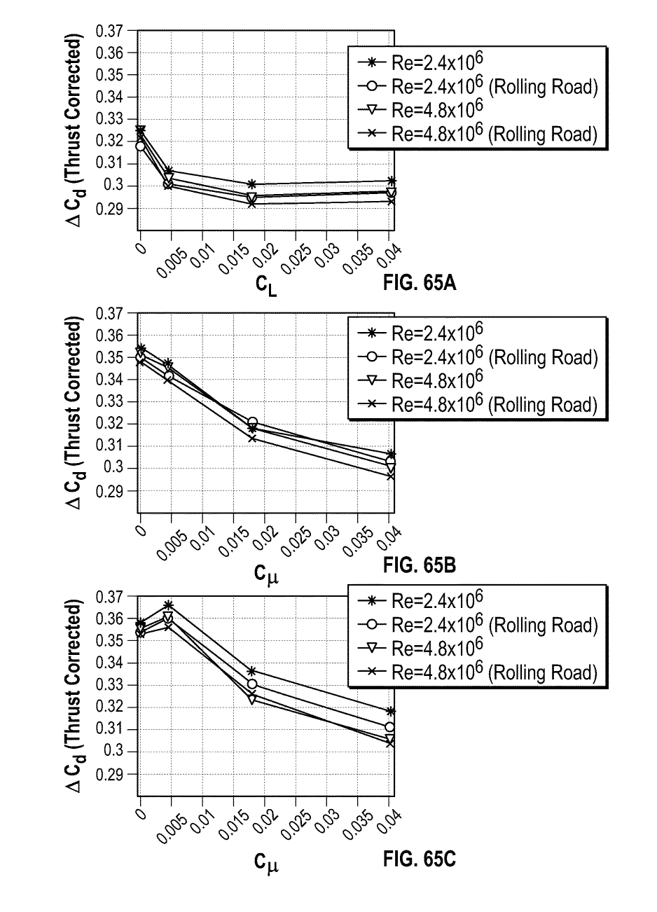

FIGS. 65A-C show Re and Rolling road sensitivity based on square-back models at ride height value h/H=0.23. FIG. 65A, FIG. 65B, and FIG. 65C are for 10°, 15°, and 20° flaps respectively.

FIGS. 66A-B show wake surveys behind the pitched jets B square-back model with sealed cavity [C_{D}=0.275] in FIG. 66A and open cavity [C_{D}=0.251] in FIG. 66B. The flaps were set to 0° to achieve the square-back representation.

C. Acoustics Details

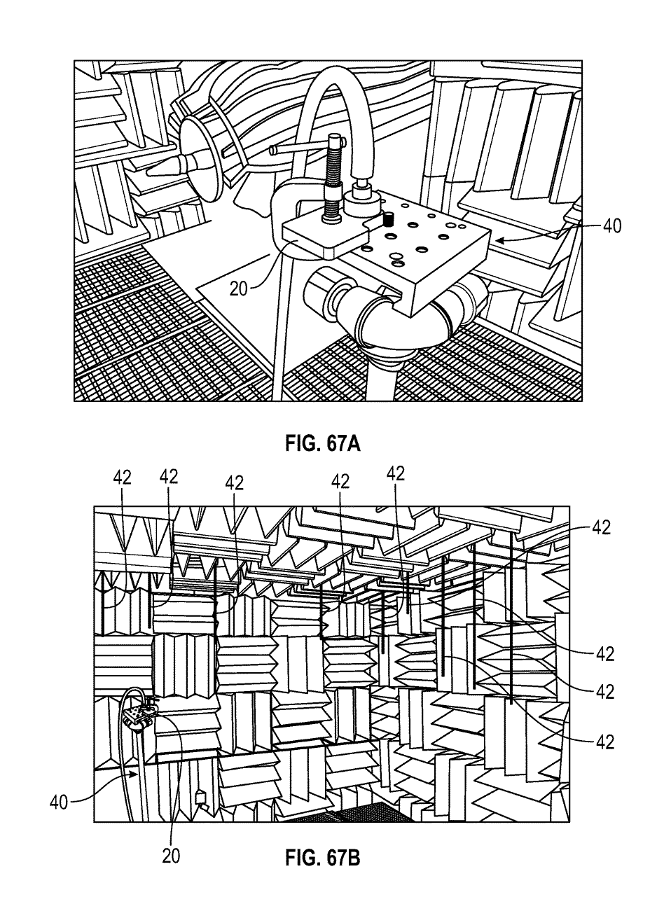

FIGS. 67A-B show oscillator mounting in anechoic chamber and microphone array overview.

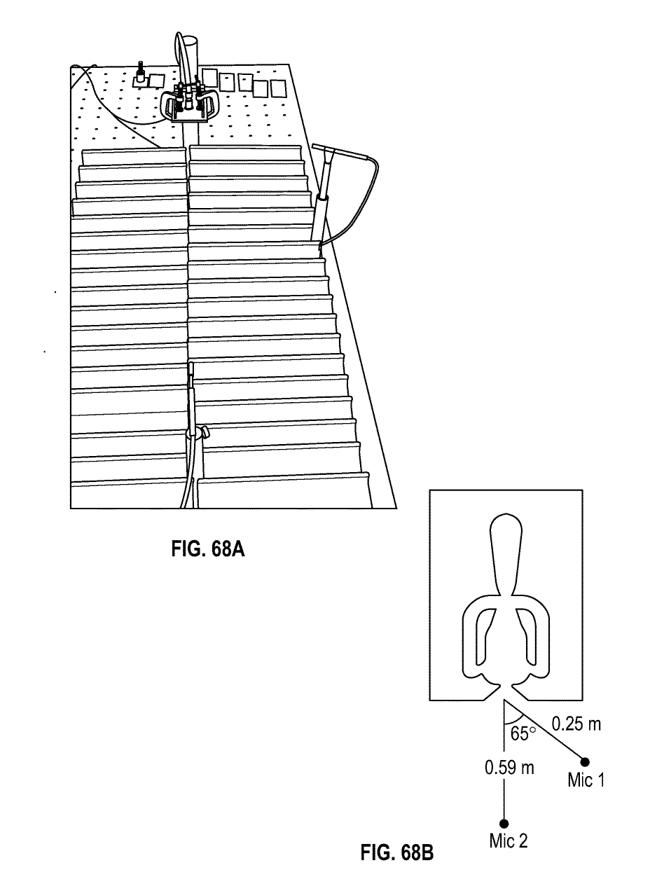

FIG. 68A-B show benchtop acoustic microphone layout.

D. Fluid Oscillator Application to Road Vehicles for the Purpose of Base Pressure Manipulation and Aerodynamic Drag Reduction

The present disclosure contemplates applying a plurality of fluid oscillators to a rear perimeter section of a vehicle, such as a tractor trailer, car, minivan, sports utility vehicle, and the like, for the purpose of increasing rear vehicle portion base pressure, controlling flow separation off the rear portion of the vehicle (such as off the trailer) and reducing aerodynamic drag off the rear portion of the vehicle (such as off the trailer).

The performance of the oscillator is proportional to the area of the perimeter and the benefit increases with the number of oscillators applied.

According to one embodiment of the present disclosure, a plurality of oscillators may be applied on all 4 sides of the rear portion of a tractor trailer truck for effective reduction of drag (sides comprises top, bottom, driver side and passenger side). However, the present disclosure also contemplates applying oscillators on only the top and sides (3 sides) for an effective configuration for reducing drag. The oscillators of the present disclosure can be implemented on a tractor trailer utilizing tail flaps at the base of the flaps, as illustrated below.

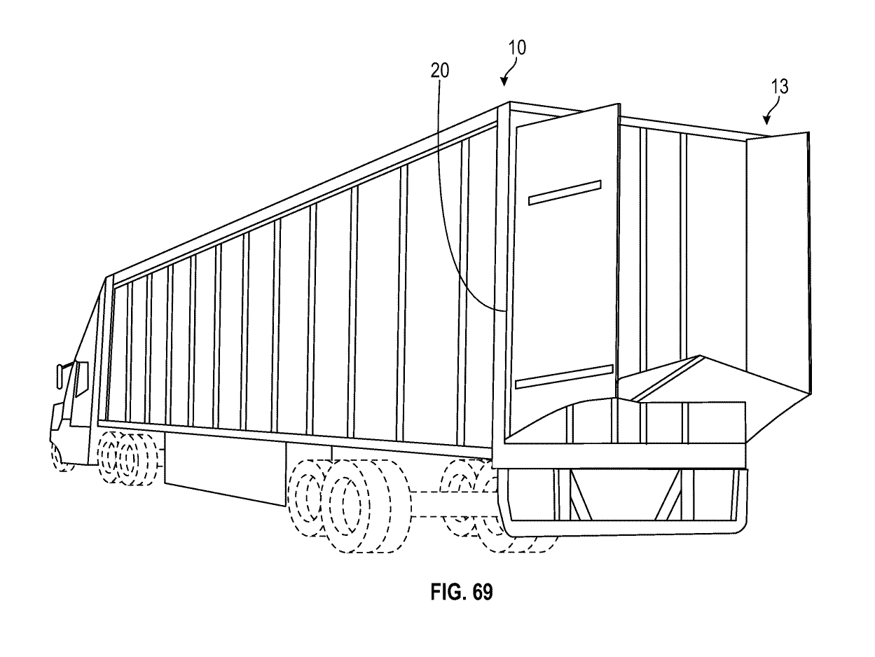

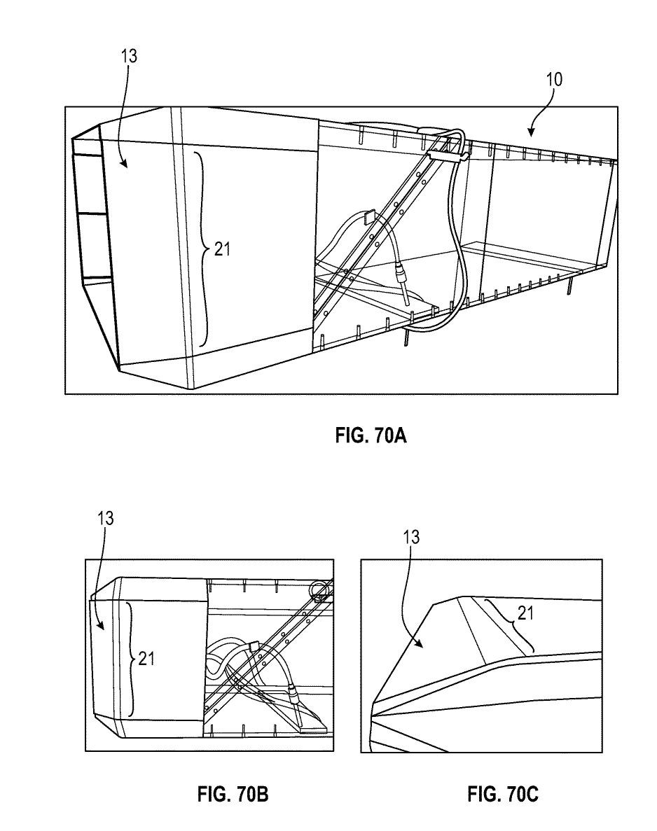

FIG. 69 is a perspective view of an exemplary vehicle having oscillators arranged along bases of a flap assembly. FIG. 70A is a perspective view of an exemplary vehicle having oscillators arranged along bases of a flap assembly. FIG. 70B is a perspective view of an exemplary vehicle having oscillators arranged along bases of a flap assembly. FIG. 70C is a perspective view of an exemplary vehicle having oscillators arranged along bases of a flap assembly.

The present disclosure also contemplates application of fluid oscillators to the perimeter of the rear section of a passenger vehicle, such as a square back rear portion of a vehicle such as a van, minivan, station wagon, or SUV for the purpose of increasing base pressure, controlling flow separation of the vehicle and reducing aerodynamic drag.

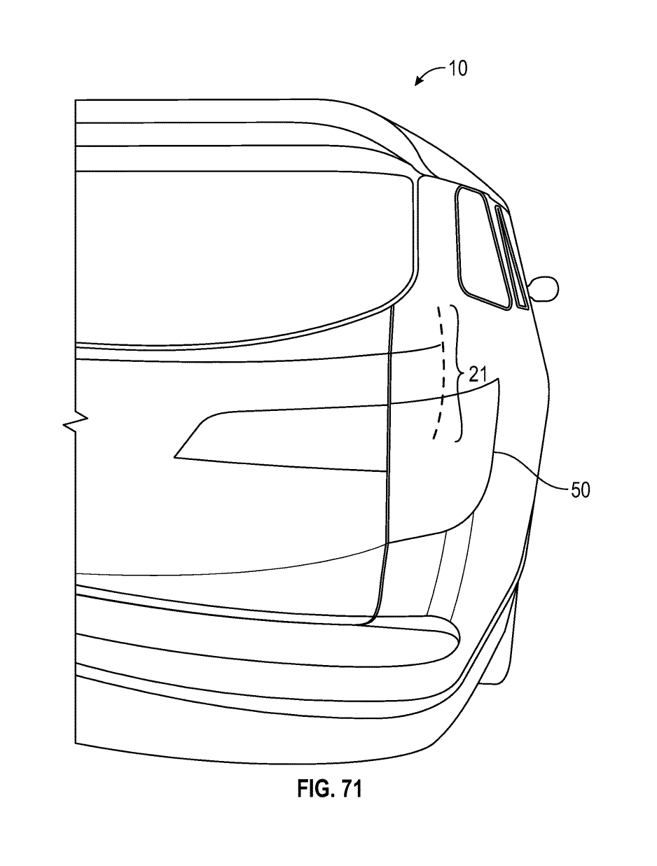

FIG. 71 is a perspective view of an exemplary vehicle having an oscillator array.

Application of the oscillators on a passenger vehicle has similar principles as to application to a tractor trailer. The present disclosure provides that oscillators can be applied to the perimeter or periphery of the rear portion of the vehicle and contemplates a plurality of oscillators on each side, just a 2-3 sides, or just one side, as warranted by performance and vehicle shape and configuration.

According to one embodiment of the present disclosure, at least one oscillator, preferably a plurality, may be positioned along the sides of a vehicle (driver side and passenger side), on a rear surface, a side surface, or where the rear and side surfaces meet (corner). Moreover, at least one oscillator may be integrated into the tail lights, reverse lights, or turning lights; where such lighting configuration designs exist.

At least one oscillator is provided on a bumper side and tail lights. However, the present disclosure contemplates oscillators integrated into rear decklids, roof, trunks, boot, spoilers, or rear covers of automobiles, trucks, vans, and minivans, while keeping within the scope and spirit of the present disclosure.

In another embodiment of the present disclosure, oscillators may be located along the top of a vehicle's roof and/or roof spoiler (if the vehicle is equipped with one), as illustrated below.

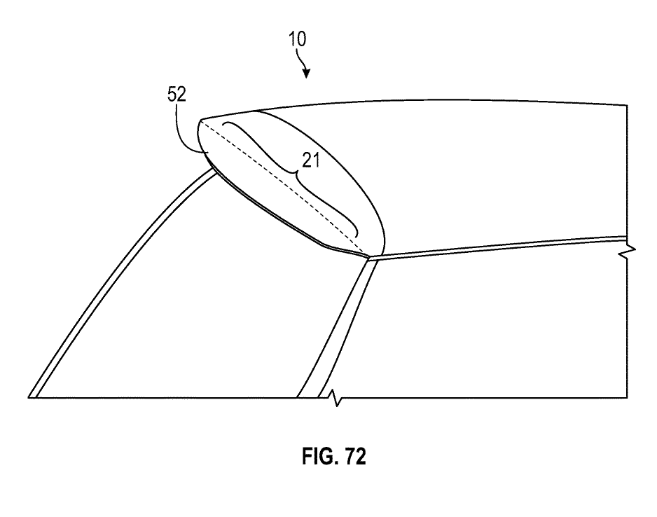

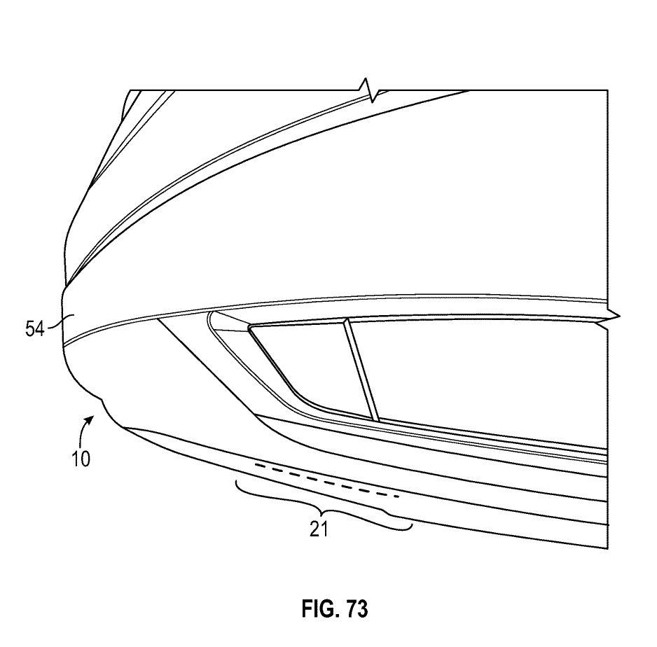

FIG. 72 is a perspective view of an exemplary vehicle having an oscillator array. FIG. 73 is a perspective view of an exemplary vehicle having an oscillator array.

In yet another embodiment of the present disclosure, oscillators may be located along the bottom of a bumper flange of a vehicle and/or a rear diffuser (if the vehicle is equipped with one), as illustrated above.

The present disclosure also contemplates implementing at least one fluidic oscillators at, on, or around side mirrors on vehicles keeping with the scope and spirit of the present disclosure, as illustrated below.

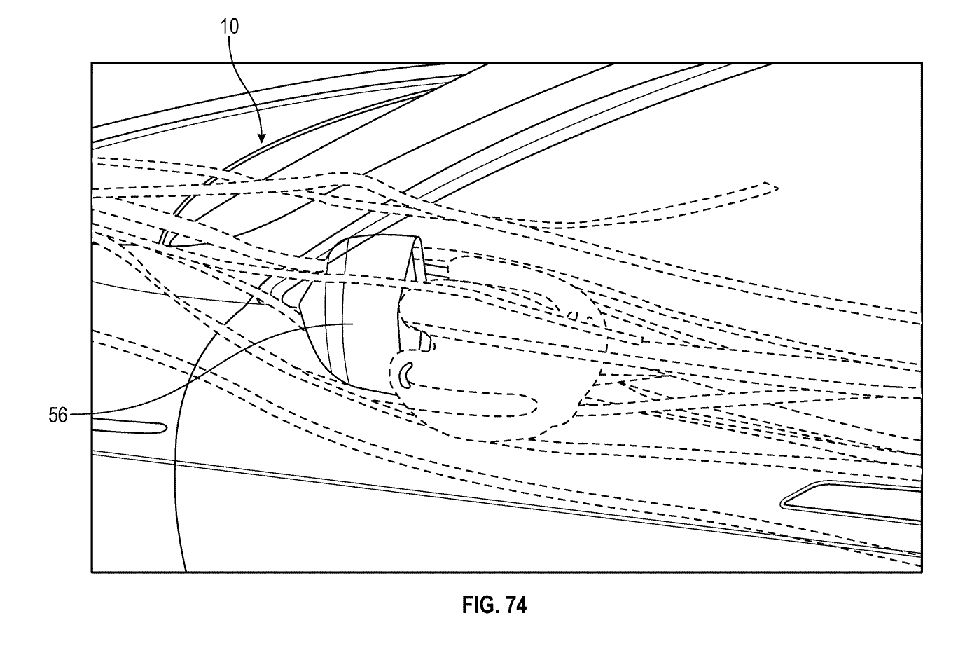

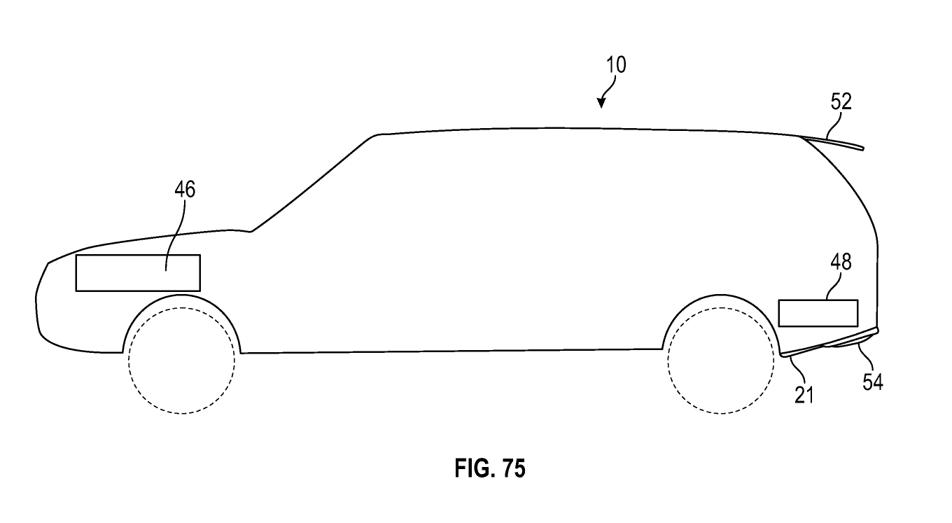

FIG. 74 is a perspective view of an exemplary vehicle having an oscillator array.

Thus, the disclosure may be applied to any motorized vehicle, including, but not limited to cars, trucks, minivans, SUVs, station wagons, and the like; and motorcycles and all-terrain vehicles such as four wheelers, and side by sides. The addition of oscillators near the side mirrors reduces aerodynamic drag, vortex/vortices, and noise (which may be heard in the vehicle cabin).

The present disclosure contemplates supplying compressed air to the oscillators (as discussed above). A source of compressed air may be integrated or separate from the vehicle.

According to the present disclosure, the top, sides and bottom flaps have different flap angles as well as different flow rates supplied to the oscillators.

E. Underbody Active Flow Control System

1. System Description

This disclosure describes an active flow control system that aims to alter the aerodynamic behavior of near ground bluff bodies, such as cars, trucks, convertibles, SUVs and the like, through fluidic means. The goal of the system is to favorably alter drag and/or rear lift on the vehicle, through manipulation of the low pressure base wake region. The wake structure behind a ground vehicle is asymmetric due to geometrical differences between the upper and lower body, ground interaction, and losses from the macro roughness of the vehicle underbody. The underbody flow generally has a lower velocity and lower total pressure than the upper body flow, and contains variation along the width of the vehicle due to interaction with the wheels and tires upstream. Asymmetry between the upper and lower wake structure leads to a net vectoring of the wake in an upwards or downwards direction. Research has shown that properly tuning the flow on the upper surface of the car relative to the underbody can lead to higher base pressure and lower drag. Alteration of the underbody flow with active flow control was shown to have a beneficial effect on the rear base pressure. A notional system required to achieve these flow field changes is described in this document. The active flow control system includes air jets, an onboard pump, air distribution system, control logic, and tuned spoiler/body surfaces on the upper and lower portions of the vehicle. Tuned surfaces on the vehicle can include contoured surfaces as well as spoilers, vanes, diffusers, strakes, canards, and any other type of surface configured to modify airflow. Specifically, the tuned spoiler/body surfaces on the upper portions of the vehicle can be configured to manipulate airflow in conjunction with the air jets to enhance vehicle aerodynamics including wake. Tuned surfaces can additionally be disposed along sides of the vehicle between the upper and lower portions.

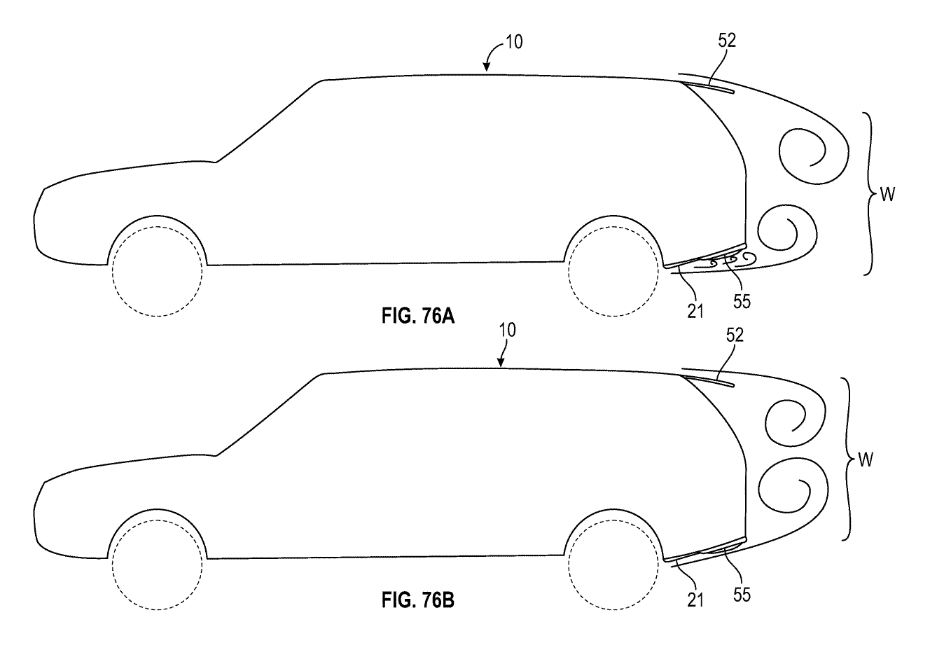

FIG. 76A is a schematic representation of an exemplary vehicle having an unactuated flow control system. FIG. 76B is a schematic representation of an exemplary vehicle having an actuated flow control system.

The underbody flow was shown to have the greatest propensity for flow separation, partially due to the thick incoming boundary layer state. This behavior increases the difficulty in achieving a balanced wake. The underbody flow poses a challenge to achieving wake symmetry with passive means, which prompts the use of active flow control to energize and vector this region of the vehicle wake. Each component of this system is described in detail in the following sections.

2. Flow Control Actuator

The flow control actuators are the system components that directly alter the flow field. There are many varieties of flow control actuators with varying degrees of efficiency that may be used for the system. Potential jet types include steady micro jets, fluidic oscillators, suction and oscillatory blowing jets (SAOB), steady VGJ's, pressurized slots, and distributed suction, among others. The commonality between the actuators is that there is an exchange of mass flow with the underbody flow with the intent of altering the flow field.

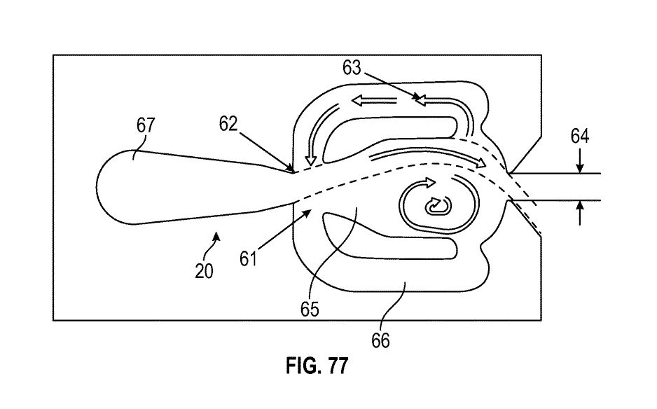

The jet of choice for this investigation is the fluidic oscillator due to its high efficiency altering the flowfield. A fluidic oscillator converts a steady flow input into a high frequency spatially oscillating jet due to interactions within the oscillator cavity, as shown in FIG. 77. FIG. 77 is a schematic representation of an exemplary fluidic oscillator. The oscillation frequency depends on a number of factors including the size of the device, mass flowrate, and length of the feedback channels, which was on the order of 1 kHz for the tested conditions. There are different geometries that can generate an oscillating jet pattern from a steady flow input.

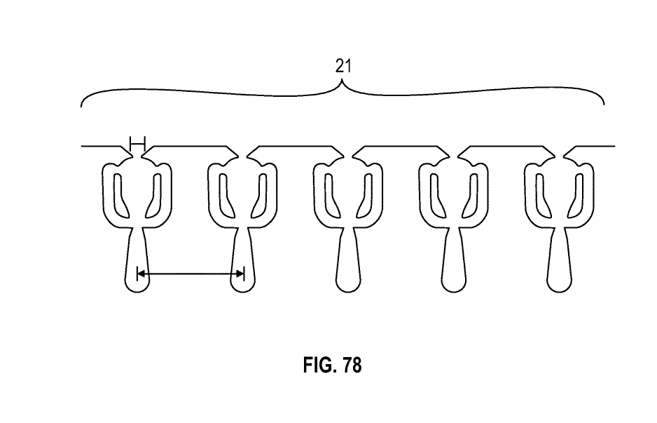

The jets should be applied ahead of the separation location for greatest efficiency. For fluidic oscillators, an optimal jet exit location was found to be close to 50 mm upstream of the flow separation location. The flow control method should be applied across the span that separation control is desired. The region of influence from a single oscillator jet can be limited, therefore many jets must be applied in an array. Several important variables related to the oscillator array are indicated in FIG. 78. A jet spacing (distance between jet exits) near λ=40 mm is recommended, however other spacing will also produce the desired flow field changes. An effective jet exit hydraulic diameter is close to d=4 mm. The oscillators may be manufactured from any material that can sustain the pressure within the oscillator while maintaining shape.

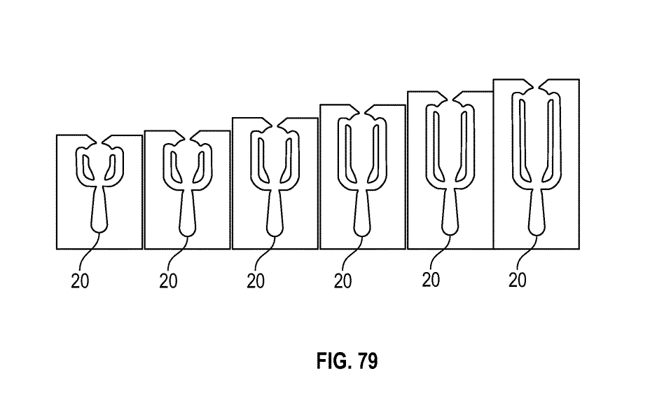

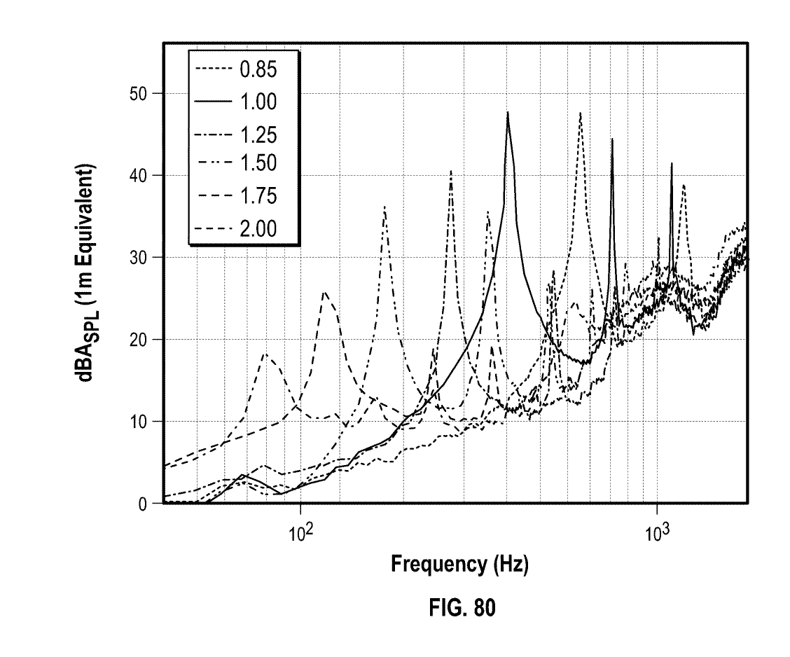

FIG. 78 is a schematic representation of an exemplary oscillator array. FIG. 79 is a schematic representation of exemplary oscillators. FIG. 80 is a graphical representation of oscillator frequency spectrum manipulation of the oscillators of FIG. 80.

Fluidic oscillators generate strong tones at the oscillation frequency and higher harmonics. The frequency range may be within the spectrum that is disruptive to passenger comfort (around 2 kHz). Oscillation frequency may be manipulated by changing the length of the feedback channels within the oscillation cavity of the feedback variety oscillator, as shown in FIG. 80. This can shift the frequency low enough in the audible range such that the noise becomes undetectable or minimal relative to other noise sources.

3. Diffuser

The purpose of the flow control actuators is to attach flow to the underbody diffuser surface. A diffuser is an underbody cover located behind the rear wheels, used to condition the underbody wake before exiting at the rear bumper. The diffuser acts to vector the underbody flow into the wake region for favorable manipulation of lift and/or drag. A tuned diffuser angle (between diffuser face and ground) will be preferably around 10° with an expected range between 5° and 20° The optimal angle is vehicle specific and depends on factors such as ground clearance, incidence of the flow from the upper body, and available packaging space under the vehicle. The flap diffuser length is largely determined by the existing components in rear portion of the underbody, rear overhang dimension, and minimum ground clearance. The profile of the diffuser may be straight or have curvature, as determined during the vehicle specific optimization process.

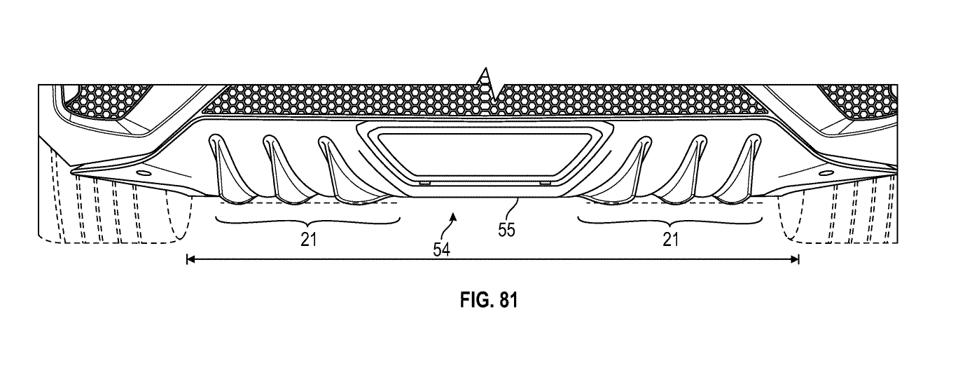

Flow on the diffuser may or may not be attached with the jet system OFF. Activation of the jet system will increase the degree of flow attachment to the diffuser surface. Testing has shown that the largest benefit is seen when the jets are placed on the outboard most region of the diffuser as depicted in FIG. 81.

FIG. 81 is a perspective view of diffuser actuators of an exemplary vehicle. An additional mechanism for the system effectiveness is the reduction in spanwise velocity gradient in the underbody, which can otherwise lead to large scale streamwise vortices in the wake. The wake streamwise vorticity is a source of drag, which when attenuated lead to higher base pressure. The underbody flow is generally strongest in the center of the car, and additional flow on the outboard portion on the diffuser reduces the spanwise variation. The interaction of the vortex structures from the upperbody and underbody depends on the flow exit angle on the upper surface of the vehicle.

4. Tuned Upper Body Surface

The vehicle wake dynamics are important in the overall base pressure and drag coefficient. Appropriate manipulation of the upper body shear layer and wake recirculation relative to the underbody can maximize base pressure. The boundary layer from the upper body is generally thinner than on the lower body, and more readily attaches to an upper flap surface. The terminal angle of the upper flap surface is in the range of 10° to 20°. Another important variable is the terminal location of the upper surface relative to the lower flap surface, which helps determine the start of the massively separated wake. Models of various embodiments have shown that matching the separation location on the upper surface with the lower improves drag coefficient. Methods of tuning the upper surface of the vehicle such that the interaction between upper and lower surfaces is favorable are not limited to those described above.

5. Pump/Generator

The pneumatic jets require an onboard air source/sink designed for continuous operation of the flow control system at the nominal vehicle cruising speed. The maximum benefit of the system is at highway speeds (greater than 45 mph), when aerodynamic drag becomes the dominant contributor to road load. The system control logic may activate the jets at the determined minimum speed and increase the jet velocity with speed to maintain the appropriate flow control authority. If fluidic oscillator jets are used as the flow control actuator, the jet velocity ratio (Jet velocity/Vehicle velocity) is shown to be optimal in the range of 2-4. The goal of the vehicle specific optimization process is to reduce the jet power relative to the flow control gains (by tuning jet location, jet velocity ratio, flap length, and angle, among other parameters), such that the net power savings (drag reduction relative to system power) is maximized.

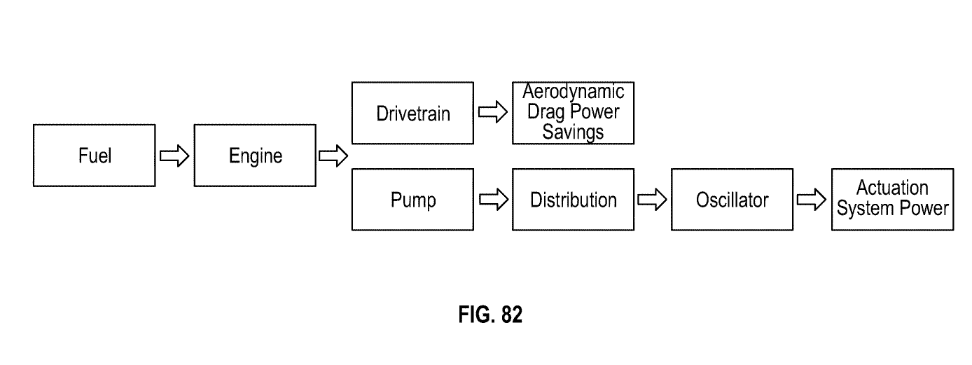

FIG. 82 is a flow chart of exemplary actuation system power. A sketch of the notional energy conversion process is shown in FIG. 82. This systems level energy analysis indicates that the losses present during conversion of energy from fuel to jet flow power can be significant. The conversion of fuel for the tractive power required to overcome drag is also considered. This allows the net benefit of the flow control system to evaluated if the jet power is known. For the system to be viable from a fuel economy improvement perspective, the power saved from drag reduction must be greater than the power consumed by the jets. The drag power savings is given in the following equation.

$$Drag Power Savings = \frac{Drag Reduction}{Efficiencies} = \frac{\frac{1}{2} {ρ}_{∞} {V}_{∞}^{3} Δ {C}_{D} A}{{n}_{engine} {n}_{transmission} {n}_{drivetrain}}$$

$$Jet System Power = \frac{Jet Energy}{Efficiencies} = \frac{\frac{1}{2} \dot{m} {V}_{j}^{2}}{{n}_{engine } {n}_{alternator \text{/} pump} {n}_{distribution} {n}_{oscillator}}$$

$$Power Net Savings = Power Savings - Jet Power$$

The jet power consumed by a fluidic oscillator based system may be approximated as ½\dot{m}Vⱼ², where \dot{m} is the mass flow rate through the oscillators, and Vⱼ is the jet velocity. The jet velocity may be estimated if the \dot{m} through the system, nozzle exit area, and density of the gas in the exiting jet are known. The net power savings is the difference between drag power savings and the jet system power.

The total mass flowrate through the system will depend on the vehicle velocity, size, and chosen actuator type. A larger vehicle will require more actuators to maintain the appropriate level of flowfield change. For a fluidic oscillator based system, there will be between 20 to 40 oscillators on the underbody of the vehicle, however the precise number of jets will depend on factors such as the baseline flowfield and available packaging space for the flow control system. The expected mass flow rate is on the order of 0.1 kg/s at highway speeds of 70 mph. The pressure required by the pumping system is less than 2 psi at the oscillator inlet, however pressure drop occurs ahead of the oscillator in the distribution system from the pump. The pump does not necessarily need to match the pressure requirements of the oscillator, because the flowrate and pressure could be controlled with a separate mass flowmeter. Another method is to use appropriate diffusing hardware to convert the pressure from a pump to what is needed at the jets, thus potentially eliminating the need for a mass flowmeter.

An alternative pumping system that alleviates that cost and complexity associated with a control system ties the compressor into the rear driveshaft or rear wheel. This system would couple pump speed to vehicle speed, and place the pump unit outside of the cabin vehicle so that noise impact is minimized. This will increase drag on the rear wheel (and require energy), however the overall system impact may improve because the alternator and motor conversion losses are eliminated. The speed coupled system can potentially eliminate the mass flow control hardware that has an additional weight penalty.

5. System Packaging

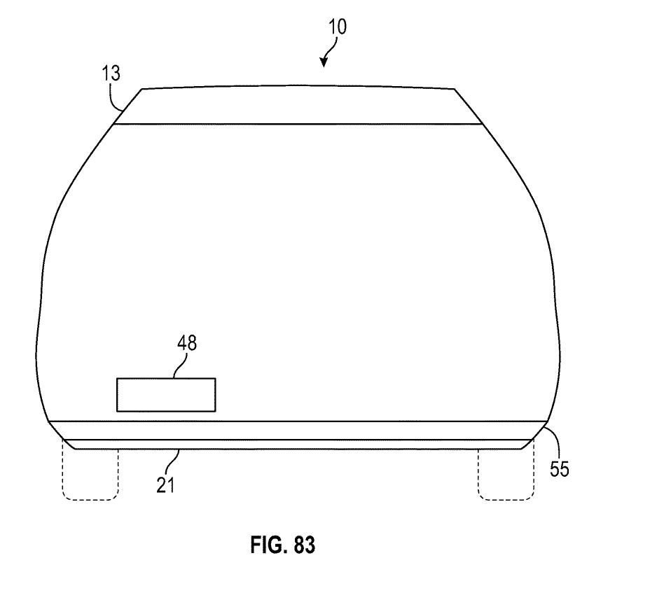

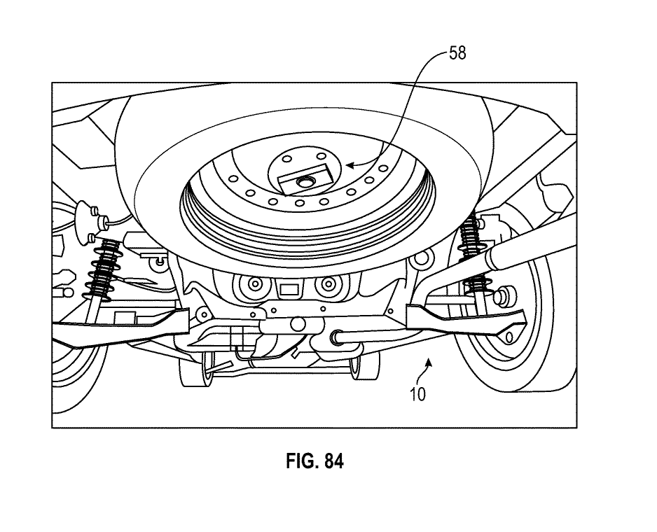

FIG. 83 is a schematic representation of rear of an exemplary vehicle having notional flow control system. FIG. 84 is a perspective view of a tire assembly of an exemplary vehicle.

There are many ways in which the system may be implemented into the vehicle. One method to improve packaging efficiency is to eliminate the spare tire and replace this region with the compressor required to power the actuators. The compressor could double as a tire inflation system in the event of a flat. Several vehicle manufacturers are already eliminating the spare tire and replacing it with a light weight pump and tire repair kit. The combination of this tire inflation system with the active flow control pump would provide overall weight savings to maximize a potential fuel economy benefit of the system (and reduce system cost). An alternative pumping mechanism involves a turbocharger run by the exhaust and connected to the jet array. This has the benefit of utilizing otherwise wasted energy to run a system that would benefit aerodynamics. It may also be possible to utilize the exhaust flow directly without the conversion through a turbocharger. For example, an active exhaust valve may divert flow to the jet system during cruise conditions, to alleviate potential backpressure considerations during acceleration or heavy load. An alternative exhaust powered system may involve a muffler in the shape of the underbody diffuser with exhaust vent holes machined in the appropriate locations to act as the flow control actuators and control separation on the aft portion of the muffler. The compressor may also be installed in the engine compartment and run directly from the engine as an accessory. This helps overall system efficiency because the losses in the alternator and electric motor are eliminated. There are numerous other potential implementations of the pumping system, and the most efficient setup will depend on the vehicle. Additional weight/cost savings for the pumping system may be found by sharing the flow control actuator pumping system with an onboard vacuum, air suspension, pump, air braking system, or any other system on the vehicle that already utilizes a pump/compressor.

### VI. Alternative Embodiments

While certain embodiments of the invention are described above, and FIGS. 1-87B disclose the best mode for practicing the various inventive aspects, it should be understood that the invention can be embodied and configured in many different ways without departing from the spirit and scope of the invention.

This flow control system can also be used for lift reduction. A relevant application for this active technology would be on high performance vehicles that require an appropriate rear down force for cornering. Rear down force is an important factor in high speed corning performance, however this is sometimes associated with a drag penalty (lift induced drag). It can be desirable to activate the down force system on demand during cornering, while remaining OFF in the other driving phases to minimize drag and maximize top speed. The notional logic system for this may be based on input parameters such, but not limited to: vehicle speed, acceleration, steering wheel angle, GPS mapping of vehicle position, and potentially a driver override switch, among other inputs. Additionally, this system can be applied to sports/performance cars, race cars, or any vehicle that would benefit from decreased rear lift. Models of various embodiments indicate that rear lift can be reduced by more than 60 counts with application of this technology to a minivan model. This system can be further optimized for down force production potentially at the expense of increased drag. The details of the activation logic depend on the vehicle and driving environments that it is expected to encounter. The active rear downforce system may also be used to modulate braking power, which could be particularly useful in emergency braking situation. The activation of the flow control system could simultaneously modulate lift and drag to achieve greater traction and increases braking directly from drag. The logic system for emergency braking may also include inputs including, but not limited to vehicle radar/camera collision mitigation systems, brake pedal position, vehicle speed, and steering wheel angle.

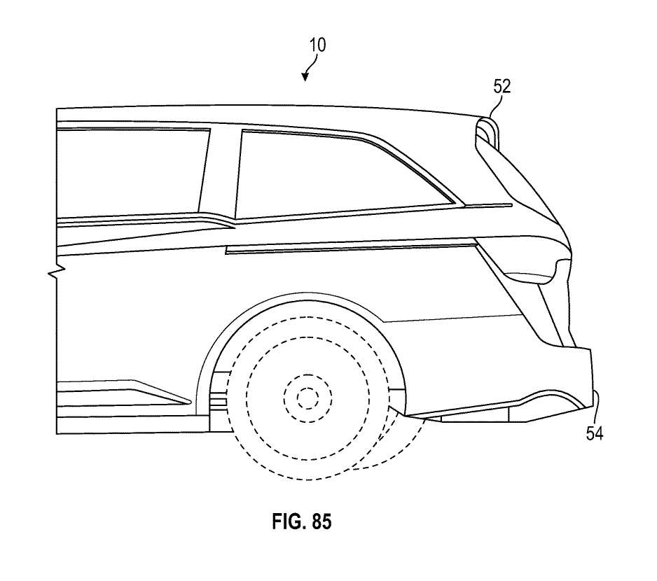

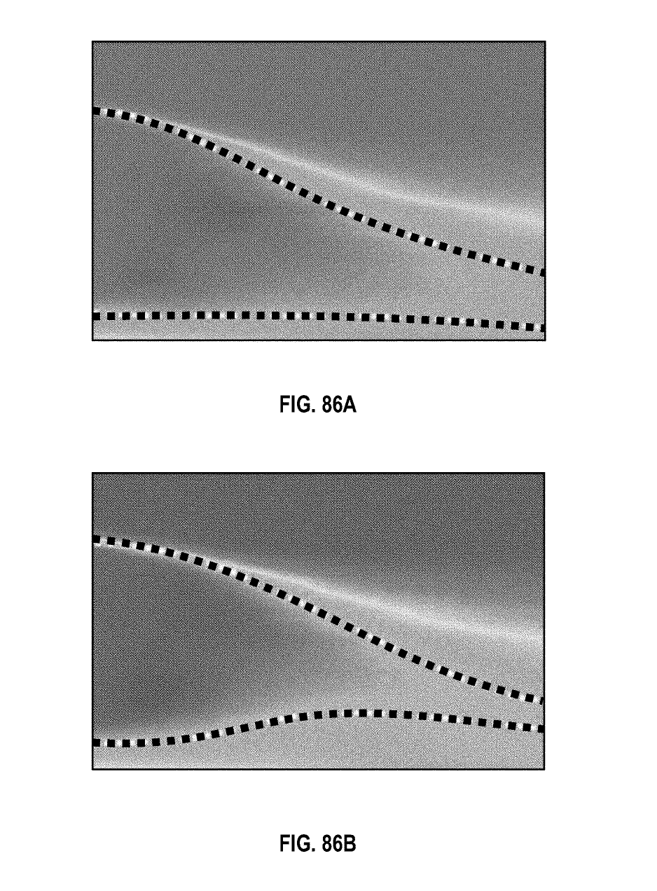

FIG. 85 is a perspective view of a rear portion of an exemplary vehicle. FIG. 86A is a representation of airflow behind the vehicle of FIG. 86 without a flow control system. FIG. 86B is a representation of airflow behind the vehicle of FIG. 86 implementing an exemplary flow control system.

Similar amounts of down force may be achieved with an upper body spoiler alone, however there will be a persistent drag penalty. This type of drag is said to be lift (or downforce) induced due to the stream wise vortices and subsequent low pressure region on the spoiler and aft car surface. Existing sports cars already have underbody flow diffusers that could be optimized further with the active flow control system. The down force is dependent on the underbody diffuser angle, and the degree to which flow attaches to the diffuser. The maximum angle for attached flow (and maximum down force) can be increased through the use of oscillator jets or other type of flow control actuator. The diffuser angle required for maximum down force production would likely be steeper than the angle needed optimal drag reduction. The steeper flap angle permits greater vectoring of the flow upwards (which has an opposite reaction of pulling the car downwards). The ability to modulate the rear down force and the associated induced drag, opens another envelope of optimization for sports car applications. The induced drag could also act as a braking mechanism which would not only increase the down force on the rear wheels, but also reduce the forward pitch moment during braking and provide more balanced braking performance.

Embodiments are disclosed above in the context of the fluidic oscillator control system configured for use with an automobile as shown in FIGS. 1-87B. However, embodiments are intended to include or otherwise cover oscillator control systems for use with other vehicles, including, but not limited to, motorcycles, recreational vehicles, aircrafts, and watercrafts.

Additionally, the present embodiments may also be implemented on any portion of a vehicle, including but not limited to the front end, such as the bumper assembly or either front fender, while keeping within the scope and spirit of the present disclosure. In addition to aft body application (defined as behind the front wheel centerline), separation control with fluidic oscillators or other flow control actuators can be effective at other regions of the vehicle. For example, separation control on the front bumper assembly may be achieved in a manner similar to separation control on the rear bumper assembly and surrounding vehicle surfaces. This application of separation control can extend the geometric envelope at which enhanced aerodynamics can be attained, thereby facilitating additional liberties for styling, crash regulations, or other constraints. Regulatory parameters for actuator placement relative to separation, in addition to jet velocity technical considerations, as well as jet spacing, remain relevant in design. Additional regions of actuator placement may include, but are not limited to, the hood, the cowl area (interface of the hood/windshield), fore of the rear glass on a sedan, and on the underbody regions at the front portion of the vehicle.

While the subject matter has been described in detail with reference to exemplary embodiments thereof, it will be apparent to one skilled in the art that various changes can be made, and equivalents employed, without departing from the scope of the invention. All related art references discussed in the above Background section are hereby incorporated by reference in their entirety.

What is claimed is:

1. A vehicle aerodynamics control system for use with a vehicle, the vehicle having a top side, a bottom side, a right side, and a left side, the control system comprising:
at least one flow control actuator disposed along at least one of the top side, the bottom side, the right side and the left side; and
a tuned surface configured to modify airflow in conjunction with the at least one flow control actuator, the tuned surface disposed along at least one of the top side, the bottom side, the right side, and the left side.

2. The vehicle aerodynamics control system of claim 1, wherein the at least one flow control actuator is disposed along a periphery of the vehicle.

3. The vehicle aerodynamics control system of claim 2, wherein the at least one flow control actuator is disposed along the top side of the vehicle.

4. The vehicle aerodynamics control system of claim 2, wherein the at least one flow control actuator is disposed along the bottom side of the vehicle.

5. The vehicle aerodynamics control system of claim 1, wherein the tuned surface is configured to modify airflow across the at least one of the top side, the bottom side, the right side, and the left side of the vehicle.

6. The vehicle aerodynamics control system of claim 1, further comprising a source of compressed air such that the at least one flow control actuator is configured to receive compressed air from the source of compressed air.

7. The vehicle aerodynamics control system of claim 1, wherein the vehicle includes a rear spoiler system configured to guide underbody airflow past the vehicle.

8. An active flow control system for use with a vehicle, the vehicle having wheels and defining an underbody and an upper body, wherein the control system is configured to modify aerodynamic performance of the vehicle by manipulating underbody airflow and interaction of the airflow with the upper body.

9. The active flow control system of claim 8, further comprising at least one flow control actuator on the underbody of the vehicle disposed lower on the underbody than a centerline of the wheels.

10. The active flow control system of claim 9, wherein the at least one flow control actuator is a pneumatic system configured to alter airflow attachment behavior to the underbody of the vehicle.

11. The active flow control system of claim 10, wherein the at least one flow control actuator is configured as a fluidic oscillator.

12. The active flow control system of claim 10, wherein the at least one flow control actuator is configured as a synthetic jet.

13. The active flow control system of claim 10, wherein the at least one flow control actuator is configured as a spanwise oscillatory suction and blowing jet.

14. The active flow control system of claim 10, wherein the at least one flow control actuator is configured as a slot blowing or suction jet.

15. The active flow control system of claim 10, wherein the at least one flow control actuator is configured as a vortex generator jet.

16. The active flow control system of claim 10, wherein the at least one flow control actuator is configured as a steady microjet.

17. The active flow control system of claim 8, further comprising an on-board power system configured to power the flow control system.

18. The active flow control system of claim 17, wherein the on-board power system utilizes an actuator pump of a spare tire inflation system of the vehicle.

19. The active flow control system of claim 17, wherein the on-board power system utilizes an actuator pump of a cleaning vacuum of the vehicle.

20. The active flow control system of claim 17, wherein the on-board power system utilizes exhaust energy dispelled by the vehicle during operation.

21. The active flow control system of claim 17, wherein the on-board power system utilizes a compressor integrated with the drivetrain.

22. The active flow control system of claim 8, wherein the control system is configured to be modulated on demand for adaptation to different driving conditions.

23. The active flow control system of claim 22, wherein the control system is configured to modify aerodynamic performance of the vehicle based on at least one of a directional change in path of travel of the vehicle, steering or braking input to the vehicle, and global positioning the vehicle.

24. The active flow control system of claim 8, wherein the control system is configured to modify aerodynamic performance during rapid speed change of the vehicle.

25. The active flow control system of claim 8, wherein acoustic characteristics of the control system are configured to be manipulatable.

26. A method of forming an aerodynamics control system for use with a vehicle, the vehicle having a top side, a bottom side, a driver side, and a passenger side, the method comprising:
providing at least one flow control actuator disposed along at least one of the top side, the bottom side, the driver side and the passenger side.
